(19) United States
(12) Patent Application Publication
(10) Pub. No.: US 2016/0025316 A1
(43) Pub. Date: Jan. 28, 2016

(54) MULTIFUNCTIONAL DESKTOP SYSTEM

(71) Applicant: Tseng-Lu Chien, Taipei (TW)

(72) Inventor: Tseng-Lu Chien, Taipei (TW)

(21) Appl. No.: 14/875,675

(22) Filed: Oct. 5, 2015

Related U.S. Application Data
(63) Continuation-in-part of application No. 14/643,026, filed on Mar. 10, 2015.
Application No. 14/643,026 is a continuation of application No. 14/144,703, filed on Dec. 31, 2013.
Application No. 14/144,703 is a continuation of application No. 13/161,643, filed on Jun. 16, 2011, now Pat. No. 8,783,936.
Application No. 13/161,643 is a continuation-in-part of application No. 13/117,227, filed on May 27, 2011.
Application No. 13/117,227 is a continuation of application No. 12/502,661, filed on Jul. 14, 2009, now Pat. No. 8,342,732.
Application No. 12/502,661 is a continuation of application No. 11/498,881, filed on Aug. 4, 2006, now Pat. No. 7,568,829.
Application No. 11/498,881 is a continuation-in-part of application No. 13/858,604, filed on Apr. 8, 2013.
Application No. 13/858,604 is a continuation-in-part of application No. 13/870,253, filed on Apr. 25, 2013.
Application No. 13/870,253 is a continuation-in-part of application No. 13/910,295, filed on Jun. 5, 2013.
Application No. 13/910,295 is a continuation-in-part of application No. 11/498,874, filed on Aug. 4, 2006.
Application No. 11/498,874 is a continuation of application No. 10/954,189, filed on Oct. 1, 2004, now abandoned.
Application No. 10/954,189 is a continuation-in-part of application No. 14/729,380, filed on Jun. 3, 2015.
Application No. 14/729,380 is a continuation of application No. 13/923,721, filed on Jun. 21, 2013.
Application No. 13/923,721 is a continuation of application No. 11/527,629, filed on Sep. 27, 2006, now Pat. No. 8,545,090.
Application No. 11/527,629 is a continuation-in-part of application No. 12/886,832, filed on Sep. 21, 2010.
Application No. 12/886,832 is a continuation of application No. 12/292,580, filed on Nov. 21, 2008, now Pat. No. 8,305,846.
Application No. 12/292,580 is a continuation of application No. 11/527,631, filed on Sep. 27, 2006, now abandoned.
Application No. 11/527,631 is a continuation of application No. 11/255,981, filed on Oct. 24, 2005, now Pat. No. 7,455,444.
Application No. 11/255,981 is a continuation of application No. 11/094,155, filed on Mar. 31, 2005, now Pat. No. 7,810,985.
Application No. 11/094,155 is a continuation-in-part of application No. 13/117,227, filed on May 27, 2011.
Application No. 13/117,227 is a continuation of application No. 12/566,322, filed on Sep. 24, 2009, now abandoned.
Application No. 12/566,322 is a continuation of application No. 11/527,628, filed on Sep. 27, 2006, now Pat. No. 7,611,253.
Application No. 11/527,628 is a continuation-in-part of application No. 11/806,285, filed on May 31, 2007.
Application No. 11/806,285 is a continuation of application No. 11/527,629, filed on Sep. 27, 2006, now Pat. No. 8,545,090.
Application No. 11/527,629 is a continuation-in-part of application No. 12/886,832, filed on Sep. 21, 2010.
Application No. 12/886,832 is a division of application No. 12/622,000, filed on Nov. 19, 2009, now Pat. No. 8,434,927.
Application No. 12/622,000 is a continuation-in-part of application No. 14/642,169, filed on Mar. 9, 2015.
Application No. 14/642,169 is a continuation of application No. 12/950,017, filed on Nov. 19, 2010, now Pat. No. 8,998,462.
Application No. 12/950,017 is a continuation-in-part of application No. 14/793,262, filed on Jul. 7, 2015.
Application No. 14/793,262 is a continuation of application No. 12/950,017, filed on Nov. 19, 2010, now Pat. No. 8,998,462.
Application No. 12/950,017 is a continuation-in-part of application No. 14/829,114, filed on Aug. 18, 2015.
Application No. 14/829,114 is a continuation of application No. 13/295,562, filed on Nov. 14, 2011.
Application No. 13/295,562 is a division of application No. 12/622,000, filed on Nov. 19, 2009, now Pat. No. 8,434,927.
Application No. 12/622,000 is a continuation-in-part of application No. 14/829,213, filed on Aug. 18, 2015.
Application No. 14/829,213 is a continuation of application No. 13/295,562, filed on Nov. 14, 2011.
Application No. 13/295,562 is a division of application No. 12/622,000, filed on Nov. 19, 2009, now Pat. No. 8,434,927.

(51) Int. Cl. F21V 23/02; F21V 23/04; F21V 33/00; F21S 6/00

(52) U.S. Cl. CPC F21V 23/023; F21S 6/003; F21V 23/0442; F21V 33/0048

(57) ABSTRACT

A method and apparatus can include: a USB-unit mounted within the desktop system, the USB-unit including a USB receptacle exposed from the desktop system, the USB-unit including active Vbus and GND pins while having inactive D+ and D− pins; a single power type directly connected to the USB-unit, the single power type conducted through the USB-unit and output on the USB receptacle with the same power profile as the single power type provides based on the single power type being a Vbus power type, or the single power type conducted through the USB-unit and output on the USB receptacle in a modified form based on the single power type being an alternating current power type; and a light source mounted within the desktop system and exposed therefrom.

### CROSS-REFERENCE TO RELATED APPLICATIONS

This is a Continuation-In-Part of U.S. patent application Ser. No. 14/643,026 filed Mar. 10, 2015, which is a Continuation of U.S. patent application Ser. No. 14/144,703 filed Dec. 31, 2013, which is a Continuation of U.S. patent application Ser. No. 13/161,643 filed Jun. 16, 2011 and currently issued as U.S. Pat. No. 8,783,936. This is a Continuation-In-Part of U.S. patent application Ser. No. 13/117,227 filed May 27, 2011, which is a Continuation of U.S. patent application Ser. No. 12/502,661 filed Jul. 14, 2009, which is a Continuation of U.S. patent application Ser. No. 11/498,881 filed Aug. 4, 2006. This is a Continuation-In-Part of U.S. patent application Ser. No. 13/858,604 filed Apr. 8, 2013. This is a Continuation-In-Part of U.S. patent application Ser. No. 13/870,253 filed Apr. 25, 2013. This is a Continuation-In-Part of U.S. patent application Ser. No. 13/910,295 filed Jun. 5, 2013. This is a Continuation-In-Part of U.S. patent application Ser. No. 11/498,874 filed Aug. 4, 2006, which is a Continuation of U.S. patent application Ser. No. 10/954,189 filed Oct. 1, 2004. This is a Continuation-In-Part of U.S. patent application Ser. No. 14/729,380 filed Jun. 3, 2015, which is a Continuation of U.S. patent application Ser. No. 13/923,721 filed Jun. 21, 2013, which is a Continuation of U.S. patent application Ser. No. 11/527,629 filed Sep. 27, 2006. This is a Continuation-In-Part of U.S. patent application Ser. No. 12/886,832 filed Sep. 21, 2010, which is a Continuation of U.S. patent application Ser. No. 12/292,580 filed Nov. 21, 2008, which is a Continuation of U.S. patent application Ser. No. 11/527,631 filed Sep. 27, 2006, which is a Continuation of both U.S. patent application Ser. No. 11/255,981 filed Oct. 24, 2005 and U.S. patent application Ser. No. 11/094,155 filed Mar. 31, 2005. This is a Continuation-In-Part of U.S. patent application Ser. No. 13/117,227 filed May 27, 2011, which is a Continuation of U.S. patent application Ser. No. 12/566,322 filed Sep. 24, 2009, which is a Continuation of U.S. patent application Ser. No. 11/527,628 filed Sep. 27, 2006. This is a Continuation-In-Part of U.S. patent application Ser. No. 11/806,285 filed May 31, 2007, which is a Continuation of U.S. patent application Ser. No. 11/527,629 filed Sep. 27, 2006. This is a Continuation-In-Part of U.S. patent application Ser. No. 12/886,832 filed Sep. 21, 2010, which is a Divisional of U.S. patent application Ser. No. 12/622,000 filed Nov. 19, 2009. This is a Continuation-In-Part of U.S. patent application Ser. No. 14/642,169 filed Mar. 9, 2015, which is a Continuation of U.S. patent application Ser. No. 12/950,017 filed Nov. 19, 2010. This is a Continuation-In-Part of U.S. patent application Ser. No. 14/793,262 filed Jul. 7, 2015, which is a Continuation of U.S. patent application Ser. No. 12/950,017 filed Nov. 19, 2010. This is a Continuation-In-Part of U.S. patent application Ser. No. 14/829,114 filed Aug. 18, 2015, which is a Continuation of U.S. patent application Ser. No. 13/295,562 filed Nov. 14, 2011, which is a Divisional of U.S. patent application Ser. No. 12/622,000 filed Nov. 19, 2009. This is a Continuation-In-Part of U.S. patent application Ser. No. 14/829,213 filed Aug. 18, 2015, which is a Continuation of U.S. patent application Ser. No. 13/295,562 filed Nov. 14, 2011, which is a Divisional of U.S. patent application Ser. No. 12/622,000 filed Nov. 19, 2009. The content of these applications is incorporated herein by reference in their entirety.

### TECHNICAL FIELD

This disclosure relates to consumer multifunctional desktop systems, more particularly to desktop lighting systems incorporating power receptacles.

### BACKGROUND

The rapidly growing portable electronics market, e.g. cellular phones, digital watches, digital music players, tablet computers, and laptop computers is an integral facet of modern life. As mobile devices have evolved to provide greater functionality, the power requirements for these devices have also evolved requiring increased charge cycles with shorter intervals between them.

The increasing needs to charge and power portable devices represents one of the largest potential market opportunities for next generation charging stations. These charging stations have unique attributes that have significant impacts on manufacturing and design, in that they must be generally easily accessible, feature rich, and they must be produced in high volumes at relatively low cost.

As an extension of the portable electronics industry, the charging station industry has witnessed ever-increasing commercial competitive pressures, along with growing consumer expectations and the diminishing opportunities for meaningful product differentiation in the marketplace. Design, cross technology integration, and ergonomic engineering are at the very core of next generation insertion strategies outlined in road maps for development of next generation products.

Future power supplies will be more intelligent, have greater charging capacity with more precision, use less power, and include cross platform technology at lower cost than today. Current charging station manufactures are struggling to accommodate the charging requirements of next generation portable electronics. The current charging station technologies, materials, features, and structural designs offer challenges to the basic charging requirements of these new portable electronic devices while still not adequately addressing functionality and cost concerns.

One line of development (Patel), contained in U.S. Pat. Nos. 7,736,033 and 8,545,039, sets forth a lamp base having an electrical device-recharging receptacle configured to receive a plug from a recharging device for a portable rechargeable electronic device. The receptacle is configured as a standard automobile cigarette lighter receptacle. The receptacle includes standard cigarette lighter receptacle electrical contacts that are connected to a voltage and current conversion circuit for receiving standard household voltage and converting it into standard automotive voltage and current.

The Patel line of development converts an input AC of 120 volts to an automobile output of 12 volts then converts the automobile output to a USB output of 5 Volts. The Patel approach requires at least two expensive circuits including multiple separate transformers in order to provide the USB output.

Further, the Patel approach is barely functional because few if any consumers have been shown to need or appreciate a 12-volt DC automobile output for use within a house or dwelling unit. The Patel approach fails to provide economical or functional solutions.

Another line of development (Meyer), contained in U.S. Pat. No. 7,897,277, sets forth a lighting apparatus that includes an electrical contact receiving power from an external power source, a battery-receiving region, and a battery backed light source. A user interface receives an input indicative of a first desired operation of the lighting apparatus when power is available from the AC power source and a second desired operation of the battery backed light source in the absence of power from the AC power source. Electrical circuitry uses battery power to operate the battery backed light source in the absence of power from the AC power source based on the second desired operation.

The Meyer line of development implements DC batteries only as the backup power for secondary lamp functions but fail to describe any power supply functionality. Specifically the Meyer approach fails to provide any functional solution for USB charging receptacles or AC charging receptacles. Further, because the Meyer approach requires expensive battery power packs, the Meyer approach also fails to provide a cost effective solution.

Another line of development (Agata), contained in U.S. Pat. No. 6,474,823, sets forth a reflex liquid crystal display of a notebook PC with a removable light source attached so that light will be irradiated evenly over an entire surface of the display and the light source can be easily detached when carrying the reflex liquid crystal display.

The Agata line of development takes AC power and converts it to power a laptop computer. The AC power input is converted in an external computer power supply, which then sends a DC input into the computer. The computer contains no USB power converters or transformers internally.

The Agata approach fails to provide a cost effective solution because it requires the entire laptop computer. Further, from a functionality perspective, the Agata approach fails because the charging transformers or circuitry is external to the laptop making the footprint of the system excessively large and unwieldy.

Another line of development (Smed), contained in U.S. Pat. No. 8,562,187, sets forth a base for a lamp having a member adapted to attach a combined adjustable arm and lamp to the base. The base has a mass sufficient to support the combined adjustable arm and lamp in all possible orientations, the base has at least one receptacle housed in the base, and the base includes a printed circuit board. The printed circuit board is electrically connected to a household power receptacle and the printed circuit board is adapted to electrically connect the at least one receptacle to the household power supply. The printed circuit board includes a transformer adapted to transform the household power supply into an output power suitable for powering the lamp, and the transformer is electrically connected to the lamp.

The Smed line of development sets forth the printed circuit board transforming input AC to 15 volt 2 ampere DC for powering an LED and providing the input AC to an AC receptacle in the US plug standard or the plug standard of another country. The Smed approach, shown in Smed FIG. 2, teaches that the input AC traverses and is channeled through the printed circuit board and further converts the input AC into 15 volt DC. Due to these limitations, the Smed approach is costly and lacks functionality by failing to provide functional DC receptacle.

Another line of development (Strauser), contained in U.S. Pat. Nos. 7,742,293, 8,116,077, 8,432,667, sets forth an audio device supporting a variety of digital music players and which includes a cradle that physically holds any of a plurality of digital music players. A power port on the audio device provides power to the digital music player through a cable that is specific to the selected digital music player and that connects between the power port and the digital music player while the digital music player is held within the cradle.

The Strauser line of development sets forth the music player supported on pedestal support or foot that is positioned on the ground. The Strauser audio device further includes a console with audio controls, a display, and indicators.

The Strauser approach fails to provide a functional, ergonomic, accessible, and cost effective solution. This results from Strauser only charging a single phone, requiring a large amount of extra circuitry in the form of the console, not being accessible on a desktop but requires a user to stand and walk over to the Strauser device, and does not provide a light, indicators, etc.

Another line of development (Schaak), contained in U.S. Patent Numbers 2006/0209530, sets forth a desk lamp including a docking station for media devices. The lamp has a support that houses a speaker and a docking structure for receiving the media device. An electrical connector and associated cable connect an output of the media player to the speaker. The desk lamp further includes a neck for coupling a terminal housing to the support. A bulb socket is attached to the terminal housing to receive a light bulb. A power cord electrically couples the bulb socket to a battery compartment or to an electrical plug. The lamp may in addition include a transformer and a charging circuit that are electrically coupled to contacts in the docking structure for providing power to the media device. Alternatively, the lamp may include a second socket at an exterior surface of the support for connecting to a media device compatible cable to receive power.

The Schaak line of developments fails to provide a solution for enhanced functionality because the Schaak approach sets forth a custom plug that is a device specific male connection, which protrudes so that a cellular phone can plug thereto. Since each cellular phone could require a different connection, the Schaak approach would provide functionality to only a sliver of the mobile market.

In view of the ever-increasing commercial competitive pressures, along with growing consumer expectations and the diminishing opportunities for meaningful product differentiation in the marketplace, it is critical that answers be found for these problems. Additionally, the need to reduce costs, reduce production time, improve efficiencies and performance, and meet competitive pressures, adds an even greater urgency to the critical necessity for finding answers to these problems.

### SUMMARY

A multifunctional desktop system and methods, providing accessibility, feature richness, allowing high volume production at relatively low cost is disclosed. The desktop system and methods can include: a USB-unit mounted within the desktop system, the USB-unit including a USB receptacle exposed from the desktop system, the USB-unit including active Vbus and GND pins while having inactive D+ and D− pins; a single power type directly connected to the USB-unit, the single power type conducted through the USB-unit and output on the USB receptacle with the same power profile as the single power type provides based on the single power type being a Vbus power type, or the single power type conducted through the USB-unit and output on the USB receptacle in a modified form based on the single power type being an alternating current power type; and a light source mounted within the desktop system and exposed therefrom.

It is disclosed that some embodiments of the desktop system provide an ergonomic solution by allowing a user to reach the desktop system while sitting comfortably at a desk without needing to walk or bend the body to reach the desktop system. The desktop system can be located on desktops where people work, eat, sleep, or rest, whether indoor or outdoor.

The desktop is contemplated to include working surfaces of tables, desks, closets, bedside tables, or computer ventilation pads for bed reading. The desktop system is disclosed in various embodiments to include multiple functions including desktop lighting, digital alarms, clocks, cup heaters, juice makers, microwave ovens, paper weights, air-fresheners, USB-hubs, decorative items, games, consumer electronic items, cosmetic lighted mirrors. It has been discovered that combining various multiple functions into the desktop system allows desktops to maintain high functionality while remaining neat, organized, and clean.

It is disclosed that some embodiments of the desktop system include USB-units, USB-modules, sealed USB-modules, or a combination thereof. It is further disclosed that some embodiments of the desktop system include AC-units, AC-modules, sealed AC-modules, or a combination thereof.

Other contemplated embodiments can include objects, features, aspects, and advantages in addition to or in place of those mentioned above. These objects, features, aspects, and advantages of the embodiments will become more apparent from the following detailed description, along with the accompanying drawings.

### BRIEF DESCRIPTION OF THE DRAWINGS

The desktop system is illustrated in the figures of the accompanying drawings which are meant to be exemplary and not limiting, in which like reference numerals are intended to refer to like components, and in which:

FIG. 1 is an isometric side view of the desktop system in a first embodiment.

FIG. 2 is an isometric side view of the desktop system in a second embodiment.

FIG. 3 is an isometric view of the base unit of FIG. 2 in an alternate configuration.

FIG. 4 is an isometric side view of the desktop system in a third embodiment.

FIG. 5 is an isometric side view of the desktop system in a fourth embodiment.

FIG. 6 is an isometric view of the base unit of FIG. 5 in an alternate configuration.

FIG. 7 is an isometric view of the base unit of FIG. 5 in an alternate configuration.

FIG. 8 is an isometric side view of the base unit of FIG. 5 in an alternate configuration.

FIG. 9 is an isometric top view of the desktop system in a fifth embodiment.

FIG. 10 is an isometric view of the base unit of FIG. 9 in an alternate configuration.

FIG. 11 is an isometric top view of the desktop system in a sixth embodiment.

FIG. 12 is an isometric view of the base unit of FIG. 11 in an alternate embodiment.

FIG. 13 is an isometric view of a base unit for an embodiment of the desktop system.

FIG. 14 is an isometric view of a base unit for an embodiment of the desktop system.

FIG. 15 is an isometric view of a base unit for an embodiment of the desktop system.

FIG. 16 is a bottom view of a lighting source for an embodiment of the desktop system.

FIG. 17 is a bottom view of a lighting source for an embodiment of the desktop system.

FIG. 18 is a bottom view of a lighting source for an embodiment of the desktop system.

FIG. 19 is an isometric top view of a rotatable unit for an embodiment of the desktop system.

FIG. 20 is an isometric top view of a rotatable unit for an embodiment of the desktop system during rotation.

FIG. 21 is an isometric top view of a rotatable unit for an embodiment of the desktop system.

FIG. 22 is an isometric top view of a rotatable unit for an embodiment of the desktop system.

FIG. 23 is an isometric top view of the desktop system in a seventh embodiment.

FIG. 24 is an isometric top view of the desktop system in an eighth embodiment.

FIG. 25 is an isometric top view of the desktop system in a ninth embodiment.

FIG. 26 is an isometric top view of the desktop system in a tenth embodiment.

FIG. 27 is an isometric top view of the desktop system in an eleventh embodiment.

FIG. 28 is an isometric side view of an implement for use with the desktop system.

FIG. 29 is an isometric side view of the desktop system in a twelfth embodiment.

FIG. 30 is an isometric side view of the desktop system in a thirteenth embodiment.

FIG. 31 is an isometric view of a USB-unit for an embodiment of the desktop system.

FIG. 32 is an isometric top view of a USB-module for an embodiment of the desktop system.

FIG. 33 is an isometric view of a sealed USB-module for an embodiment of the desktop system.

FIG. 34 is a side view of a Type-A USB receptacle for an embodiment of the desktop system.

FIG. 35 is an isometric view of an AC-unit for an embodiment of the desktop system.

FIG. 36 is an isometric top view of an AC-module for an embodiment of the desktop system.

FIG. 37 is an isometric view of a sealed AC-module for an embodiment of the desktop system.

FIG. 38 is a flow chart for a method of manufacture of the desktop system of FIG. 1.

FIG. 39 is a first block diagram for an embodiment of the desktop system.

FIG. 40 is a second block diagram for an embodiment of the desktop system.

### DETAILED DESCRIPTION

In the following description, reference is made to the accompanying drawings that form a part hereof, and in which are shown by way of illustration, embodiments in which the desktop system may be practiced. It is to be understood that other embodiments may be utilized and structural changes may be made without departing from the scope of the desktop system.

When features, aspects, or embodiments of the desktop system are described in terms of steps of a process, an operation, a control flow, or a flow chart, it is to be understood that the steps can be combined, performed in a different order, deleted, or include additional steps without departing from the desktop system as described herein.

The desktop system is described in sufficient detail to enable those skilled in the art to make and use the desktop system and provide numerous specific details to give a thorough understanding of the desktop system; however, it will be apparent that the desktop system may be practiced without these specific details.

In order to avoid obscuring the desktop system, some well-known system configurations are not disclosed in detail. Likewise, the drawings showing embodiments of the system are semi-diagrammatic and not to scale and, particularly, some of the dimensions are for the clarity of presentation and are shown greatly exaggerated in the drawing FIGS. Generally, the desktop system can be operated in any orientation.

As used herein, the term system is defined as a device or method depending on the context in which it is used. For expository purposes, the term “horizontal” as used herein is defined as a plane parallel to the bottom plane or surface of the base unit, regardless of its orientation. The term “vertical” refers to a direction perpendicular to the horizontal as just defined. Terms, such as “above”, “below”, “bottom”, “top”, “side”, “higher”, “lower”, “upper”, “over”, and “under”, are defined with respect to the horizontal plane. As used herein, the term “coupled” is defined as a physical connection.

As used herein the term “single power type”, as in single input power type, is defined as the power type of an output of a specific type of electric supply. As an illustrative example a single power type is the AC power type output of a 120 volt 60 hertz AC supply, the AC power type output of a 230 volt 50 hertz AC supply, the DC power type output of a 12 volt DC supply, the DC power type output of a 9 volt DC supply, or a Vbus power type output from a Vbus pin of the USB Type-A receptacle.

As used herein, the term “receptacle” is defined as a female connection. As used herein, the term “plug” is defined as a male connection.

As used herein, the term “USB-unit” is defined as a USB receptacle and corresponding circuitry that has a single input power type; where the single input power type is converted, conducted, or both by the circuitry and is provided as an output to the USB receptacle with a profile of a USB Vbus. It has been discovered that implementing circuitry with only a single input power type greatly reduces the production costs, production complexity, without sacrificing functionality of the USB-unit.

As used herein, the term “AC-unit” is defined as an AC receptacle and corresponding circuitry that has a single input power type; where the single input power type is converted, conducted, or both by the circuitry and is provided as an output to the AC receptacle with a profile of an alternating current. It has been discovered that implementing circuitry with only a single input power type greatly reduces the production costs, production complexity, without sacrificing functionality of the AC-unit.

As used herein the term “sealed module”, as in sealed USB-module or sealed AC-module, is defined as a structure having at least one power receptacle in a sealed housing having compliance marks. As an illustrative example a sealed module could be the USB-unit contained in a sealed housing with compliance marks from the Underwriters Laboratory (UL), the Federal Communications Commission (FCC), the Product Safety Engineering, Inc. (PSE), the Voluntary Control Council for Interference by Information Technology Equipment (VCCI), the Low Voltage Directive (LVD), Energy Star, the Restriction of Hazardous Substances Directive (Rohs), or the Limited Power Source Safety Standard (LPS).

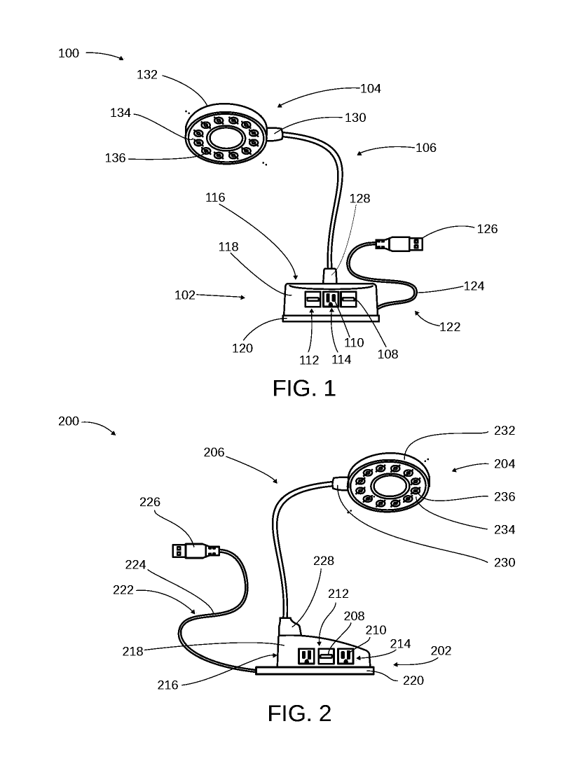

Referring now to FIG. 1, therein is shown an isometric side view of the desktop system 100 in a first embodiment. The desktop system 100 is depicted having a base unit 102 coupled to a lighting source 104, the base unit 102 coupled to the lighting source 104 with a support 106.

The base unit 102 is shown having USB receptacles 108 and AC receptacles 110. The USB receptacles 108 can be external receptacle portions of USB-units 112 and are contemplated to be USB type-A or USB type-C receptacles.

The USB receptacles 108 can provide active Vbus and GND pins while providing inactive D+, and D− pins. In alternative configurations, the USB receptacles 108 can provide the active Vbus and GND pins while providing no pins for D+ and D−. It is contemplated that when the USB receptacles 108 are implemented in USB receptacles other than type-A, the ID pin can also be inactive or nonexistent.

It has been discovered that providing the active Vbus and GND pins while not providing active D+, D−, or ID pins allows the desktop system 100 to be produced at a lower price point and less manufacturing complexity because no circuitry or internal connections are needed for the D+, D−, or ID pins.

It has further been discovered that providing only a USB receptacle rather than a USB plug, greatly increases the versatility and usability of the desktop system 100 by allowing users to plug in a USB charging plug that is compatible with the type-A or type-C receptacle on one end and any other USB receptacle on the other. That is, a user can use the USB receptacles 108 to charge an electronic device requiring a USB mini-A, a USB mini-B, a USB micro-A, a USB micro-B, or even a USB type-B connection by using the user's own USB charging cable.

Further it has been discovered that the USB receptacles 108 increase the ergonomic functionality and versatility of the desktop system 100 by enabling a user to plug in their charging cable and position their electronic device anywhere within reach of the desktop system 100. The electronic device can be positioned out of the way and the user can easily reach the desktop system 100 without needing to stand up, walk over to an outlet, bend over, and plug their electronic device in.

The USB receptacles 108 are shown configured with one of the USB receptacles 108 on either side of the AC receptacles 110. The AC receptacles 110 can be external receptacle portions of AC-units 114.

The AC-units 114 and the USB-units 112 can be combined within a base housing 116 into modules. The modules of the AC-units 114 and the USB-units 112 can include multiple AC-units 114 or multiple USB-units 112 and can share components like conductors, passive electrical components, and circuit boards. The modules of the AC-units 114 and the USB-units 112 can also be housed with an internal housing that is contained within the base housing 116.

The AC-units 114 and the USB-units 112 can also be combined within the base housing 116 into sealed modules. The sealed modules of the AC-units 114 and the USB-units 112 can include multiple AC-units 114 or multiple USB-units 112 and can share components like conductors, passive electrical components, and circuit boards. The sealed modules of the AC-units 114 and the USB-units 112 can also be housed with a sealed internal housing that is contained within the base housing 116.

The AC receptacles 110 and the USB receptacles 108 are shown exposed from multiple openings in a side 118 of the base housing 116 of the base unit 102. The side 118 can be a vertical side or a substantially vertical side of the base housing 116.

The base housing 116 is contemplated to be a lamp base having a universal shape that can be formed to resemble multiple types of existing lamp bases. It has been discovered that shaping the base unit 102 to resemble currently used bases enables greater integration of the desktop system 100 onto the desk of a user because the desktop system 100 does not occupy new desk top space but only occupies the same amount of space as any previously used desktop lamp.

It is contemplated that the base housing 116 can include a multiplicity of the AC-units 114 and the USB-units 112 and could further include wireless connectivity for external wireless devices. The wireless connectivity is contemplated to include Bluetooth, Infrared, NFC, Wi-Fi, Wireless technology, Zigbee, or a combination thereof.

The base housing 116 is contemplated to be made of plastics or metals depending on the level of quality demanded by users and supported by the market. The base unit 102 further includes a base foot 120 below the base housing 116 and connected thereto.

During manufacture, the USB receptacles 108 and the AC receptacles 110 can be mounted to the base housing 116, to the base foot 120, or a combination thereof. The base foot 120 can provide a non-slip surface for anchoring the desktop system 100 to a desktop, floor, or other surface. The base foot 120 can further provide or be coupled to a weight for providing extra stability to the desktop system 100 and additional anchoring force.

The base unit 102 is shown having a power input 122. The power input 122 is shown having a cable 124 coupled to the base housing 116 and a USB plug 126 coupled to the end of the cable 124 opposite of the base housing 116. The USB plug 126 is contemplated to be compatible with a USB type-A or USB type-C receptacles.

The power from the power input 122 can be a single power type and can be conducted straight from the power input 122 through circuitry in the USB-units 112 to the USB receptacles 108 of the USB-units 112. It has been discovered that conducting the power from the power input 122 straight through the USB-units 112 without modifying the power improves the desktop system 100 by reducing manufacturing costs, complexity, and component failure points.

The single power type from the power input 122 can also be converted in circuitry in the AC-units 114 from a DC Vbus power source to an AC power and provided as an output at the AC receptacles 110 of the AC-units 114. It has been discovered that converting the power from the single power type of the power input 122 improves the desktop system 100 by reducing manufacturing costs, complexity, and component failure points because the circuitry doing the conversion can be designed for a single power type and is not required to convert multiple different types of input power.

The support 106 is shown extending from a lower support connector 128 coupled to the base housing 116. The lower support connector 128 can be a reinforcing element that is integrally molded to the base housing 116 or can be a structure affixed rigidly to the base housing 116.

The support 106 can be threaded through the lower support connector 128 and directly connected to the base housing 116 or can be coupled only to the lower support connector 128. The support 106 is further shown extending from an upper support connector 130 coupled to the lighting source 104. The upper support connector 130 can be a reinforcing element that is integrally molded to the lighting source 104 or can be a structure affixed rigidly to the lighting source 104.

The support 106 can be threaded through the upper support connector 130 and directly connected to the lighting source 104 or can be coupled only to the upper support connector 130. The lighting source 104 is depicted having a light housing 132 and a lighting base 134.

The upper support connector 130 is depicted as coupled to the light housing 132. The lighting base 134 is shown having lighting elements 136. The lighting elements 136 can be DC lighting elements including LEDs or OLEDs. The lighting elements 136 are contemplated to be configurable to emit multiple different wavelengths of light including red, blue, and multiple wavelengths of light simultaneously like white light.

The desktop system 100 can take power from the power input 122 and conduct it through the circuitry of the USB-units 112 to power the USB receptacles 108, convert it within the AC-units 114 to power the AC receptacles 110, or conduct it to the lighting elements 136 to power the lighting elements 136 directly.

It has been discovered that removing extra circuitry associated with the conversion of the power from the power input 122 to be useable with the USB-units 112 and the lighting elements 136 and directly connecting the USB receptacles 108 and the lighting elements 136 to the power input 122 greatly reduces costs and complexity of producing and designing the desktop system 100 while simultaneously reducing the number of components that could potentially fail.

Further, the desktop system 100 does not include any batteries for power storage for the power of the power input 122. That is, when the power from the power input 122 is removed the AC receptacles 110, the USB receptacles 108, and the lighting elements 136 are no longer powered. It has been discovered that providing the desktop system 100 without batteries for power storage can provide a smaller footprint, simplified design, and a lower bill of materials along with a more robust design.

The support 106 can be repositioned and moved to determine where the lighting source 104 is angled. The lighting source 104 is depicted as including 12 lighting elements 136 arranged in a circle near a perimeter of the light housing 132.

Referring now to FIG. 2, therein is shown an isometric side view of the desktop system 200 in a second embodiment. The desktop system 200 is depicted having a base unit 202 coupled to a lighting source 204, the base unit 202 coupled to the lighting source 204 with a support 206. The base unit 202 is shown having USB receptacles 208 and AC receptacles 210. The USB receptacles 208 can be external receptacle portions of USB-units 212 and are contemplated to be USB type-A or USB type-C receptacles.

The USB receptacles 208 can provide active Vbus and GND pins while providing inactive D+, and D− pins. In alternative configurations, the USB receptacles 208 can provide the active Vbus and GND pins while providing no pins for D+ and D−. It is contemplated that when the USB receptacles 208 are implemented in USB receptacles other than type-A, the ID pin can also be inactive or nonexistent.

It has been discovered that providing the active Vbus and GND pins, while not providing active D+, D−, or ID pins, allows the desktop system 200 to be produced at a lower price point and less manufacturing complexity because no circuitry or internal connections are needed for the D+, D−, or ID pins.

It has further been discovered that providing only a USB receptacle rather than a USB plug, greatly increases the versatility and usability of the desktop system 200 by allowing users to plug in a USB charging plug that is compatible with the type-A or type-C receptacle on one end and any other USB receptacle on the other. That is, a user can use the USB receptacles 208 to charge an electronic device requiring a USB mini-A, a USB mini-B, a USB micro-A, a USB micro-B, or even a USB type-B connection by using the user's own USB charging cable.

Further it has been discovered that the USB receptacles 208 increase the ergonomic functionality and versatility of the desktop system 200 by enabling a user to plug in their charging cable and position their electronic device anywhere within reach of the desktop system 200. The electronic device can be positioned out of the way and the user can easily reach the desktop system 200 without needing to stand up, walk over to an outlet, bend over, and plug their electronic device in.

The AC receptacles 210 are shown configured with one of the AC receptacles 210 on either side of the USB receptacles 208. The AC receptacles 210 can be external receptacle portions of AC-units 214.

The AC-units 214 and the USB-units 212 can be combined within a base housing 216 into modules. The modules of the AC-units 214 and the USB-units 212 can include multiple AC-units 214 or multiple USB-units 212 and can share components like conductors, passive electrical components, and circuit boards. The modules of the AC-units 214 and the USB-units 212 can also be housed with an internal housing that is contained within the base housing 216.

The AC-units 214 and the USB-units 212 can also be combined within the base housing 216 into sealed modules. The sealed modules of the AC-units 214 and the USB-units 212 can include multiple AC-units 214 or multiple USB-units 212 and can share components like conductors, passive electrical components, and circuit boards. The sealed modules of the AC-units 214 and the USB-units 212 can also be housed with a sealed internal housing that is contained within the base housing 216.

The AC receptacles 210 and the USB receptacles 208 are shown exposed from multiple openings in a side 218 of the base housing 216 of the base unit 202. The side 218 can be a vertical side or a substantially vertical side of the base housing 216.

The base housing 216 is contemplated to be a lamp base having a universal shape that can be formed to resemble multiple types of existing lamp bases. It has been discovered that shaping the base unit 202 to resemble currently used bases enables greater integration of the desktop system 200 onto the desk of a user because the desktop system 200 does not occupy new desk top space but only occupies the same amount of space as any previously used desktop lamp.

The base housing 216 is contemplated to be made of plastics or metals depending on the level of quality demanded by users and supported by the market. The base unit 202 further includes a base foot 220 below the base housing 216 and connected thereto.

During manufacture, the USB receptacles 208 and the AC receptacles 210 can be mounted to the base housing 216, to the base foot 220, or a combination thereof. The base foot 220 can provide a non-slip surface for anchoring the desktop system 200 to a desktop, floor, or other surface. The base foot 220 can further provide or be coupled to a weight for providing extra stability to the desktop system 200 and additional anchoring force.

The base unit 202 is shown having a power input 222. The power input 222 is shown having a cable 224 coupled to the base foot 220 and a USB plug 226 coupled to the end of the cable 224 opposite of the base foot 220. The USB plug 226 is contemplated to be compatible with USB type-A or USB type-C receptacles.

The power from the power input 222 can be a single power type and can be conducted straight from the power input 222 through circuitry in the USB-units 212 to the USB receptacles 208 of the USB-units 212. It has been discovered that conducting the power from the power input 222 straight through the USB-units 212 without modifying the power improves the desktop system 200 by reducing manufacturing costs, complexity, and component failure points.

The single power type from the power input 222 can also be converted in circuitry in the AC-units 214 from a DC Vbus power source to an AC power and provided as an output at the AC receptacles 210 of the AC-units 214. It has been discovered that converting the power from the single power type of the power input 222 improves the desktop system 200 by reducing manufacturing costs, complexity, and component failure points because the circuitry doing the conversion can be designed for a single power type and is not required to convert multiple different types of input power.

The support 206 is shown extending from a lower support connector 228 coupled to the base housing 216. The lower support connector 228 can be a reinforcing element that is integrally molded to the base housing 216 or can be a structure affixed rigidly to the base housing 216.

The support 206 can be threaded through the lower support connector 228 and directly connected to the base housing 216 or can be coupled only to the lower support connector 228. The support 206 is further shown extending from an upper support connector 230 coupled to the lighting source 204. The upper support connector 230 can be a reinforcing element that is integrally molded to the lighting source 204 or can be a structure affixed rigidly to the lighting source 204.

The support 206 can be threaded through the upper support connector 230 and directly connected to the lighting source 204 or can be coupled only to the upper support connector 230. The lighting source 204 is depicted having a light housing 232 and a lighting base 234.

The upper support connector 230 is depicted as coupled to the light housing 232. The lighting base 234 is shown having lighting elements 236. The lighting elements 236 can be DC lighting elements including LEDs or OLEDs. The lighting elements 236 are contemplated to be configurable to emit multiple different wavelengths of light including red, blue, and multiple wavelengths of light simultaneously like white light.

The desktop system 200 can take power from the power input 222 and conduct it through the circuitry of the USB-units 212 to power the USB receptacles 208, convert it within the AC-units 214 to power the AC receptacles 210, or conduct it to the lighting elements 236 to power the lighting elements 236 directly.

It has been discovered that removing extra circuitry associated with the conversion of the power from the power input 222 to be useable with the USB-units 212 and the lighting elements 236 and directly connecting the USB receptacles 208 and the lighting elements 236 to the power input 222 greatly reduces costs and complexity of producing and designing the desktop system 200 while simultaneously reducing the number of components that could potentially fail.

Further, the desktop system 200 does not include any batteries for power storage for the power of the power input 222. That is, when the power from the power input 222 is removed the AC receptacles 210, the USB receptacles 208, and the lighting elements 236 are no longer powered. It has been discovered that providing the desktop system 200 without batteries for power storage can provide a smaller footprint, simplified design, and a lower bill of materials along with a more robust design.

The support 206 can be repositioned and moved to control where the lighting source 204 is angled. The lighting source 204 is depicted as including 12 lighting elements 236 arranged in a circle near a perimeter of the light housing 232.

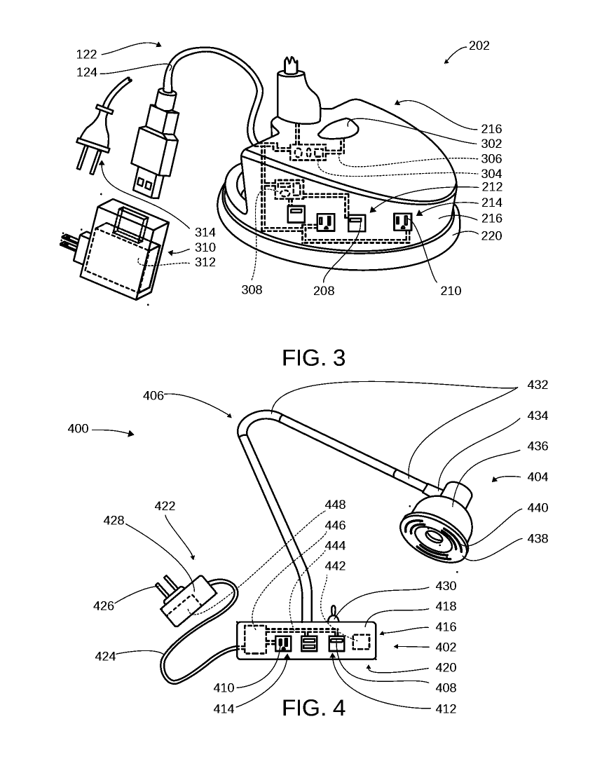

Referring now to FIG. 3, therein is shown an isometric view of the base unit 202 of FIG. 2 in an alternate configuration. The base unit 202 is shown having the USB receptacles 208 of the USB-units 212 and the AC receptacles 210 of the AC-units 214.

The base unit 202 is shown having two of the USB receptacles 208 and two of the AC receptacles 210. The USB receptacles 208 and the AC receptacles 210 are placed in an alternating pattern and exposed across the base housing 216.

The base housing 216 and the base foot 220 are enlarged and enable more of the AC receptacles 210 or the USB receptacles 208 to be exposed therefrom. Further, it has been discovered that providing the base unit 202 having a larger form factor provides more internal space for different circuitry for providing other functions.

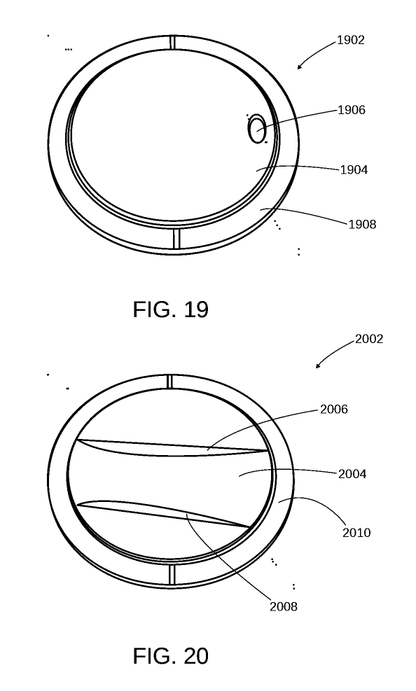

It has further been discovered that providing a larger form factor provides reduced manufacturing costs by allowing larger components to be used if available. It has further been discovered that the larger form factor of the base unit 202 can allow the rotatable unit 1900 of FIGS. 19-22 to be installed therein.

The base housing 216 is depicted having a switch 302 exposed therefrom. The switch 302 can be coupled to an illumination controller circuit 304 within the base housing 216. The illumination controller circuit 304 can be coupled and powered by the cable 124 of the power input 122.

The illumination controller circuit 304 can be coupled to the lighting source 104 thorough the support 106 for controlling the lighting source 104. The illumination controller circuit 304 can be connected to the power input 122, the lighting source 104, and to the switch 302 with internal interconnects 306.

The AC-units 214 can be coupled directly to the power input 122 while the USB-units 212 can be coupled to an adjustment circuit 308. The adjustment circuit 308 can be within the base housing 216. The adjustment circuit 308 can be coupled to the power input 122 and can convert DC power from the power input 122 into a DC Vbus power source for output on the USB receptacles 208.

It is contemplated that the power from the power input 122 can be a twelve volt DC power source that is converted to the five volt DC power source of the DC Vbus for the USB receptacles 208. The USB plug 126 of the power input 122 can be plugged into a USB receptacle or into an adapter 310.

The adapter 310 can be external to the base housing 216 and can include a converter circuit 312 for converting AC power to DC power such as an 110V AC power source to a 12V DC power source. the converter circuit could include rectifier circuitry, transformer circuitry, or other circuitry. Alternatively, an AC plug 314 is shown as an optional substitute for the USB plug 126. In some contemplated embodiments, the adapter 310 can convert the 110V AC power to the 12V DC power and the adjustment circuit 308 can further convert the 12V DC power from the adapter 310 to a 5V DC power for the USB Vbus.

It is contemplated that the lighting elements 236 of FIG. 2 can be AC lighting elements such as incandescent bulbs, compact fluorescent lamp, fluorescent tube, electro luminescent wire, or a combination thereof. It is contemplated that when implementing AC lighting elements, the lighting elements 236 can be coupled to the illumination controller circuit 304, which could be coupled to the 5adapter 310 to produce light from the lighting elements 236.

It is further contemplated that when implementing the AC lighting elements, the lighting elements 236 can be coupled directly to the AC plug 314, or the AC plug 314 could be coupled directly to the illumination controller circuit 304, which could then power the lighting elements 236. In some implementations, the AC plug 314 can be coupled to the illumination controller circuit 304 and the adjustment circuit 308 within the base housing 216.

It has been discovered that implementing the adapter 310 to convert the AC to the DC externally to the base housing 216 enables the desktop system 200 to be very versatile by allowing the desktop system to be powered by a DC source or an AC source and providing the Vbus power source for the USB receptacles 208. It has also been discovered that implementing the adapter 310 to initially convert an AC power source to an initial 12V DC power source reduces manufacturing costs while still allowing the Vbus 5V DC to be converted in the adjustment circuit 308 and provided at the USB receptacles 208.

It has been discovered that implementing the adapter 310 converting AC to DC external to the base housing 216 and also implementing the adjustment circuit 308 separate from the illumination controller circuit 304 within the base housing 216 provides high DC voltage (like the 12V DC) for quickly charging energy storage units like rechargeable batteries internal or external to the base housing 216 and still providing the increased functionality of providing the output of the adjustment circuit 308 as the Vbus 5V DC power to the USB receptacles 208.

It has been yet further discovered that implementing the adapter 310 converting AC to DC external to the base housing 216 and also implementing the adjustment circuit 308 separate from the illumination controller circuit 304 provides higher DC current for very quickly charging devices coupled to the USB receptacles 208. That is, by separating the power conversion in the adjustment circuit 308 and the control of the light source 104 with the illumination controller circuit 304 enables the adjustment circuit 308 to output from 1 amp up to 5 amps to external devices charging on the USB receptacles 208.

Referring now to FIG. 4, therein is shown an isometric side view of the desktop system 400 in a third embodiment. The desktop system 400 is depicted having a base unit 402 coupled to a lighting source 404, the base unit 402 coupled to the lighting source 404 with a support 406.

The base unit 402 is shown having USB receptacles 408 and AC receptacles 410. The USB receptacles 408 can be external receptacle portions of USB-units 412 and are contemplated to be USB type-A or USB type-C receptacles.

The USB receptacles 408 can provide active Vbus and GND pins while providing inactive D+, and D− pins. In alternative configurations, the USB receptacles 408 can provide the active Vbus and GND pins while providing no pins for D+ and D−. It is contemplated that when the USB receptacles 408 are implemented in USB receptacles other than type-A, the ID pin can also be inactive or nonexistent.

It has been discovered that providing the active Vbus and GND pins while not providing active D+, D−, or ID pins allows the desktop system 400 to be produced at a lower price point and less manufacturing complexity because no circuitry or internal connections are needed for the D+, D−, or ID pins.

It has further been discovered that providing only a USB receptacle rather than a USB plug, greatly increases the versatility and usability of the desktop system 400 by allowing users to plug in a USB charging plug that is compatible with the type-A or type-C receptacle on one end and any other USB receptacle on the other. That is, a user can use the USB receptacles 408 to charge an electronic device requiring a USB mini-A, a USB mini-B, a USB micro-A, a USB micro-B, or even a USB type-B connection by using the user's own USB charging cable.

Further it has been discovered that the USB receptacles 408 increase the ergonomic functionality and versatility of the desktop system 400 by enabling a user to plug in their charging cable and position their electronic device anywhere within reach of the desktop system 400. The electronic device can be positioned out of the way and the user can easily reach the desktop system 400 without needing to stand up, walk over to an outlet, bend over, and plug their electronic device in.

The USB receptacles 408 are shown configured with three of the USB receptacles 408 on one side of the AC receptacles 410. Two of the USB receptacles 408 are depicted vertically offset from one another, while the third USB receptacle 408 is depicted horizontally offset from the other USB receptacles 408. The AC receptacles 410 can be external receptacle portions of AC-units 414.

The AC-units 414 and the USB-units 412 can be combined within a base housing 416 into modules. The modules of the AC-units 414 and the USB-units 412 can include multiple AC-units 414 or multiple USB-units 412 and can share components like conductors, passive electrical components, and circuit boards. The modules of the AC-units 414 and the USB-units 412 can also be housed with an internal housing that is contained within the base housing 416.

The AC-units 414 and the USB-units 412 can also be combined within the base housing 416 into sealed modules. The sealed modules of the AC-units 414 and the USB-units 412 can include multiple AC-units 414 or multiple USB-units 412 and can share components like conductors, passive electrical components, and circuit boards. The sealed modules of the AC-units 414 and the USB-units 412 can also be housed with a sealed internal housing that is contained within the base housing 416.

As an illustrative example, the two USB-units 412 vertically offset from one another can be a single USB-module or sealed USB-module with an internal housing and sharing components. As a further illustrative example, each of the AC-units 414 and the USB-units 412 can be individual modules, or individual sealed modules, self-contained within their own internal housings. As a further illustrative example, the AC-units 414 along with the USB-units 412 can be combined into a single module, or sealed module, sharing an internal housing and components.

The AC receptacles 410 and the USB receptacles 408 are shown exposed from multiple openings in a side 418 of the base housing 416 of the base unit 402. The side 418 can be a vertical side or a substantially vertical side of the base housing 416.

The base housing 416 is contemplated to be a lamp base having a universal shape that can be formed to resemble multiple types of existing lamp bases. It has been discovered that shaping the base unit 402 to resemble currently used bases enables greater integration of the desktop system 400 onto the desk of a user because the desktop system 400 does not occupy new desk top space but only occupies the same amount of space as any previously used desktop lamp.

The base housing 416 is contemplated to be made of plastics or metals depending on the level of quality demanded by users and supported by the market. The base unit 402 further includes a base foot 420 below the base housing 416 and connected thereto.

During manufacture, the USB receptacles 408 and the AC receptacles 410 can be mounted to the base housing 416, to the base foot 420, or a combination thereof. The base foot 420 can provide a non-slip surface for anchoring the desktop system 400 to a desktop, floor, or other surface. The base foot 420 can further provide or be coupled to a weight for providing extra stability to the desktop system 400 and additional anchoring force.

The base unit 402 is shown having a power input 422. The power input 422 is shown having a cable 424 coupled to the base housing 416 and an AC plug 426 coupled to the end of the cable 424 opposite of the base housing 416. The AC plug 426 is contemplated to be compatible with a 120 volt 60 hertz AC receptacle or a 230 volt 50 hertz AC receptacle.

The power input 422 can include an adapter 428 coupled between the AC plug 426 and the cable 424. The adapter 428 can include a transformer, rectifier, and inverter to convert the AC power to DC.

It is contemplated that the adapter 428 can convert the input AC to 5 volts DC and provide a 1 ampere, 2.1 ampere, 3.1 ampere, 2.4 ampere, 3.4 ampere, 4.2 ampere, 4.4 ampere, or up to a 10 ampere supply. It has been discovered that providing high currents converted from AC can quickly charge mobile devices.

The power from the power input 422 can be a single power type and can be conducted straight from the adapter 428 of the power input 422 through circuitry in the USB-units 412 to the USB receptacles 408 of the USB-units 412. It has been discovered that conducting the power from the power input 422 straight through the USB-units 412 without modifying the power improves the desktop system 400 by reducing manufacturing costs, complexity, and component failure points.

It is contemplated that each of the USB-units 412 can also convert the single power type from the adapter 428 into multiple different ampere ratings. For example it is contemplated that the USB-units 412 can convert the single power type from the adapter 428 and convert it to supply a 500 milliamperes, 1,000 milliamperes, or 2,100 milliamperes DC current to the USB receptacles 408.

It is contemplated that the USB-units 412 can change the ampere rating based on the external mobile device plugged into the corresponding USB receptacle 408. It is further contemplated that the USB-units 412 can be dedicated to a specific and fixed ampere rating.

It has been discovered that providing multiple ampere ratings enables the USB-units 412 to charge different mobile devices effectively. It has been further discovered that the USB-units 412 set to supply a specific fixed ampere rating to the mobile devices reduces the complexity of the conversion circuitry required by the USB-units 412 and thus reduces manufacturing costs and complexity.

The single power type from the adapter 428 of the power input 422 can also be converted in circuitry in the AC-units 414 from a DC Vbus power source to an AC power and provided as an output at the AC receptacles 410 of the AC-units 414. It has been discovered that converting the power from the single power type of the power input 422 improves the desktop system 400 by reducing manufacturing costs, complexity, and component failure points because the circuitry doing the conversion can be designed for a single power type and is not required to convert multiple different types of input power.

It is contemplated that in alternate embodiments without the adapter 428, the power from the power input 422 can be a single power type and can be conducted straight from the AC plug 426 of the power input 422 to circuitry in the USB-units 412, which converts the power from the power input 422 to DC. The converted power from the USB-units 412 is output on the USB receptacles 408. It has been discovered that conducting the power from the power input 422 straight to the USB-units 412 without modifying the power improves the desktop system 400 by reducing manufacturing costs, complexity, and component failure points.

It is contemplated that in alternate embodiments without the adapter 428, that each of the USB-units 412 can also convert the single power type from the AC plug 426 into multiple different ampere ratings. For example it is contemplated that the USB-units 412 can convert the single power type from the AC plug 426 and convert it to supply a 500 milliamperes, 1,000 milliamperes, or 2,100 milliamperes DC current to the USB receptacles 408.

In embodiments without the adapter 428, the power from the power AC plug 426 can be a single power type and can be conducted straight from the AC plug 426 of the power input 422 through circuitry in the AC-units 414 to the AC receptacles 410. It has been discovered that conducting the power from the power input 422 straight through the AC-units 414 without modifying the power improves the desktop system 400 by reducing manufacturing costs, complexity, and component failure points.

The base unit 402 is depicted having a power switch 430 extending vertically from the base housing 416. The power switch 430 can be used to turn off the USB-units 412 and the AC-units 414. It is contemplated that the power switch 430 can be a multifunctional switch allowing the lighting source 404 to be turned off while leaving the USB-units 412 and the AC-units 414 on. It is further contemplated that the power switch 430 can turn only the lighting source 404 on and off while the AC-units 414 and the USB-units 412 are unaffected by the power switch 430.

The support 406 is shown extending from the base housing 416. The support 406 is depicted having moveable joints 432 for repositioning the lighting source 404.

The support 406 is further shown extending from an upper support connector 434 coupled to the lighting source 404. The upper support connector 434 can be a reinforcing element that is integrally molded to the lighting source 404 or can be a structure affixed rigidly to the lighting source 404.

The support 406 can be threaded through the upper support connector 434 and directly connected to the lighting source 404 or can be coupled only to the upper support connector 434. The lighting source 404 is depicted having a light housing 436 and a lighting base 438.

The upper support connector 434 is depicted as coupled to the light housing 436. The lighting base 438 is shown having lighting elements 440. The lighting elements 440 can be DC lighting elements including LEDs or OLEDs. The lighting elements 440 can further be AC lighting elements including incandescent bulbs, compact fluorescent lamp, fluorescent tube, electro luminescent wire, or a combination thereof.

It is contemplated that the lighting elements 440 can include both the DC lighting elements and the AC lighting elements in various combinations. The lighting elements 440 are contemplated to be configurable to emit multiple different wavelengths of light including red, blue, and multiple wavelengths of light simultaneously like white light.

The desktop system 400 can take power from the power input 422 and conduct it through the circuitry of the USB-units 412 to power the USB receptacles 408, convert it within the AC-units 414 to power the AC receptacles 410, or conduct it directly from the power input 422 to the lighting elements 440 to directly power the lighting elements 440.

It has been discovered that removing extra circuitry associated with the conversion of the power from the power input 422 to be useable with the USB-units 412 and the lighting elements 440 and directly connecting the USB receptacles 408 and the lighting elements 440 to the power input 422 greatly reduces costs and complexity of producing and designing the desktop system 400 while simultaneously reducing the number of components that could potentially fail.

Further, the desktop system 400 does not include any batteries for power storage for the power of the power input 422. That is, when the power from the power input 422 is removed the AC receptacles 410, the USB receptacles 408, and the lighting elements 440 are no longer powered. It has been discovered that providing the desktop system 400 without batteries for power storage can provide a smaller footprint, simplified design, and a lower bill of materials along with a more robust design. It has also been discovered that it is very difficult to supply the high current levels required by mobile devices and the lighting source 404 with batteries for power storage unit.

The support 406 can be repositioned and moved to control the direction the lighting source 404 is angled toward with the moveable joints 432. The lighting source 404 is depicted as including 7 lighting elements 440 arranged in arcs following a near a perimeter of the light housing 436 and with the lighting elements 440 in the center of the light housing 436.

The base housing 416 is depicted having the power switch 430 exposed therefrom. The power switch 430 can be coupled to an illumination controller circuit 442 within the base housing 416. The illumination controller circuit 442 can be coupled and powered by the cable 424 of the power input 422.

The illumination controller circuit 442 can be coupled to the lighting source 404 thorough the support 406 for controlling the lighting source 404. The illumination controller circuit 442 can be connected to the power input 422, the lighting source 404, and to the power switch 430 with internal interconnects 444.

The AC-units 414 can be coupled directly to an adjustment circuit 446. The USB-units 412 can also be coupled to the adjustment circuit 446.

The adjustment circuit 446 can be within the base housing 416. The adjustment circuit 446 can be coupled to the power input 422 and can convert DC power from the power input 422 into a DC Vbus power source for output on the USB receptacles 408.

It is contemplated that the power from the power input 422 can be a twelve volt DC power source that is converted to the five volt DC power source of the DC Vbus for the USB receptacles 408. The adapter 428 can be external to the base housing 416 and can include a converter circuit 448 for converting AC power to DC power such as an 110V AC power source to a 12V DC power source.

The converter circuit 448 could include rectifier circuitry, transformer circuitry, or other circuitry. In some contemplated embodiments, the adapter 428 can convert the 110V AC power to the 12V DC power and the adjustment circuit 446 can further convert the 12V DC power from the adapter 428 to a 5V DC power for the USB Vbus.

It is contemplated that the lighting elements 440 can be AC lighting elements such as incandescent bulbs, compact fluorescent lamp, fluorescent tube, electro luminescent wire, or a combination thereof. It is contemplated that when implementing AC lighting elements, the lighting elements 440 can be coupled to the illumination controller circuit 442, which could be coupled to the 5adapter 428 to produce light from the lighting elements 440.

It is further contemplated that when implementing the AC lighting elements, the lighting elements 440 can be coupled directly to the AC plug 426, or the AC plug 426 could be coupled directly to the illumination controller circuit 442, which could then power the lighting elements 440. In some implementations, the AC plug 426 can be coupled to the illumination controller circuit 442 and the adjustment circuit 446 within the base housing 416.

It has been discovered that implementing the adapter 428 to convert the AC to the DC externally to the base housing 416 enables the desktop system 400 to be very versatile by allowing the desktop system to be powered by a DC source or an AC source and providing the Vbus power source for the USB receptacles 408. It has also been discovered that implementing the adapter 428 to initially convert an AC power source to an initial 12V DC power source reduces manufacturing costs while still allowing the Vbus 5V DC to be converted by the adjustment circuit 446 and provided at the USB receptacles 408.

It has been discovered that implementing the adapter 428 converting AC to DC external to the base housing 416 and also implementing the adjustment circuit 446 separate from the illumination controller circuit 442 within the base housing 416 provides high DC voltage (like the 12V DC) for quickly charging energy storage units like rechargeable batteries internal or external to the base housing 416 and still providing the increased functionality of providing the output of the adjustment circuit 446 as the Vbus 5V DC power to the USB receptacles 408.

It has been yet further discovered that implementing the adapter 428 converting AC to DC external to the base housing 416 and also implementing the adjustment circuit 446 separate from the illumination controller circuit 442 provides higher DC current for very quickly charging devices coupled to the USB receptacles 408. That is, by separating the power conversion in the adjustment circuit 446 and the control of the light source 404 with the illumination controller circuit 442 enables the adjustment circuit 446 to output from 1 amp up to 5 amps to external devices charging on the USB receptacles 408.

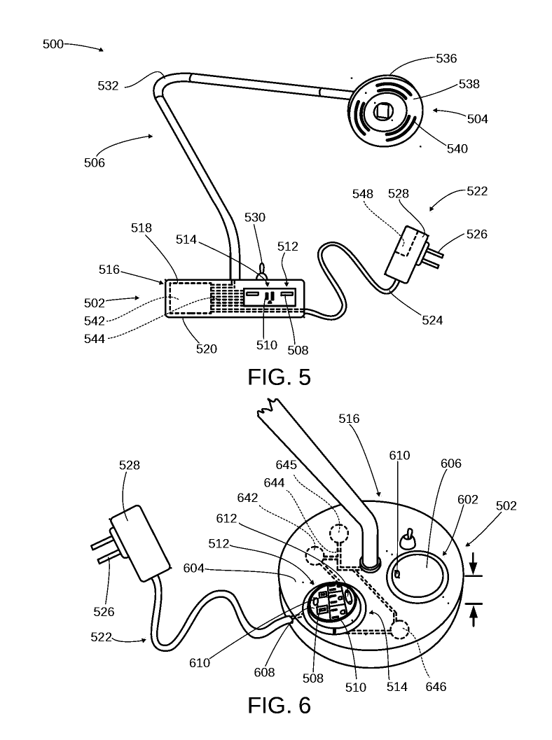

Referring now to FIG. 5, therein is shown an isometric side view of the desktop system 500 in a fourth embodiment. The desktop system 500 is depicted having a base unit 502 coupled to a lighting source 504, the base unit 502 coupled to the lighting source 504 with a support 506.

The base unit 502 is shown having USB receptacles 508 and AC receptacles 510. The USB receptacles 508 can be external receptacle portions of USB-units 512 and are contemplated to be USB type-A or USB type-C receptacles.

The USB receptacles 508 can provide active Vbus and GND pins while providing inactive D+, and D− pins. In alternative configurations, the USB receptacles 508 can provide the active Vbus and GND pins while providing no pins for D+ and D−. It is contemplated that when the USB receptacles 508 are implemented in USB receptacles other than type-A, the ID pin can also be inactive or nonexistent.

It has been discovered that providing the active Vbus and GND pins while not providing active D+, D−, or ID pins allows the desktop system 500 to be produced at a lower price point and less manufacturing complexity because no circuitry or internal connections are needed for the D+, D−, or ID pins.

It has further been discovered that providing only a USB receptacle rather than a USB plug, greatly increases the versatility and usability of the desktop system 500 by allowing users to plug in a USB charging plug that is compatible with the type-A or type-C receptacle on one end and any other USB receptacle on the other. That is, a user can use the USB receptacles 508 to charge an electronic device requiring a USB mini-A, a USB mini-B, a USB micro-A, a USB micro-B, or even a USB type-B connection by using the user's own USB charging cable.

Further it has been discovered that the USB receptacles 508 increase the ergonomic functionality and versatility of the desktop system 500 by enabling a user to plug in their charging cable and position their electronic device anywhere within reach of the desktop system 500. The electronic device can be positioned out of the way and the user can easily reach the desktop system 500 without needing to stand up, walk over to an outlet, bend over, and plug their electronic device in.

The USB receptacles 508 are shown configured with one of the USB receptacles 508 on either side of the AC receptacles 510. The AC receptacles 510 can be external receptacle portions of AC-units 514.

The AC-units 514 and the USB-units 512 can be combined within a base housing 516 into modules. The modules of the AC-units 514 and the USB-units 512 can include multiple AC-units 514 or multiple USB-units 512 and can share components like conductors, passive electrical components, and circuit boards. The modules of the AC-units 514 and the USB-units 512 can also be housed with an internal housing that is contained within the base housing 516.

The AC-units 514 and the USB-units 512 can also be combined within the base housing 516 into sealed modules. The sealed modules of the AC-units 514 and the USB-units 512 can include multiple AC-units 514 or multiple USB-units 512 and can share components like conductors, passive electrical components, and circuit boards. The sealed modules of the AC-units 514 and the USB-units 512 can also be housed with a sealed internal housing that is contained within the base housing 516.

As an illustrative example, the two USB-units 512 can be a single USB-module, or a sealed USB-module, with an internal housing and sharing components. As a further illustrative example, each of the AC-units 514 and the USB-units 512 can be individual modules, or individual sealed modules, self-contained within their own internal housings. As a further illustrative example, the AC-units 514 along with the USB-units 512 can be combined into a single module, or single sealed module, sharing an internal housing and components.

The AC receptacles 510 and the USB receptacles 508 are shown exposed from a single opening in a side 518 of the base housing 516 of the base unit 502. The side 518 can be a vertical side or a substantially vertical side of the base housing 516.

The base housing 516 is contemplated to be a lamp base having a universal shape that can be formed to resemble multiple types of existing lamp bases. It has been discovered that shaping the base unit 502 to resemble currently used bases enables greater integration of the desktop system 500 onto the desk of a user because the desktop system 500 does not occupy new desk top space but only occupies the same amount of space as any previously used desktop lamp.

The base housing 516 is contemplated to be made of plastics or metals depending on the level of quality demanded by users and supported by the market. The base unit 502 further includes a base foot 520 below the base housing 516 and connected thereto.

During manufacture, the USB receptacles 508 and the AC receptacles 510 can be mounted to the base housing 516, to the base foot 520, or a combination thereof. The base foot 520 can provide a non-slip surface for anchoring the desktop system 500 to a desktop, floor, or other surface. The base foot 520 can further provide or be coupled to a weight for providing extra stability to the desktop system 500 and additional anchoring force.

The base unit 502 is shown having a power input 522. The power input 522 is shown having a cable 524 coupled to the base housing 516 and an AC plug 526 coupled to the end of the cable 524 opposite of the base housing 516. The AC plug 526 is contemplated to be compatible with a 120 volt 60 hertz AC receptacle or a 230 volt 50 hertz AC receptacle.

The power input 522 can include an adapter 528 coupled between the AC plug 526 and the cable 524. The adapter 528 can include a transformer, rectifier, and inverter to convert the AC power to DC.

It is contemplated that the adapter 528 can convert the input AC to 5 volts DC and provide a 1 ampere, 2.1 ampere, 3.1 ampere, 2.4 ampere, 3.4 ampere, 4.2 ampere, 4.4 ampere, or up to a 10 ampere supply. It has been discovered that providing high currents converted from AC can quickly charge mobile devices.

The power from the power input 522 can be a single power type and can be conducted straight from the adapter 528 of the power input 522 through circuitry in the USB-units 512 to the USB receptacles 508 of the USB-units 512. It has been discovered that conducting the power from the power input 522 straight through the USB-units 512 without modifying the power improves the desktop system 500 by reducing manufacturing costs, complexity, and component failure points.

It is contemplated that each of the USB-units 512 can also convert the single power type from the adapter 528 into multiple different ampere ratings. For example it is contemplated that the USB-units 512 can convert the single power type from the adapter 528 and convert it to supply a 500 milliamperes, 1,000 milliamperes, or 2,100 milliamperes DC current to the USB receptacles 508.

It is contemplated that the USB-units 512 can change the ampere rating based on the external mobile device plugged into the corresponding USB receptacle 508. It is further contemplated that the USB-units 512 can be dedicated to a specific and fixed ampere rating.

It has been discovered that providing multiple ampere ratings enables the USB-units 512 to charge different mobile devices effectively. It has been further discovered that the USB-units 512 set to supply a specific fixed ampere rating to the mobile devices reduces the complexity of the conversion circuitry required by the USB-units 512 and thus reduces manufacturing costs and complexity.

The single power type from the adapter 528 of the power input 522 can also be converted in circuitry in the AC-units 514 from a DC Vbus power source to an AC power and provided as an output at the AC receptacles 510 of the AC-units 514. It has been discovered that converting the power from the single power type of the power input 522 improves the desktop system 500 by reducing manufacturing costs, complexity, and component failure points because the circuitry doing the conversion can be designed for a single power type and is not required to convert multiple different types of input power.

It is contemplated that in alternate embodiments without the adapter 528, the power from the power input 522 can be a single power type and can be conducted straight from the AC plug 526 of the power input 522 to circuitry in the USB-units 512, which converts the power from the power input 522 to DC. The converted power from the USB-units 512 is output on the USB receptacles 508. It has been discovered that conducting the power from the power input 522 straight to the USB-units 512 without modifying the power improves the desktop system 500 by reducing manufacturing costs, complexity, and component failure points.

It is contemplated that in alternate embodiments without the adapter 528, that each of the USB-units 512 can also convert the single power type from the AC plug 526 into multiple different ampere ratings. For example it is contemplated that the USB-units 512 can convert the single power type from the AC plug 526 and convert it to supply a 500 milliamperes, 1,000 milliamperes, or 2,100 milliamperes DC current to the USB receptacles 508.

In embodiments without the adapter 528, the power from the power AC plug 526 can be a single power type and can be conducted straight from the AC plug 526 of the power input 522 through circuitry in the AC-units 514 to the AC receptacles 510. It has been discovered that conducting the power from the power input 522 straight through the AC-units 514 without modifying the power improves the desktop system 500 by reducing manufacturing costs, complexity, and component failure points.

The base unit 502 is depicted having a power switch 530 extending vertically from the base housing 516. The power switch 530 can be used to turn off the USB-units 512 and the AC-units 514. It is contemplated that the power switch 530 can be a multifunctional switch allowing the lighting source 504 to be turned off while leaving the USB-units 512 and the AC-units 514 on. It is further contemplated that the power switch 530 can turn only the lighting source 504 on and off while the AC-units 514 and the USB-units 512 are unaffected by the power switch 530.

The support 506 is shown extending from the base housing 516. The support 506 is depicted having moveable joints 532 for repositioning the lighting source 504. The lighting source 504 is depicted having a light housing 536 and a lighting base 538.

The lighting base 538 is shown having lighting elements 540. The lighting elements 540 can be AC lighting elements including incandescent bulbs, compact fluorescent lamp, fluorescent tube, electro luminescent wire, or a combination thereof. The lighting elements 540 are contemplated to be configurable to emit multiple different wavelengths of light including red, blue, and multiple wavelengths of light simultaneously like white light.

The desktop system 500 can take power from the power input 522 and conduct it through the circuitry of the USB-units 512 to power the USB receptacles 508, convert it within the AC-units 514 to power the AC receptacles 510, or conduct it directly from the power input 522 to the lighting elements 540 to directly power the lighting elements 540.

It has been discovered that removing extra circuitry associated with the conversion of the power from the power input 522 to be useable with the USB-units 512 and the lighting elements 540 and directly connecting the USB receptacles 508 and the lighting elements 540 to the power input 522 greatly reduces costs and complexity of producing and designing the desktop system 500 while simultaneously reducing the number of components that could potentially fail.

Further, the desktop system 500 does not include any batteries for power storage for the power of the power input 522. That is, when the power from the power input 522 is removed the AC receptacles 510, the USB receptacles 508, and the lighting elements 540 are no longer powered. It has been discovered that providing the desktop system 500 without batteries for power storage can provide a smaller footprint, simplified design, and a lower bill of materials along with a more robust design. It has also been discovered that it is very difficult to supply the high current levels required by mobile devices and the lighting source 504 with batteries for power storage unit.

The support 506 can be repositioned and moved to control the direction the lighting source 504 is angled toward with the moveable joints 532. The lighting source 504 is depicted as including 6 lighting elements 540 arranged in arcs following a near a perimeter of the light housing 536.

The base housing 516 is depicted having the power switch 530 exposed therefrom. The power switch 530 can be coupled to an internal circuit 542. The internal circuit 542 can include an illumination controller and an adjustment circuit and can be affixed within the base housing 516. The illumination controller of the internal circuit 542 can be coupled and powered by the cable 524 of the power input 522.

The illumination controller of the internal circuit 542 can be coupled to the lighting source 504 thorough the support 506 for controlling the lighting source 504. The illumination controller of the internal circuit 542 can be connected to the power input 522, the lighting source 504, and to the power switch 530 with internal interconnects 544.

The AC-units 514 can be coupled directly to the adjustment circuit of the internal circuit 542. The USB-units 512 can also be coupled to the adjustment circuit of the internal circuit 542.

The adjustment circuit of the internal circuit 542 can be within the base housing 516. The adjustment circuit of the internal circuit 542 can be coupled to the power input 522 and can convert DC power from the power input 522 into a DC Vbus power source for output on the USB receptacles 508.

It is contemplated that the power from the power input 522 can be a twelve volt DC power source that is converted to the five volt DC power source of the DC Vbus for the USB receptacles 508. The adapter 528 can be external to the base housing 516 and can include a converter circuit 548 for converting AC power to DC power such as an 110V AC power source to a 12V DC power source.

The converter circuit 548 could include rectifier circuitry, transformer circuitry, or other circuitry. In some contemplated embodiments, the adapter 528 can convert the 110V AC power to the 12V DC power and the adjustment circuit of the internal circuit 542 can further convert the 12V DC power from the adapter 528 to a 5V DC power for the USB Vbus.

It is contemplated that the lighting elements 540 can be AC lighting elements such as incandescent bulbs, compact fluorescent lamp, fluorescent tube, electro luminescent wire, or a combination thereof. It is contemplated that when implementing AC lighting elements, the lighting elements 540 can be coupled to the illumination controller of the internal circuit 542, which could be coupled to the adapter 528 to produce light from the lighting elements 540.

It is further contemplated that when implementing the AC lighting elements, the lighting elements 540 can be coupled directly to the AC plug 526, or the AC plug 526 could be coupled directly to the illumination controller of the internal circuit 542, which could then power the lighting elements 540. In some implementations, the AC plug 526 can be coupled to the illumination controller and the adjustment circuit of the internal circuit 542 within the base housing 516.

It has been discovered that implementing the adapter 528 to convert the AC to the DC externally to the base housing 516 enables the desktop system 500 to be very versatile by allowing the desktop system to be powered by a DC source or an AC source and providing the Vbus power source for the USB receptacles 508. It has also been discovered that implementing the adapter 528 to initially convert an AC power source to an initial 12V DC power source reduces manufacturing costs while still allowing the Vbus 5V DC to be converted by the adjustment circuit of the internal circuit 542 and provided at the USB receptacles 508.

Referring now to FIG. 6, therein is shown an isometric view of the base unit 502 of FIG. 5 in an alternate configuration. The base unit 502 is shown having the USB receptacles 508 of the USB-units 512 and the AC receptacles 510 of the AC-units 514.

The base unit 502 is shown having two of the USB receptacles 508 and three of the AC receptacles 510. The USB receptacles 508 and the AC receptacles 510 are placed in rotatable units 602. The base housing 516 of the base unit 502 is shown having two of the rotatable units 602 positioned on a top side 604 of the base housing 516.

One of the rotatable units 602 is depicted having a first side 606 exposed from the top side 604 of the base housing 516. The first side 606 is depicted as a flat side with a clean surface.

The other one of the rotatable units 602 is depicted having a second side 608 exposed from the top side 604 of the base housing 516. The second side 608 is depicted having the AC receptacles 510 and the USB receptacles 508 exposed therefrom.

The rotatable units 602 can include a release and a locker that can be used to maintain the rotatable units 602 with the first side 606 or the second side 608 facing up. The release and locker of the rotatable units 602 can be a press release and locker system that is elastic and will transition from the first side 606 to the second side 608 when the first side 606 of the rotatable units 602 is pressed by a user.

Alternatively, it is contemplated that the rotatable units 602 can rotate from the second side 608 to the first side 606 when the second side of the rotatable units 602 is pressed by a user. The second side 608 is contemplated, in other embodiments, to include other receptacles such as receptacles for internet, phone, or digital data.

The second side 608 and the first side 606 are also shown having indicator lights 610 that can visually depict the charging or the charging status of a device plugged into the AC receptacles 510 or the USB receptacles 508. The indicator lights 610 can also show the power status of the desktop system 500, that is whether the desktop system 500 is powered or whether the desktop system 500 is turned on.

The rotatable units 602 are further depicted having a marking plate 612 on the second side 608. The marking plate 612 can include the power ratings of the AC receptacles 510 and the USB receptacles 508. As an illustrative example, the marking plate 612 can identify a maximum wattage such as 1,650 Watt for all external electronic devices plugged into the rotatable units 602.

The AC-units 514 and the USB-units 512 can be combined within the rotatable units 602 of the base housing 516 into modules. The modules of the AC-units 514 and the USB-units 512 can include multiple AC-units 514 or multiple USB-units 512 and can share components like conductors, passive electrical components, and circuit boards. The modules of the AC-units 514 and the USB-units 512 can also be housed with an internal housing that is contained within the rotatable units 602 of the base housing 516.

The AC-units 514 and the USB-units 512 can also be combined within the rotatable units 602 of the base housing 516 into sealed modules. The sealed modules of the AC-units 514 and the USB-units 512 can include multiple AC-units 514 or multiple USB-units 512 and can share components like conductors, passive electrical components, and circuit boards. The sealed modules of the AC-units 514 and the USB-units 512 can also be housed with a sealed internal housing that is contained within the rotatable units 602 of the base housing 516.

As an illustrative example, the two USB-units 512 can be a single USB-module, or a sealed USB-module, with an internal housing and sharing components. Alternatively, the two USB-units 512 can be different USB-modules, or sealed USB-modules, with individual internal housings within the rotatable units 602 of the base housing 516.

As a further illustrative example, each of the AC-units 514 can be a single AC-module, or a sealed AC-module, with an internal housing and sharing components. Alternatively, the three AC-units 514 can be different AC-modules, or sealed AC-modules, with individual internal housings within the rotatable units 602 of the base housing 516. As a further illustrative example, the AC-units 514 along with the USB-units 512 can be combined into a single module, or single sealed module, sharing an internal housing and components.

The power from the power input 522 can be a single power type and can be conducted straight from the adapter 528 of the power input 522 through circuitry in the USB-units 512 to the USB receptacles 508 of the USB-units 512. It has been discovered that conducting the power from the power input 522 straight through the USB-units 512 without modifying the power improves the desktop system 500 by reducing manufacturing costs, complexity, and component failure points.

It is contemplated that each of the USB-units 512 can also convert the single power type from the adapter 528 into multiple different ampere ratings. For example it is contemplated that the USB-units 512 can convert the single power type from the adapter 528 and convert it to supply a 500 milliamperes, 1,000 milliamperes, or 2,100 milliamperes DC current to the USB receptacles 508.

It is contemplated that the USB-units 512 can change the ampere rating based on the external mobile device plugged into the corresponding USB receptacle 508. It is further contemplated that the USB-units 512 can be dedicated to a specific and fixed ampere rating.

It has been discovered that providing multiple ampere ratings enables the USB-units 512 to charge different mobile devices effectively. It has been further discovered that the USB-units 512 set to supply a specific fixed ampere rating to the mobile devices reduces the complexity of the conversion circuitry required by the USB-units 512 and thus reduces manufacturing costs and complexity.

The single power type from the adapter 528 of the power input 522 can also be converted in circuitry in the AC-units 514 from a DC Vbus power source to an AC power and provided as an output at the AC receptacles 510 of the AC-units 514. It has been discovered that converting the power from the single power type of the power input 522 improves the desktop system 500 by reducing manufacturing costs, complexity, and component failure points because the circuitry doing the conversion can be designed for a single power type and is not required to convert multiple different types of input power.

It is contemplated that in alternate embodiments without the adapter 528, the power from the power input 522 can be a single power type and can be conducted straight from the AC plug 526 of the power input 522 to circuitry in the USB-units 512, which converts the power from the power input 522 to DC. The converted power from the USB-units 512 is output on the USB receptacles 508. It has been discovered that conducting the power from the power input 522 straight to the USB-units 512 without modifying the power improves the desktop system 500 by reducing manufacturing costs, complexity, and component failure points.

It is contemplated that in alternate embodiments without the adapter 528, that each of the USB-units 512 can also convert the single power type from the AC plug 526 into multiple different ampere ratings. For example it is contemplated that the USB-units 512 can convert the single power type from the AC plug 526 and convert it to supply a 500 milliamperes, 1,000 milliamperes, or 2,100 milliamperes DC current to the USB receptacles 508.

In embodiments without the adapter 528, the power from the power AC plug 526 can be a single power type and can be conducted straight from the AC plug 526 of the power input 522 through circuitry in the AC-units 514 to the AC receptacles 510. It has been discovered that conducting the power from the power input 522 straight through the AC-units 514 without modifying the power improves the desktop system 500 by reducing manufacturing costs, complexity, and component failure points.

The base housing 516 and the base foot 520 are enlarged and enable more of the AC receptacles 510 or the USB receptacles 508 to be exposed therefrom. Further, it has been discovered that providing the base unit 502 having a larger, thicker form factor provides more internal space for different circuitry for providing other functions. It has further been discovered that providing a larger form factor provides reduced manufacturing costs by allowing larger components to be used if available.

In an alternative configuration, an illumination controller circuit 642 within the base housing 616. The illumination controller circuit 642 can be coupled and powered by the cable 524 of FIG. 5 of the power input 522.

The illumination controller circuit 642 can be coupled to the lighting source 504 of FIG. 5 thorough the support 506 of FIG. 5 for controlling the lighting source 504. The illumination controller circuit 642 can be connected to the power input 522 and the lighting source 504 with internal interconnects 644.

The AC-units 514 can be coupled directly to an AC circuit 645. The USB-units 612 can be coupled to an adjustment circuit 646.

The adjustment circuit 646, the AC circuit 645, and the illumination controller circuit 642 can be within the base housing 516. The adjustment circuit 646, the AC circuit 645, and the illumination controller circuit 642 can be coupled to the power input 522. In the present contemplated configuration, the power input 522 can be an AC power source.

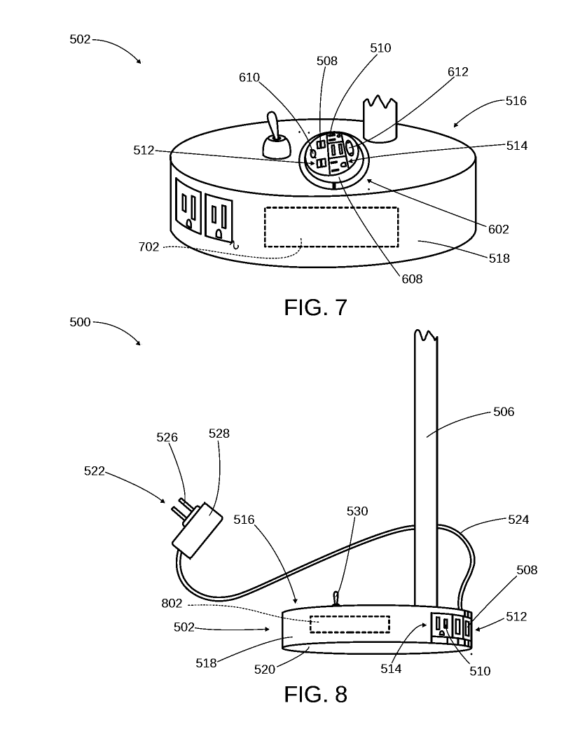

Referring now to FIG. 7, therein is shown an isometric view of the base unit 502 of FIG. 5 in an alternate configuration. The base unit 502 is shown having the USB receptacles 508 of the USB-units 512 and the AC receptacles 510 of the AC-units 514.

The base unit 502 is shown having two of the USB receptacles 508 and three of the AC receptacles 510 in the rotatable unit 602. The base unit 502 is further shown having two of the AC receptacles 510 in the side 518 of the base housing 516.

The base housing 516 of the base unit 502 is shown having one of the rotatable units 602 positioned on the top side 604 of the base housing 516. The rotatable unit 602 is contemplated to include a first flat side 606 of FIG. 6 with a clean surface on the other side of the second side 608, which is depicted as facing up on the rotatable unit 602.

The second side 608 of the rotatable unit 602 is depicted exposed from the top side 604 of the base housing 516. The second side 608 is depicted having the AC receptacles 510 and the USB receptacles 508 exposed therefrom.

The rotatable unit 602 can include a release and a locker that can be used to maintain the rotatable unit 602 with the first side 606 or the second side 608 facing up. The release and locker of the rotatable unit 602 can be a press release and locker system that is elastic and will transition from the first side 606 to the second side 608 when the first side 606 of the rotatable unit 602 is pressed by a user.

Alternatively, it is contemplated that the rotatable unit 602 can rotate from the second side 608 to the first side 606 when the second side of the rotatable unit 602 is pressed by a user. The second side 608 is contemplated, in other embodiments, to include other receptacles such as receptacles for internet, phone, or digital data.

The second side 608 is also shown having an indicator light 610 that can visually depict the charging or the charging status of a device plugged into the AC receptacles 510 or the USB receptacles 508. The indicator light 610 can also show the power status of the desktop system 500, that is whether the desktop system 500 is powered or whether the desktop system 500 is turned on. It is contemplated that the indicator light 610 can be an LED indicator light.

The rotatable unit 602 is further depicted having a marking plate 612 on the second side 608. The marking plate 612 can include the power ratings of the AC receptacles 510 and the USB receptacles 508. As an illustrative example, the marking plate 612 can identify a maximum wattage such as 1,650 Watt for all external electronic devices plugged into the rotatable unit 602.

The AC-units 514 and the USB-units 512 can be combined within the rotatable unit 602 of the base housing 516 into modules. The modules of the AC-units 514 and the USB-units 512 can include multiple AC-units 514 or multiple USB-units 512 and can share components like conductors, passive electrical components, and circuit boards. The modules of the AC-units 514 and the USB-units 512 can also be housed with an internal housing that is contained within the rotatable unit 602 of the base housing 516.

The AC-units 514 and the USB-units 512 can also be combined within the rotatable unit 602 of the base housing 516 into sealed modules. The sealed modules of the AC-units 514 and the USB-units 512 can include multiple AC-units 514 or multiple USB-units 512 and can share components like conductors, passive electrical components, and circuit boards. The sealed modules of the AC-units 514 and the USB-units 512 can also be housed with a sealed internal housing that is contained within the rotatable unit 602 of the base housing 516.

As an illustrative example, the two USB-units 512 can be a single USB-module, or a sealed USB-module, with an internal housing and sharing components. Alternatively, the two USB-units 512 can be different USB-modules, or sealed USB-modules, with individual internal housings within the rotatable unit 602 of the base housing 516.

As a further illustrative example, each of the AC-units 514 can be a single AC-module, or a sealed AC-module, with an internal housing and sharing components. Alternatively, the three AC-units 514 can be different AC-modules, or sealed AC-modules, with individual internal housings within the rotatable unit 602 of the base housing 516. As a further illustrative example, the AC-units 514 along with the USB-units 512 can be combined into a single module, or single sealed module, sharing an internal housing and components.

The AC-units 514 exposed from the side 518 of the base housing 516 can be a module. The module of the AC-units 514 can share components like conductors, passive electrical components, and circuit boards. The module of the AC-units 514 can also be housed with an internal housing that is contained within the base housing 516.

The AC-units 514 exposed from the side 518 of the base housing 516 can be a sealed module. The sealed module of the AC-units 514 can share components like conductors, passive electrical components, and circuit boards. The sealed module of the AC-units 514 can also be housed with an internal housing that is contained within the base housing 516. Alternatively, the two AC-units 514 can be different modules, or sealed modules, with individual internal housings within the base housing 516.

The power from the power input 522 of FIG. 5 can be a single power type and can be conducted straight from the adapter 528 of FIG. 5 through circuitry in the USB-units 512 to the USB receptacles 508 of the USB-units 512. It has been discovered that conducting the power from the power input 522 straight through the USB-units 512 without modifying the power improves the desktop system 500 by reducing manufacturing costs, complexity, and component failure points.

It is contemplated that each of the USB-units 512 can also convert the single power type from the adapter 528 into multiple different ampere ratings. For example it is contemplated that the USB-units 512 can convert the single power type from the adapter 528 and convert it to supply a 500 milliamperes, 1,000 milliamperes, or 2,100 milliamperes DC current to the USB receptacles 508.

It is contemplated that the USB-units 512 can change the ampere rating based on the external mobile device plugged into the corresponding USB receptacle 508. It is further contemplated that the USB-units 512 can be dedicated to a specific and fixed ampere rating.

It has been discovered that providing multiple ampere ratings enables the USB-units 512 to charge different mobile devices effectively. It has been further discovered that the USB-units 512 set to supply a specific fixed ampere rating to the mobile devices reduces the complexity of the conversion circuitry required by the USB-units 512 and thus reduces manufacturing costs and complexity.

The single power type from the adapter 528 of the power input 522 can also be converted in circuitry in the AC-units 514 from a DC Vbus power source to an AC power and provided as an output at the AC receptacles 510 of the AC-units 514. It has been discovered that converting the power from the single power type of the power input 522 improves the desktop system 500 by reducing manufacturing costs, complexity, and component failure points because the circuitry doing the conversion can be designed for a single power type and is not required to convert multiple different types of input power.

It is contemplated that in alternate embodiments without the adapter 528, the power from the power input 522 can be a single power type and can be conducted straight from the AC plug 526 of FIG. 5 of the power input 522 to circuitry in the USB-units 512, which converts the power from the power input 522 to DC. The converted power from the USB-units 512 is output on the USB receptacles 508. It has been discovered that conducting the power from the power input 522 straight to the USB-units 512 without modifying the power improves the desktop system 500 by reducing manufacturing costs, complexity, and component failure points.

It is contemplated that in alternate embodiments without the adapter 528, that each of the USB-units 512 can also convert the single power type from the AC plug 526 into multiple different ampere ratings. For example it is contemplated that the USB-units 512 can convert the single power type from the AC plug 526 and convert it to supply a 500 milliamperes, 1,000 milliamperes, or 2,100 milliamperes DC current to the USB receptacles 508.

In embodiments without the adapter 528, the power from the power AC plug 526 can be a single power type and can be conducted straight from the AC plug 526 of the power input 522 through circuitry in the AC-units 514 to the AC receptacles 510. It has been discovered that conducting the power from the power input 522 straight through the AC-units 514 without modifying the power improves the desktop system 500 by reducing manufacturing costs, complexity, and component failure points.

The base housing 516 and the base foot 520 are enlarged and enable more of the AC receptacles 510 or the USB receptacles 508 to be exposed therefrom. Further, it has been discovered that providing the base unit 502 having a larger, thicker form factor provides more internal space for different circuitry for providing other functions. It has further been discovered that providing a larger form factor provides reduced manufacturing costs by allowing larger components to be used if available.

Within the base housing 516 is shown an IC adjustment circuit 702. The IC adjustment circuit 702 can take high voltage, such as a 12V DC power source, and convert the high voltage power source to a high current Vbus for quickly charging external UBS devices.

Referring now to FIG. 8, therein is shown an isometric side view of the base unit 502 of FIG. 5 in an alternate configuration. The desktop system 500 is depicted having the base unit 502 coupled to the support 506.

The base unit 502 is shown having the USB receptacles 508 and the AC receptacle 510. The USB receptacles 508 can be external receptacle portions of the USB-units 512 and are contemplated to be USB type-A or USB type-C receptacles.

The USB receptacles 508 can provide active Vbus and GND pins while providing inactive D+, and D− pins. In alternative configurations, the USB receptacles 508 can provide the active Vbus and GND pins while providing no pins for D+ and D−. It is contemplated that when the USB receptacles 508 are implemented in USB receptacles other than type-A, the ID pin can also be inactive or nonexistent.

It has been discovered that providing the active Vbus and GND pins while not providing active D+, D−, or ID pins allows the desktop system 500 to be produced at a lower price point and less manufacturing complexity because no circuitry or internal connections are needed for the D+, D−, or ID pins.

It has further been discovered that providing only a USB receptacle rather than a USB plug, greatly increases the versatility and usability of the desktop system 500 by allowing users to plug in a USB charging plug that is compatible with the type-A or type-C receptacle on one end and any other USB receptacle on the other. That is, a user can use the USB receptacles 508 to charge an electronic device requiring a USB mini-A, a USB mini-B, a USB micro-A, a USB micro-B, or even a USB type-B connection by using the user's own USB charging cable.

Further it has been discovered that the USB receptacles 508 increase the ergonomic functionality and versatility of the desktop system 500 by enabling a user to plug in their charging cable and position their electronic device anywhere within reach of the desktop system 500. The electronic device can be positioned out of the way and the user can easily reach the desktop system 500 without needing to stand up, walk over to an outlet, bend over, and plug their electronic device in.

The USB receptacles 508 are shown configured with one of two of the USB receptacles 508 on one side of the AC receptacle 510. The AC receptacle 510 can be an external receptacle portion of the AC-unit 514.

The AC-unit 514 and the USB-units 512 can be combined within the base housing 516 into modules. The modules of the AC-unit 514 and the USB-units 512 can include the AC-unit 514 or multiple USB-units 512 and can share components like conductors, passive electrical components, and circuit boards. The modules of the AC-unit 514 and the USB-units 512 can also be housed with an internal housing that is contained within the base housing 516.

The AC-unit 514 and the USB-units 512 can also be combined within the base housing 516 into sealed modules. The sealed modules of the AC-unit 514 and the USB-units 512 can include the AC-unit 514 or multiple USB-units 512 and can share components like conductors, passive electrical components, and circuit boards. The sealed modules of the AC-unit 514 and the USB-units 512 can also be housed with a sealed internal housing that is contained within the base housing 516.

As an illustrative example, the two USB-units 512 can be a single USB-module, or a sealed USB-module, with an internal housing and sharing components. As a further illustrative example, each of the AC-unit 514 and the USB-units 512 can be individual modules, or individual sealed modules, self-contained within their own internal housings. As a further illustrative example, the AC-unit 514 along with the USB-units 512 can be combined into a single module, or single sealed module, sharing an internal housing and components.

The AC receptacle 510 and the USB receptacles 508 are shown exposed from a single opening in the side 518 of the base housing 516 of the base unit 502. The side 518 can be a vertical side or a substantially vertical side of the base housing 516.

The base housing 516 is contemplated to be a lamp base having a universal shape that can be formed to resemble multiple types of existing lamp bases. It has been discovered that shaping the base unit 502 to resemble currently used bases enables greater integration of the desktop system 500 onto the desk of a user because the desktop system 500 does not occupy new desk top space but only occupies the same amount of space as any previously used desktop lamp.

The base housing 516 is contemplated to be made of plastics or metals depending on the level of quality demanded by users and supported by the market. The base unit 502 further includes the base foot 520 below the base housing 516 and connected thereto.

During manufacture, the USB receptacles 508 and the AC receptacle 510 can be mounted to the base housing 516, to the base foot 520, or a combination thereof. The base foot 520 can provide a non-slip surface for anchoring the desktop system 500 to a desktop, floor, or other surface. The base foot 520 can further provide or be coupled to a weight for providing extra stability to the desktop system 500 and additional anchoring force.

The base unit 502 is shown having the power input 522. The power input 522 is shown having the cable 524 coupled to the base housing 516 and an AC plug 526 coupled to the end of the cable 524 opposite of the base housing 516. The AC plug 526 is contemplated to be compatible with a 120 volt 60 hertz AC receptacle or a 230 volt 50 hertz AC receptacle.

The power input 522 can include an adapter 528 coupled between the AC plug 526 and the cable 524. The adapter 528 can include a transformer, rectifier, and inverter to convert the AC power to DC.

It is contemplated that the adapter 528 can convert the input AC to 5 volts DC and provide a 1 ampere, 2.1 ampere, 3.1 ampere, 2.4 ampere, 3.4 ampere, 4.2 ampere, 4.4 ampere, or up to a 10 ampere supply. It has been discovered that providing high currents converted from AC can quickly charge mobile devices.

The power from the power input 522 can be a single power type and can be conducted straight from the adapter 528 of the power input 522 through circuitry in the USB-units 512 to the USB receptacles 508 of the USB-units 512. It has been discovered that conducting the power from the power input 522 straight through the USB-units 512 without modifying the power improves the desktop system 500 by reducing manufacturing costs, complexity, and component failure points.

It is contemplated that each of the USB-units 512 can also convert the single power type from the adapter 528 into multiple different ampere ratings. For example it is contemplated that the USB-units 512 can convert the single power type from the adapter 528 and convert it to supply a 500 milliamperes, 1,000 milliamperes, or 2,100 milliamperes DC current to the USB receptacles 508.

It is contemplated that the USB-units 512 can change the ampere rating based on the external mobile device plugged into the corresponding USB receptacle 508. It is further contemplated that the USB-units 512 can be dedicated to a specific and fixed ampere rating.

It has been discovered that providing multiple ampere ratings enables the USB-units 512 to charge different mobile devices effectively. It has been further discovered that the USB-units 512 set to supply a specific fixed ampere rating to the mobile devices reduces the complexity of the conversion circuitry required by the USB-units 512 and thus reduces manufacturing costs and complexity.

The single power type from the adapter 528 of the power input 522 can also be converted in circuitry in the AC-unit 514 from a DC Vbus power source to an AC power and provided as an output at the AC receptacle 510 of the AC-unit 514. It has been discovered that converting the power from the single power type of the power input 522 improves the desktop system 500 by reducing manufacturing costs, complexity, and component failure points because the circuitry doing the conversion can be designed for a single power type and is not required to convert multiple different types of input power.

It is contemplated that in alternate embodiments without the adapter 528, the power from the power input 522 can be a single power type and can be conducted straight from the AC plug 526 of the power input 522 to circuitry in the USB-units 512, which converts the power from the power input 522 to DC. The converted power from the USB-units 512 is output on the USB receptacles 508. It has been discovered that conducting the power from the power input 522 straight to the USB-units 512 without modifying the power improves the desktop system 500 by reducing manufacturing costs, complexity, and component failure points.

It is contemplated that in alternate embodiments without the adapter 528, that each of the USB-units 512 can also convert the single power type from the AC plug 526 into multiple different ampere ratings. For example it is contemplated that the USB-units 512 can convert the single power type from the AC plug 526 and convert it to supply a 500 milliamperes, 1,000 milliamperes, or 2,100 milliamperes DC current to the USB receptacles 508.

In embodiments without the adapter 528, the power from the power AC plug 526 can be a single power type and can be conducted straight from the AC plug 526 of the power input 522 through circuitry in the AC-unit 514 to the AC receptacle 510. It has been discovered that conducting the power from the power input 522 straight through the AC-unit 514 without modifying the power improves the desktop system 500 by reducing manufacturing costs, complexity, and component failure points.

The base unit 502 is depicted having the power switch 530 extending vertically from the base housing 516. The power switch 530 can be used to turn off the USB-units 512 and the AC-unit 514. It is contemplated that the power switch 530 can be a multifunctional switch allowing the lighting source 504 to be turned off while leaving the USB-units 512 and the AC-unit 514 on.

It is further contemplated that the power switch 530 can turn only the lighting source 504 on and off while the AC-unit 514 and the USB-units 512 are unaffected by the power switch 530. The support 506 is shown extending from the base housing 516.

Within the base housing 516 is shown an IC adjustment circuit 802. The IC adjustment circuit 802 can take high voltage, such as a 12V DC power source, and convert the high voltage power source to a high current Vbus for quickly charging external UBS devices.

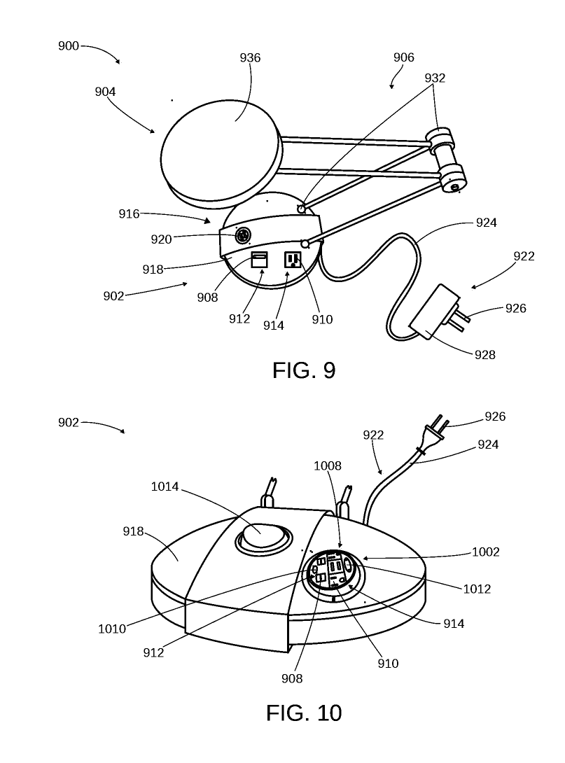

Referring now to FIG. 9, therein is shown an isometric top view of the desktop system 900 in a fifth embodiment. The desktop system 900 is depicted having a base unit 902 coupled to a lighting source 904, the base unit 902 coupled to the lighting source 904 with a support 906.

The support 906 is shown to include adjustable arms to enable the adjustment of the height, orientation, direction, and angle of the lighting source 904. The lighting source 904 is contemplated to be an LED lamp.

The base unit 902 is shown having a USB receptacle 908 and an AC receptacle 910. The USB receptacle 908 can be external receptacle portions of a USB-unit 912 and is contemplated to be USB type-A or USB type-C receptacle.

The USB receptacle 908 can provide active Vbus and GND pins while providing inactive D+, and D− pins. In alternative configurations, the USB receptacle 908 can provide the active Vbus and GND pins while providing no pins for D+ and D−. It is contemplated that when the USB receptacle 908 is implemented in USB receptacles other than type-A, the ID pin can also be inactive or nonexistent.

It has been discovered that providing the active Vbus and GND pins while not providing active D+, D−, or ID pins allows the desktop system 900 to be produced at a lower price point and less manufacturing complexity because no circuitry or internal connections are needed for the D+, D−, or ID pins.

It has further been discovered that providing only a USB receptacle rather than a USB plug, greatly increases the versatility and usability of the desktop system 900 by allowing users to plug in a USB charging plug that is compatible with the type-A or type-C receptacle on one end and any other USB receptacle on the other. That is, a user can use the USB receptacle 908 to charge an electronic device requiring a USB mini-A, a USB mini-B, a USB micro-A, a USB micro-B, or even a USB type-B connection by using the user's own USB charging cable.

Further, it has been discovered that the USB receptacle 908 increase the ergonomic functionality and versatility of the desktop system 900 by enabling a user to plug in their charging cable and position their electronic device anywhere within reach of the desktop system 900. The electronic device can be positioned out of the way and the user can easily reach the desktop system 900 without needing to stand up, walk over to an outlet, bend over, and plug their electronic device in.

The USB receptacle 908 is shown beside the AC receptacle 910. The AC receptacle 910 can be an external receptacle portion of an AC-unit 914. It has been discovered that implementing the base unit 902 with only one USB-unit 912 and one AC-unit 914 enables the base unit 902 to be constructed at a lower cost because the USB-unit 912 and the AC-unit 914 do not need to be made as compact.

The AC-unit 914 and the USB-unit 912 can be combined within a base housing 916 into a module. The module of the AC-unit 914 and the USB-unit 912 can share components like conductors, passive electrical components, and circuit boards. The module of the AC-unit 914 and the USB-unit 912 can also be housed with an internal housing that is contained within the base housing 916.

The AC-unit 914 and the USB-unit 912 can also be combined within the base housing 916 into a sealed module. The sealed module of the AC-unit 914 and the USB-unit 912 can share components like conductors, passive electrical components, and circuit boards. The sealed module of the AC-unit 914 and the USB-unit 912 can also be housed with a sealed internal housing that is contained within the base housing 916.

As an illustrative example, the AC-unit 914 and the USB-unit 912 can be individual modules, or individual sealed modules, self-contained within their own internal housings. As a further illustrative example, the AC-unit 914 along with the USB-unit 912 can be combined into a single module, or single sealed module, sharing an internal housing and components.

The AC receptacle 910 and the USB receptacle 908 are shown exposed from a single opening in a top side 918 of the base housing 916 of the base unit 902. The top side 918 can be a curved side.

The base housing 916 is contemplated to be a lamp base having a universal shape that can be formed to resemble multiple types of existing lamp bases. It has been discovered that shaping the base unit 902 to resemble currently used bases enables greater integration of the desktop system 900 onto the desk of a user because the desktop system 900 does not occupy new desk top space but only occupies the same amount of space as any previously used desktop lamp.

The base housing 916 is contemplated to be made of plastics or metals depending on the level of quality demanded by users and supported by the market. The base unit 902 further includes a secondary light 920.

The secondary light 920 can be positioned on the top side 918 of the base housing 916. The secondary light 920 can be an LED light or multiple LED lights arranged in an array. The secondary light 920 can be an indicator light that can provide visual confirmation or feedback of the charging status of external devices that are plugged into the AC-unit 914 or the USB-unit 912. The secondary light 920 can provide an indication of whither external devices are charging, are fully charged, or are not connected.

The base unit 902 is shown having a power input 922. The power input 922 is shown having a cable 924 coupled to the base housing 916 and an AC plug 926 coupled to the end of the cable 924 opposite of the base housing 916. The AC plug 926 is contemplated to be compatible with a 120 volt 60 hertz AC receptacle or a 230 volt 90 hertz AC receptacle.

The power input 922 can include an adapter 928 coupled between the AC plug 926 and the cable 924. The adapter 928 can include a transformer, rectifier, and inverter to convert the AC power to DC. It is contemplated that the adapter 928 can be an Underwriters Laboratory listed adaptor or transformer.

It is contemplated that the adapter 928 can convert the input AC to 5 volts DC and provide a 1 ampere, 2.1 ampere, 3.1 ampere, 2.4 ampere, 3.4 ampere, 4.2 ampere, 4.4 ampere, or up to a 10 ampere supply. It has been discovered that providing high currents converted from AC can quickly charge mobile devices.

The power from the power input 922 can be a single power type and can be conducted straight from the adapter 928 to the Vbus pin of the USB-unit 912. It has been discovered that conducting the power from the power input 922 straight through the USB-unit 912 without modifying the power improves the desktop system 900 by reducing manufacturing costs, complexity, and component failure points.

It is contemplated that the USB-unit 912 can also convert the single power type from the adapter 928 into multiple different ampere ratings. For example it is contemplated that the USB-unit 912 can convert the single power type from the adapter 928 and convert it to supply a 500 milliamperes, 1,000 milliamperes, or 2,100 milliamperes DC current to the Vbus pin of the USB receptacle 908.

It is contemplated that the USB-unit 912 can change the ampere rating based on the external mobile device plugged into the USB receptacle 908. It is further contemplated that the USB-unit 912 can be dedicated to a specific and fixed ampere rating.

It has been discovered that providing multiple ampere ratings enables the USB-unit 912 to charge different mobile devices effectively. It has been further discovered that the USB-unit 912 set to supply a specific fixed ampere rating to the mobile devices reduces the complexity of the conversion circuitry required by the USB-unit 912 and thus reduces manufacturing costs and complexity.

The single power type from the adapter 928 of the power input 922 can also be converted in circuitry in the AC-unit 914 from a DC Vbus power source to an AC power and provided as an output at the AC receptacle 910 of the AC-unit 914. It has been discovered that converting the power from the single power type of the power input 922 improves the desktop system 900 by reducing manufacturing costs, complexity, and component failure points because the circuitry doing the conversion can be designed for a single power type and is not required to convert multiple different types of input power.

It is contemplated that in alternate embodiments without the adapter 928, the power from the power input 922 can be a single power type and can be conducted straight from the AC plug 926 of the power input 922 to circuitry in the USB-unit 912, which converts the power from the power input 922 to DC. The converted power from the USB-unit 912 is output on the USB receptacle 908. It has been discovered that conducting the power from the power input 922 straight to the USB-unit 912 without modifying the power improves the desktop system 900 by reducing manufacturing costs, complexity, and component failure points.

It is contemplated that in alternate embodiments without the adapter 928, that the USB-unit 912 can also convert the single power type from the AC plug 926 into multiple different ampere ratings. For example it is contemplated that the USB-unit 912 can convert the single power type from the AC plug 926 and convert it to supply a 500 milliamperes, 1,000 milliamperes, or 2,100 milliamperes DC current to the USB receptacle 908.

In embodiments without the adapter 928, the power from the power AC plug 926 can be a single power type and can be conducted straight from the AC plug 926 of the power input 922 through circuitry in the AC-unit 914 to the AC receptacle 910. It has been discovered that conducting the power from the power input 922 straight through the AC-unit 914 without modifying the power improves the desktop system 900 by reducing manufacturing costs, complexity, and component failure points.

The support 906 is shown extending from the base housing 916. The support 906 is depicted having moveable joints 932 for repositioning the lighting source 904. The lighting source 904 is depicted having a light housing 936.

The desktop system 900 can take power from the power input 922 and conduct it through the circuitry of the USB-unit 912 to power the USB receptacle 908, convert it within the AC-unit 914 to power the AC receptacle 910, or conduct it directly from the power input 922 to lighting elements within the lighting source 904.

It has been discovered that removing extra circuitry associated with the conversion of the power from the power input 922 to be useable with the USB-unit 912 and the lighting elements and directly connecting the USB receptacle 908 and the lighting elements of the lighting source 904 to the power input 922 greatly reduces costs and complexity of producing and designing the desktop system 900 while simultaneously reducing the number of components that could potentially fail.

Further, the desktop system 900 does not include any batteries for power storage for the power of the power input 922. That is, when the power from the power input 922 is removed the AC receptacle 910, the USB receptacle 908, and the lighting source 904 are no longer powered. It has been discovered that providing the desktop system 900 without batteries for power storage can provide a smaller footprint, simplified design, and a lower bill of materials along with a more robust design. It has also been discovered that it is very difficult to supply the high current levels required by mobile devices and the lighting source 904 with batteries for power storage unit.

Referring now to FIG. 10, therein is shown an isometric view of the base unit 902 of FIG. 9 in an alternate configuration. The base unit 902 is shown having the USB receptacles 908 of the USB-units 912 and the AC receptacles 910 of the AC-units 914.

The base unit 902 is shown having four of the USB receptacles 908 and two of the AC receptacles 910 in a rotatable unit 1002. The base housing 916 of the base unit 902 is shown having the rotatable units 1002 positioned on the top side 918 of the base housing 916. The rotatable unit 1002 is contemplated to include a first flat side with a clean surface on the other side of the second side 1008, which is depicted as facing up on the rotatable unit 1002.

The second side 1008 of the rotatable unit 1002 is depicted exposed from the top side 918 of the base housing 916. The second side 1008 is depicted having the AC receptacles 910 and the USB receptacles 908 exposed therefrom.

The rotatable unit 1002 can include a release and a locker that can be used to maintain the rotatable unit 1002 with the first side or the second side 1008 facing up. The release and locker of the rotatable unit 1002 can be a press release and locker system that is elastic and will transition from the first side to the second side 1008 when the first side of the rotatable unit 1002 is pressed by a user.

Alternatively, it is contemplated that the rotatable unit 1002 can rotate from the second side 1008 to the first side when the second side of the rotatable unit 1002 is pressed by a user. The second side 1008 is contemplated, in other embodiments, to include other receptacles such as receptacles for internet, phone, or digital data.

The second side 1008 is also shown having an indicator light 1010 that can visually depict the charging or the charging status of a device plugged into the AC receptacles 910 or the USB receptacles 908. The indicator light 1010 can also show the power status of the desktop system 900, that is whether the desktop system 900 is powered or whether the desktop system 900 is turned on. It is contemplated that the indicator light 1010 can be an LED indicator light.

The rotatable unit 1002 is further depicted having a marking plate 1012 on the second side 1008. The marking plate 1012 can include the power ratings of the AC receptacles 910 and the USB receptacles 908. As an illustrative example, the marking plate 1012 can identify a maximum wattage such as 1,650 Watt for all external electronic devices plugged into the rotatable unit 1002.

The AC-units 914 and the USB-units 912 can be combined within the rotatable unit 1002 of the base housing 916 into modules. The modules of the AC-units 914 and the USB-units 912 can include multiple AC-units 914 or multiple USB-units 912 and can share components like conductors, passive electrical components, and circuit boards. The modules of the AC-units 914 and the USB-units 912 can also be housed with an internal housing that is contained within the rotatable unit 1002 of the base housing 916.

The AC-units 914 and the USB-units 912 can also be combined within the rotatable unit 1002 of the base housing 916 into sealed modules. The sealed modules of the AC-units 914 and the USB-units 912 can include multiple AC-units 914 or multiple USB-units 912 and can share components like conductors, passive electrical components, and circuit boards. The sealed modules of the AC-units 914 and the USB-units 912 can also be housed with a sealed internal housing that is contained within the rotatable unit 1002 of the base housing 916.

As an illustrative example, the USB-units 912 can be a single USB-module, or a sealed USB-module, with an internal housing and sharing components. Alternatively, the USB-units 912 can be different USB-modules, or sealed USB-modules, with individual internal housings within the rotatable unit 1002 of the base housing 916.

As a further illustrative example, each of the AC-units 914 can be a single AC-module, or a sealed AC-module, with an internal housing and sharing components. Alternatively, the AC-units 914 can be different AC-modules, or sealed AC-modules, with individual internal housings within the rotatable unit 1002 of the base housing 916. As a further illustrative example, the AC-units 914 along with the USB-units 912 can be combined into a single module, or single sealed module, sharing an internal housing and components.

The power input 922 can include the cable 924 and the AC plug 926 without the adapter 928 of FIG. 9. It has been discovered that providing the power input 922 without the adapter 928 can enable the desktop system 900 to be more efficient and less expensive when powering the lighting source 904 of FIG. 9 that requires an AC power input.

The power from the power input 922 can be a single power type and can be conducted straight from the AC plug 926 of through circuitry in the AC-unit 914 to the AC receptacle 910. It has been discovered that conducting the power from the power input 922 straight through the AC-unit 914 without modifying the power improves the desktop system 900 by reducing manufacturing costs, complexity, and component failure points.

The single power type from the power input 922 can also be converted in circuitry in the USB-unit 912 from an AC power source to a DC Vbus power and provided as an output at the USB receptacle 908. It has been discovered that converting the power from the single power type of the power input 922 improves the desktop system 900 by reducing manufacturing costs, complexity, and component failure points because the circuitry doing the conversion can be designed for a single power type and is not required to convert multiple different types of input power.

It is contemplated that the USB-units 912 can change the ampere rating based on the external mobile device plugged into the corresponding USB receptacle 908. It is further contemplated that the USB-units 912 can be dedicated to a specific and fixed ampere rating.

It is contemplated that each of the USB-units 912 can also convert the single power type from the power input 922 into multiple different ampere ratings. For example it is contemplated that the USB-units 912 can convert the single power type from the power input 922 and convert it to supply a 500 milliamperes, 1,000 milliamperes, or 2,100 milliamperes DC current to the USB receptacles 908.

It has been discovered that providing multiple ampere ratings enables the USB-units 912 to charge different mobile devices effectively. It has been further discovered that the USB-units 912 set to supply a specific fixed ampere rating to the mobile devices reduces the complexity of the conversion circuitry required by the USB-units 912 and thus reduces manufacturing costs and complexity.

The base housing 916 is enlarged and can allow more of the AC receptacles 910 or the USB receptacles 908 to be exposed therefrom. Further, it has been discovered that providing the base unit 902 having a larger, thicker form factor provides more internal space for different circuitry for providing other functions. It has further been discovered that providing a larger form factor provides reduced manufacturing costs by allowing larger components to be used if available.

The base unit 902 is further depicted having a power switch 1014 extending vertically from the base housing 916. The power switch 1014 can be used to turn off the USB-units 912 and the AC-units 914. It is contemplated that the power switch 1014 can be a multifunctional switch allowing the lighting source 904 to be turned off while leaving the USB-units 912 and the AC-units 914 on. It is further contemplated that the power switch 1014 can turn only the lighting source 904 on and off while the AC-units 914 and the USB-units 912 are unaffected by the power switch 1014. It is further contemplated that the power switch 1014 can be a sensor or a wireless switch.

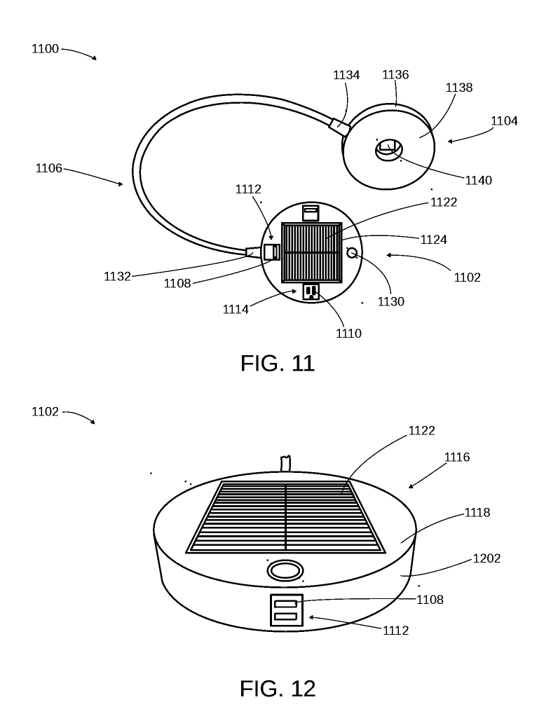

Referring now to FIG. 11, therein is shown an isometric top view of the desktop system 1100 in a sixth embodiment. The desktop system 1100 is depicted having a base unit 1102 coupled to a lighting source 1104, the base unit 1102 coupled to the lighting source 1104 with a support 1106.

The base unit 1102 is shown having USB receptacles 1108 and an AC receptacle 1110. The USB receptacles 1108 can be external receptacle portions of USB-units 1112 and are contemplated to be USB type-A or USB type-C receptacles.

The USB receptacles 1108 can provide active Vbus and GND pins while providing inactive D+, and D− pins. In alternative configurations, the USB receptacles 1108 can provide the active Vbus and GND pins while providing no pins for D+ and D−. It is contemplated that when the USB receptacles 1108 is implemented in USB receptacles other than type-A, the ID pin can also be inactive or nonexistent.

It has been discovered that providing the active Vbus and GND pins while not providing active D+, D−, or ID pins allows the desktop system 1100 to be produced at a lower price point and less manufacturing complexity because no circuitry or internal connections are needed for the D+, D−, or ID pins. It has also been discovered that providing the active Vbus and GND pins while not providing active D+, D−, or ID pins reduces the power requirements of the USB-unit 912.

It has further been discovered that providing only a USB receptacle rather than a USB plug, greatly increases the versatility and usability of the desktop system 1100 by allowing users to plug in a USB charging plug that is compatible with the type-A or type-C receptacle on one end and any other USB receptacle on the other. That is, a user can use the USB receptacles 1108 to charge an electronic device requiring a USB mini-A, a USB mini-B, a USB micro-A, a USB micro-B, or even a USB type-B connection by using the user's own USB charging cable.

Further it has been discovered that the USB receptacles 1108 increase the ergonomic functionality and versatility of the desktop system 1100 by enabling a user to plug in their charging cable and position their electronic device anywhere within reach of the desktop system 1100. The electronic device can be positioned out of the way and the user can easily reach the desktop system 1100 without needing to stand up, walk over to an outlet, bend over, and plug their electronic device in.

The USB receptacles 1108 and the AC receptacle 1110 are shown positioned around a perimeter of the base unit 1102. The USB receptacles 1108 are shown rotated 90° from each other. The AC receptacle 1110 can be an external receptacle portion of an AC-unit 1114.

The AC-unit 1114 and the USB-units 1112 can be combined within a base housing 1116 into modules. The modules of the AC-unit 1114 and the USB-units 1112 can include the AC-unit 1114 and multiple USB-units 1112 and can share components like conductors, passive electrical components, and circuit boards. The modules of the AC-unit 1114 and the USB-units 1112 can also be housed with an internal housing that is contained within the base housing 1116.

The AC-unit 1114 and the USB-units 1112 can also be combined within the base housing 1116 into sealed modules. The sealed modules of the AC-unit 1114 and the USB-units 1112 can include the AC-unit 1114 and multiple USB-units 1112 and can share components like conductors, passive electrical components, and circuit boards. The sealed modules of the AC-unit 1114 and the USB-units 1112 can also be housed with a sealed internal housing that is contained within the base housing 1116.

As an illustrative example, the two USB-units 1112 can be a single USB-module or sealed USB-module with an internal housing and sharing components. As a further illustrative example, the AC-unit 1114 and the USB-units 1112 can be individual modules, or individual sealed modules, self-contained within their own internal housings. As a further illustrative example, the AC-unit 1114 along with the USB-units 1112 can be combined into a single module, or sealed module, sharing an internal housing and components.

The AC receptacle 1110 and the USB receptacles 1108 are shown exposed from multiple openings in a top side 1118 of the base housing 1116 of the base unit 1102. The top side 1118 can be a horizontal side or a substantially horizontal side of the base housing 1116.

The base housing 1116 is contemplated to be a lamp base having a universal shape that can be formed to resemble multiple types of existing lamp bases. It has been discovered that shaping the base unit 1102 to resemble currently used bases enables greater integration of the desktop system 1100 onto the desk of a user because the desktop system 1100 does not occupy new desk top space but only occupies the same amount of space as any previously used desktop lamp.

The base housing 1116 is contemplated to be made of plastics or metals depending on the level of quality demanded by users and supported by the market. The base unit 1102 is shown having a power input 1122. The power input 1122 is depicted as a solar power array. The power input 1122 is coupled to power storage 1124 within the base housing 1116.

The power storage 1124 is contemplated to be rechargeable batteries. The power storage 1124 is contemplated to be large enough to provide power to the USB-units 1112 and the AC-unit 1114 and charge external mobile devices along with powering the lighting source 1104.

The power from the power input 1122 can be stored in the power storage 1124. The power from the power storage 1124 can be a single power type and can be conducted straight from the power storage 1124 through circuitry in the USB-units 1112 to the USB receptacles 1108. It has been discovered that conducting the power from the power storage 1124 straight through the USB-units 1112 without modifying the power improves the desktop system 1100 by reducing manufacturing costs, complexity, and component failure points.

It is contemplated that each of the USB-units 1112 can also convert the single power type from the power storage 1124 into multiple different ampere ratings. For example it is contemplated that the USB-units 1112 can convert the single power type from the power storage 1124 and convert it to supply a 500 milliamperes, 1,000 milliamperes, or 2,100 milliamperes DC current to the USB receptacles 1108.

It is contemplated that the USB-units 1112 can change the ampere rating based on the external mobile device plugged into the corresponding USB receptacle 1108. It is further contemplated that the USB-units 1112 can be dedicated to a specific and fixed ampere rating.

It has been discovered that providing multiple ampere ratings enables the USB-units 1112 to charge different mobile devices effectively. It has been further discovered that the USB-units 1112 set to supply a specific fixed ampere rating to the mobile devices reduces the complexity of the conversion circuitry required by the USB-units 1112 and thus reduces manufacturing costs and complexity.

The single power type from the power storage 1124 can also be converted in circuitry in the AC-unit 1114 from a DC power source to an AC power and provided as an output at the AC receptacle 1110 of the AC-unit 1114. It has been discovered that converting the power from the single power type of the power storage 1124 improves the desktop system 1100 by reducing manufacturing costs, complexity, and component failure points because the circuitry doing the conversion can be designed for a single power type and is not required to convert multiple different types of input power.

The base unit 1102 is depicted having a power switch 1130 exposed from the top side 1118 of the base housing 1116. The power switch 1130 can be used to turn off the USB-units 1112 and the AC-unit 1114. It is contemplated that the power switch 1130 can be a multifunctional switch allowing the lighting source 1104 to be turned off while leaving the USB-units 1112 and the AC-unit 1114 on.

It is further contemplated that the power switch 1130 can turn only the lighting source 1104 on and off while the AC-unit 1114 and the USB-units 1112 are unaffected by the power switch 1130. The support 1106 is shown extending from the base housing 1116. The support 1106 is depicted as moveable for repositioning the lighting source 1104.

The support 1106 is shown extending from a lower support connector 1132 coupled to the base housing 1116. The lower support connector 1128 can be a reinforcing element that is integrally molded to the base housing 1116 or can be a structure affixed rigidly to the base housing 1116.

The support 1106 can be threaded through the lower support connector 1128 and directly connected to the base housing 1116 or can be coupled only to the lower support connector 1128. The support 1106 is further shown extending from an upper support connector 1134 coupled to the lighting source 1104. The upper support connector 1134 can be a reinforcing element that is integrally molded to the lighting source 1104 or can be a structure affixed rigidly to the lighting source 1104.

The support 1106 can be threaded through the upper support connector 1134 and directly connected to the lighting source 1104 or can be coupled only to the upper support connector 1134. The lighting source 1104 is depicted having a light housing 1136 and a lighting base 1138.

The upper support connector 1134 is depicted as coupled to the light housing 1136. The lighting base 1138 is shown having a lighting element 1140. The lighting element 1140 can be LEDs, OLEDs, incandescent bulbs, compact fluorescent lamp, fluorescent tube, or a combination thereof. The lighting element 1140 are contemplated to be configurable to emit multiple different wavelengths of light including red, blue, and multiple wavelengths of light simultaneously like white light.

The desktop system 1100 can take power from the power input 1122 and conduct it to the power storage 1124. The desktop system 1100 can take power from the power storage 1124 through the circuitry of the USB-units 1112 to power the USB receptacles 1108, convert it within the AC-unit 1114 to power the AC receptacle 1110, or conduct it directly from the power storage 1124 to the lighting element 1140 to power the lighting element 1140 directly.

It has been discovered that removing extra circuitry associated with the conversion of the power from the power storage 1124 to be useable with the USB-units 1112 and the lighting element 1140 and directly connecting the USB receptacles 1108 and the lighting element 1140 to the power storage 1124 greatly reduces costs and complexity of producing and designing the desktop system 1100 while simultaneously reducing the number of components that could potentially fail.

The support 1106 can be repositioned and moved to control where the lighting source 1104 is angled. The lighting source 1104 is depicted as including one lighting element 1140 arranged in the center of the light housing 1136.

Referring now to FIG. 12, therein is shown an isometric view of the base unit 1102 of FIG. 11 in an alternate embodiment. The base unit 1102 is shown having the USB receptacles 1108 positioned along a side 1202 of the base housing 1116.

The base housing 1116 is depicted enlarged, which provides a larger top side 1118. The larger top side 1118 provides a larger area for the power input 1122 to occupy. Further it has been discovered that providing the base unit 1102 having a larger, thicker form factor provides more internal space for different circuitry for providing other functions.

It has further been discovered that providing a larger form factor provides reduced manufacturing costs by allowing larger components to be used if available. It has yet further been discovered that providing a larger thicker form factor provides a larger internal volume for larger power storage 1124.

The USB receptacles 1108 are shown positioned vertically offset on the side 1202 of the base unit 1102. The USB-units 1112 can be combined within a base housing 1116 into a module.

The module can include the USB-units 1112 and can share components like conductors, passive electrical components, and circuit boards. The modules of the USB-units 1112 can also be housed with an internal housing that is contained within the base housing 1116.

The USB-units 1112 can also be combined within the base housing 1116 into sealed modules. The sealed modules of the USB-units 1112 can include the USB-units 1112 and can share components like conductors, passive electrical components, and circuit boards. The sealed modules of the USB-units 1112 can also be housed with a sealed internal housing that is contained within the base housing 1116.

As an illustrative example, the two USB-units 1112 can be a single USB-module or sealed USB-module with an internal housing and sharing components. As a further illustrative example the USB-units 1112 can be individual modules, or individual sealed modules, self-contained within their own internal housings.

The USB receptacles 1108 are shown exposed from a single opening in the side 1202 of the base housing 1116. The power input 1122 on the top side 1118 of the base housing 1116 is depicted as a solar cell array but is contemplated be implemented as a wind mill to capture and convert wind power, a generator to capture and convert chemical power, or a battery to supply stored electricity.

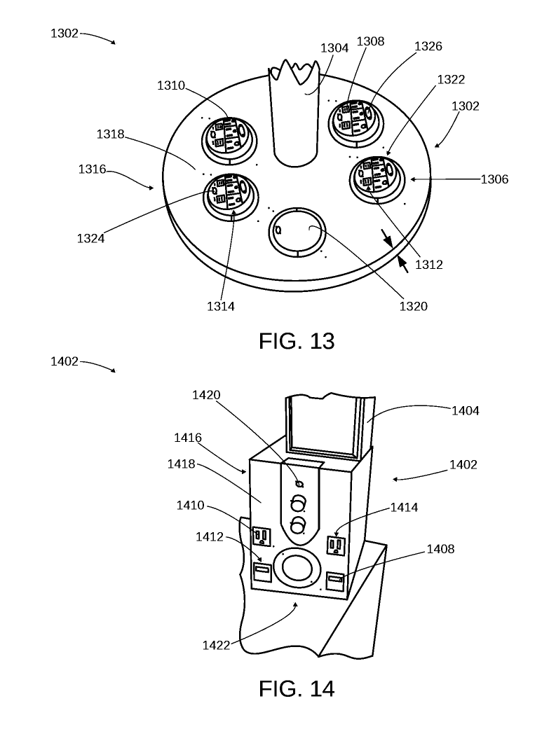

Referring now to FIG. 13, therein is shown an isometric view of a base unit 1302 for an embodiment of the desktop system. The base unit 1302 is depicted as coupled a support 1304.

The base unit 1302 is depicted larger than the base units of other embodiments and is contemplated to be useful in public spaces such as in train stations, bus stations, airports, meeting rooms, and hotel lobbies. The base unit 1302 is shown having rotatable units 1306.

The rotatable units 1306 can include USB receptacles 1308 and AC receptacles 1310. The USB receptacles 1308 can be external receptacle portions of USB-units 1312 and are contemplated to be USB type-A or USB type-C receptacles.

The USB receptacles 1308 can provide active Vbus and GND pins while providing inactive D+, and D− pins. In alternative configurations, the USB receptacles 1308 can provide the active Vbus and GND pins while providing no pins for D+ and D−. It is contemplated that when the USB receptacles 1308 is implemented in USB receptacles other than type-A, the ID pin can also be inactive or nonexistent.

It has been discovered that providing the active Vbus and GND pins while not providing active D+, D−, or ID pins allows the desktop system to be produced at a lower price point and less manufacturing complexity because no circuitry or internal connections are needed for the D+, D−, or ID pins.

It has further been discovered that providing only a USB receptacle rather than a USB plug, greatly increases the versatility and usability of the desktop system by allowing users to plug in a USB charging plug that is compatible with the type-A or type-C receptacle on one end and any other USB receptacle on the other. That is, a user can use the USB receptacles 1308 to charge an electronic device requiring a USB mini-A, a USB mini-B, a USB micro-A, a USB micro-B, or even a USB type-B connection by using the user's own USB charging cable.

Further it has been discovered that the USB receptacles 1308 increase the ergonomic functionality and versatility of the desktop system by enabling a user to plug in their charging cable and position their electronic device anywhere within reach of the desktop system. The electronic device can be positioned out of the way and the user can easily reach the desktop system without needing to stand up, walk over to an outlet, bend over, and plug their electronic device in.

The rotatable units 1306 are depicted as partially embedded within and partially exposed from a base housing 1316. The base housing 1316 forms an external housing for the base unit 1302 and is shown having a top side 1318. The top side 1318 is shown having five of the rotatable units 1306 arranged thereon.

The rotatable units 1306 are shown having a first side 1320 and a second side 1322. The first side 1320 is depicted as a flat side with a clean surface. The second side 1322 is depicted having the AC receptacles 1310 and the USB receptacles 1308 exposed therefrom.

The rotatable units 1306 can include a release and a locker that can be used to maintain the rotatable units 1306 with the first side 1320 or the second side 1322 facing up. The release and locker of the rotatable units 1306 can be a press release and locker system that is elastic and will transition from the first side 1320 to the second side 1322 when the first side 1320 of the rotatable units 1306 is pressed by a user.

Alternatively, it is contemplated that the rotatable units 1306 can rotate from the second side 1322 to the first side 1320 when the second side of the rotatable units 1306 is pressed by a user. The second side 1322 is contemplated, in other embodiments, to include other receptacles such as receptacles for internet, phone, or digital data.

The second side 1322 and the first side 1320 are also shown having indicator lights 1324 that can visually depict the charging or the charging status of a device plugged into the AC receptacles 510 or the USB receptacles 508. The indicator lights 1324 can also show the power status of the desktop system, that is whether the desktop system is powered or whether the desktop system is turned on.

The rotatable units 1306 are further depicted having a marking plate 1326 on the second side 1322. The marking plate 1326 can include the power ratings of the AC receptacles 510 and the USB receptacles 508. As an illustrative example, the marking plate 1326 can identify a maximum wattage such as 1,650 Watt for all external electronic devices plugged into the rotatable units 1306.

The AC-units 1314 and the USB-units 1312 can be combined within the rotatable units 1306 of the base housing 1316 into modules. The modules of the AC-units 1314 and the USB-units 1312 can include multiple AC-units 1314 or multiple USB-units 1312 and can share components like conductors, passive electrical components, and circuit boards. The modules of the AC-units 1314 and the USB-units 1312 can also be housed with an internal housing that is contained within the rotatable units 1306 of the base housing 1316.

The AC-units 1314 and the USB-units 1312 can also be combined within the rotatable units 1306 of the base housing 1316 into sealed modules. The sealed modules of the AC-units 1314 and the USB-units 1312 can include multiple AC-units 1314 or multiple USB-units 1312 and can share components like conductors, passive electrical components, and circuit boards. The sealed modules of the AC-units 1314 and the USB-units 1312 can also be housed with a sealed internal housing that is contained within the rotatable units 1306 of the base housing 1316.

As an illustrative example, the USB-units 1312 can be a single USB-module, or a single sealed USB-module, with an internal housing and sharing components. Alternatively, the USB-units 1312 can be different USB-modules, or different sealed USB-modules, with individual internal housings within the rotatable units 1306 of the base housing 1316.

As a further illustrative example each of the AC-units 1314 can be a single AC-module, or a single sealed AC-module, with an internal housing and sharing components. Alternatively, the AC-units 1314 can be different AC-modules, or sealed AC-modules, with individual internal housings within the rotatable units 1306 of the base housing 1316. As a further illustrative example the AC-units 1314 along with the USB-units 1312 can be combined into a single module, or single sealed module, sharing an internal housing and components.

The base housing 1316 is contemplated to be a lamp base having a universal shape that can be formed to resemble multiple types of existing lamp bases. It has been discovered that shaping the base unit 1302 to resemble currently used bases enables greater integration of the desktop system onto the desk of a user because the desktop system does not occupy new desk top space but only occupies the same amount of space as any previously used desktop lamp.

The base housing 1316 is contemplated to be made of plastics or metals depending on the level of quality demanded by users and supported by the market.

The base unit 1302 can have a power input such as an AC plug, an AC plug with an adapter, or a USB plug. The support 1304 can be coupled to a lighting source such as a florescent light source, an LED light source, or an arch lighting source.

The power from the power input can be a single power type and can be conducted straight from the power input through circuitry in the USB-units 1312 to the USB receptacles 1308 of the USB-units 1312. It has been discovered that conducting the power from the power input straight through the USB-units 1312 without modifying the power improves the desktop system by reducing manufacturing costs, complexity, and component failure points.

It is contemplated that each of the USB-units 1312 can also convert the single power type from the power input into multiple different ampere ratings. For example, it is contemplated that the USB-units 1312 can convert the single power type to supply a 500 milliamperes, 1,000 milliamperes, or 2,100 milliamperes DC current to the USB receptacles 1308.

It is contemplated that the USB-units 1312 can change the ampere rating based on the external mobile device plugged into the corresponding USB receptacle 1308. It is further contemplated that the USB-units 1312 can be dedicated to a specific and fixed ampere rating.

It has been discovered that providing multiple ampere ratings enables the USB-units 1312 to charge different mobile devices effectively. It has been further discovered that the USB-units 1312 set to supply a specific fixed ampere rating to the mobile devices reduces the complexity of the conversion circuitry required by the USB-units 1312 and thus reduces manufacturing costs and complexity.

The single power type can also be converted in circuitry in the AC-units 1314 from a DC power source to an AC power and provided as an output at the AC receptacles 1310 of the AC-units 1314. It has been discovered that converting the power from the single power type improves the desktop system by reducing manufacturing costs, complexity, and component failure points because the circuitry doing the conversion can be designed for a single power type and is not required to convert multiple different types of input power.

It is contemplated that in alternate embodiments without the single power type can be conducted straight to circuitry in the USB-units 1312, which converts the power to DC. The converted power from the USB-units 1312 is output on the USB receptacles 1308. It has been discovered that conducting the power from the power input straight to the USB-units 1312 without modifying the power improves the desktop system by reducing manufacturing costs, complexity, and component failure points.

It is contemplated that in alternate embodiments that each of the USB-units 1312 can also convert the single power type into multiple different ampere ratings. For example, it is contemplated that the USB-units 1312 can convert the single power type to supply a 500 milliamperes, 1,000 milliamperes, or 2,100 milliamperes DC current to the USB receptacles 1308.

In other contemplated embodiments, the single power type can be conducted straight from the power input through circuitry in the AC-units 1314 to the AC receptacles 1310. It has been discovered that conducting the power from the power input straight through the AC-units 1314 without modifying the power improves the desktop system by reducing manufacturing costs, complexity, and component failure points.

It is contemplated that the desktop system does not include any batteries for power storage. That is, when the power from the power input is removed the AC receptacles 1310, the USB receptacles 1308, and the lighting elements are no longer powered. It has been discovered that providing the desktop system without batteries for power storage can provide a smaller footprint, simplified design, and a lower bill of materials along with a more robust design. It has also been discovered that it is very difficult to supply the high current levels required by mobile devices and the lighting source with batteries for power storage unit.

Referring now to FIG. 14, therein is shown an isometric view of a base unit 1402 for an embodiment of the desktop system. The base unit 1402 is shown coupled to a speaker 1404.

The base unit 1402 is shown having USB receptacles 1408 and AC receptacles 1410. The USB receptacles 1408 can be external receptacle portions of USB-units 1412 and are contemplated to be USB type-A or USB type-C receptacles.

The USB receptacles 1408 can provide active Vbus and GND pins while providing inactive D+, and D− pins. In alternative configurations, the USB receptacles 1408 can provide the active Vbus and GND pins while providing no pins for D+ and D−. It is contemplated that when the USB receptacles 1408 is implemented in USB receptacles other than type-A, the ID pin can also be inactive or nonexistent.

It has been discovered that providing the active Vbus and GND pins while not providing active D+, D−, or ID pins allows the desktop system 1400 to be produced at a lower price point and less manufacturing complexity because no circuitry or internal connections are needed for the D+, D−, or ID pins.

It has further been discovered that providing only a USB receptacle rather than a USB plug, greatly increases the versatility and usability of the desktop system by allowing users to plug in a USB charging plug that is compatible with the type-A or type-C receptacle on one end and any other USB receptacle on the other. That is, a user can use the USB receptacles 1408 to charge an electronic device requiring a USB mini-A, a USB mini-B, a USB micro-A, a USB micro-B, or even a USB type-B connection by using the user's own USB charging cable.

Further it has been discovered that the USB receptacles 1408 increase the ergonomic functionality and versatility of the desktop system by enabling a user to plug in their charging cable and position their electronic device anywhere within reach of the desktop system. The electronic device can be positioned out of the way and the user can easily reach the desktop system without needing to stand up, walk over to an outlet, bend over, and plug their electronic device in.

The USB receptacles 1408 are shown configured with two of the USB receptacles 1408 vertically offset below the AC receptacles 1410. The USB receptacles 1408 are depicted horizontally offset from each other. The AC receptacles 1410 are depicted horizontally offset from each other. The AC receptacles 1410 can be external receptacle portions of AC-units 1414.

The AC-units 1414 and the USB-units 1412 can be combined within a base housing 1416 into modules. The modules of the AC-units 1414 and the USB-units 1412 can include multiple AC-units 1414 or multiple USB-units 1412 and can share components like conductors, passive electrical components, and circuit boards. The modules of the AC-units 1414 and the USB-units 1412 can also be housed with an internal housing that is contained within the base housing 1416.

The AC-units 1414 and the USB-units 1412 can also be combined within the base housing 1416 into sealed modules. The sealed modules of the AC-units 1414 and the USB-units 1412 can include multiple AC-units 1414 or multiple USB-units 1412 and can share components like conductors, passive electrical components, and circuit boards. The sealed modules of the AC-units 1414 and the USB-units 1412 can also be housed with a sealed internal housing that is contained within the base housing 1416.

As an illustrative example, the USB-units 1412 can be a single USB-module or single sealed USB-module with an internal housing and sharing components. As a further illustrative example, each of the AC-units 1414 and the USB-units 1412 can be individual modules, or individual sealed modules, self-contained within their own internal housings. As a further illustrative example the AC-units 1414 along with the USB-units 1412 can be combined into a single module, or single sealed module, sharing an internal housing and components.

The AC receptacles 1410 and the USB receptacles 1408 are shown exposed from multiple openings in a side 1418 of the base housing 1416 of the base unit 1402. The side 1418 can be a vertical side or a substantially vertical side of the base housing 1416.

The side 1418 is also shown having an indicator light 1420 and radio controls 1422. The indicator light 1420 can visually depict the charging or the charging status of a device plugged into the AC receptacles 1410 or the USB receptacles 1408. The indicator light 1420 can also show the power status of the desktop system, the speaker 1404, or the state of the radio controls 1422.

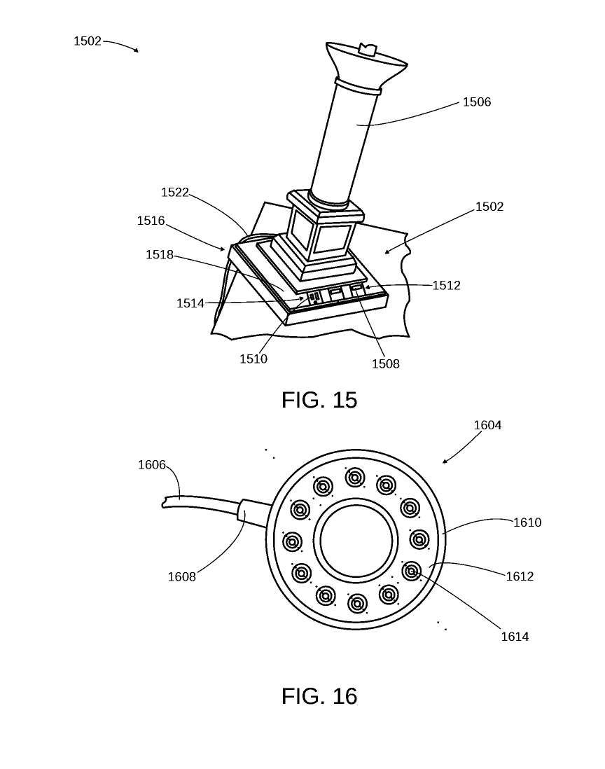

Referring now to FIG. 15, therein is shown an isometric view of a base unit 1502 for an embodiment of the desktop system. The base unit 1502 is shown coupled to a support 1506.

The base unit 1502 is shown having USB receptacles 1508 and an AC receptacle 1510. The USB receptacles 1508 can be external receptacle portions of USB-units 1512 and are contemplated to be USB type-A or USB type-C receptacles.

The USB receptacles 1508 can provide active Vbus and GND pins while providing inactive D+, and D− pins. In alternative configurations, the USB receptacles 1508 can provide the active Vbus and GND pins while providing no pins for D+ and D−. It is contemplated that when the USB receptacles 1508 is implemented in USB receptacles other than type-A, the ID pin can also be inactive or nonexistent.

It has been discovered that providing the active Vbus and GND pins while not providing active D+, D−, or ID pins allows the desktop system to be produced at a lower price point and less manufacturing complexity because no circuitry or internal connections are needed for the D+, D−, or ID pins.

It has further been discovered that providing only a USB receptacle rather than a USB plug, greatly increases the versatility and usability of the desktop system by allowing users to plug in a USB charging plug that is compatible with the type-A or type-C receptacle on one end and any other USB receptacle on the other. That is, a user can use the USB receptacles 1508 to charge an electronic device requiring a USB mini-A, a USB mini-B, a USB micro-A, a USB micro-B, or even a USB type-B connection by using the user's own USB charging cable.

Further it has been discovered that the USB receptacles 1508 increase the ergonomic functionality and versatility of the desktop system by enabling a user to plug in their charging cable and position their electronic device anywhere within reach of the desktop system. The electronic device can be positioned out of the way and the user can easily reach the desktop system without needing to stand up, walk over to an outlet, bend over, and plug their electronic device in.

The USB receptacles 1508 are shown arranged on one side of the AC receptacle 1510. The AC receptacle 1510 can be an external receptacle portion of an AC-unit 1514.

The AC-unit 1514 and the USB-units 1512 can be combined within a base housing 1516 into modules. The modules of the AC-unit 1514 and the USB-units 1512 can include the AC-unit 1514 or multiple USB-units 1512 and can share components like conductors, passive electrical components, and circuit boards. The modules of the AC-unit 1514 and the USB-units 1512 can also be housed with an internal housing that is contained within the base housing 1516.

The AC-unit 1514 and the USB-units 1512 can also be combined within the base housing 1516 into sealed modules. The sealed modules of the AC-unit 1514 and the USB-units 1512 can include multiple AC-unit 1514 or multiple USB-units 1512 and can share components like conductors, passive electrical components, and circuit boards. The sealed modules of the AC-unit 1514 and the USB-units 1512 can also be housed with a sealed internal housing that is contained within the base housing 1516.

The AC receptacle 1510 and the USB receptacles 1508 are shown exposed from multiple openings in a side 1518 of the base housing 1516 of the base unit 1502. The side 1518 can be a slanted side of the base housing 1516.

The base housing 1516 is contemplated to be a lamp base having a universal shape that can be formed to resemble multiple types of existing lamp bases. It has been discovered that shaping the base unit 1502 to resemble currently used bases enables greater integration of the desktop system onto the desk of a user because the desktop system does not occupy new desk top space but only occupies the same amount of space as any previously used desktop lamp.

The base housing 1516 is contemplated to be made of plastics, metals, or woods depending on the level of quality demanded by users and supported by the market. The base unit 1502 is shown having a power input 1522.

The power from the power input 1522 can be a single power type and can be conducted straight from the power input 1522 through circuitry in the AC-unit 1514 to the AC receptacle 1510. It has been discovered that conducting the power from the power input 1522 straight through the AC-unit 1514 without modifying the power improves the desktop system by reducing manufacturing costs, complexity, and component failure points.

The single power type from the power input 1522 can also be converted in circuitry in the USB-units 1512 from an AC power to a DC Vbus power source provided as an output at the USB receptacles 1508. It has been discovered that converting the power from the single power type of the power input 1522 improves the desktop system by reducing manufacturing costs, complexity, and component failure points because the circuitry doing the conversion can be designed for a single power type and is not required to convert multiple different types of input power.

The desktop system can take power from the power input 1522 and conduct it through the circuitry of the USB-units 1512 to power a DC lighting source such as an LED lighting source. The desktop system can also direct the power from the power input 1522 directly to the lighting source to power an AC lighting source such as an incandescent bulb.

It has been discovered that utilizing the circuitry within the USB-units 1512 for multiple purposes removes extra circuitry associated generating DC power. Reducing the amount of circuitry required greatly reduces costs and complexity of producing and designing the desktop system while simultaneously reducing the number of components that could potentially fail.

The desktop system does not include any batteries for power storage for the power of the power input 1522. That is, when the power from the power input 1522 is removed the AC receptacle 1510, the USB receptacles 1508, and the lighting elements are no longer powered. It has been discovered that providing the desktop system without batteries for power storage can provide a smaller footprint, simplified design, and a lower bill of materials along with a more robust design. The support 1506 is shown fixed in relation to the base unit 1502 and the lighting source.

Referring now to FIG. 16, therein is shown a bottom view of a lighting source 1604 for an embodiment of the desktop system. The lighting source 1604 is shown having a support 1606 extending from an upper support connector 1608 coupled to the lighting source 1604. The upper support connector 1608 can be a reinforcing element that is integrally molded to the lighting source 1604 or can be a structure affixed rigidly to the lighting source 1604.

The support 1606 can be threaded through the upper support connector 1608 and directly connected to the lighting source 1604 or can be coupled only to the upper support connector 1608. The lighting source 104 is depicted having a light housing 1610 and a lighting base 1612.

The upper support connector 1608 is depicted as coupled to the light housing 1610. The lighting base 1612 is shown having lighting elements 1614. The lighting elements 1614 can be DC lighting elements including LEDs or OLEDs. The lighting elements 1614 are contemplated to be configurable to emit multiple different wavelengths of light including red, blue, and multiple wavelengths of light simultaneously like white light.

The support 1606 can be repositioned and moved to control where the lighting source 1604 is angled. The lighting source 1604 is depicted as including 12 lighting elements 1614 arranged in a circle near a perimeter of the light housing 1610.

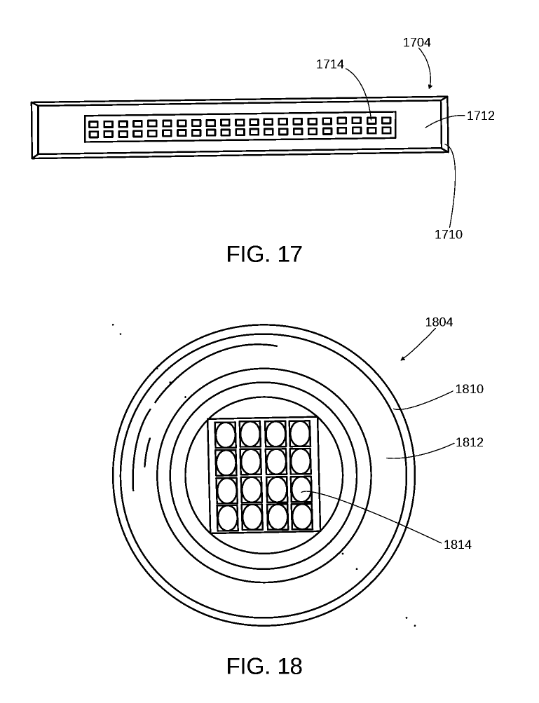

Referring now to FIG. 17, therein is shown a bottom view of a lighting source 1704 for an embodiment of the desktop system. The lighting source 104 is depicted having a light housing 1710 and a lighting base 1712.

The lighting base 1712 is shown having lighting elements 1714. The lighting elements 1714 can be DC lighting elements including LEDs or OLEDs. The lighting elements 1714 are contemplated to be configurable to emit multiple different wavelengths of light including red, blue, and multiple wavelengths of light simultaneously like white light. The lighting source 1704 is depicted as including 42 lighting elements 1714 arranged in two rows of twenty-one columns.

Referring now to FIG. 18, therein is shown a bottom view of a lighting source 1804 for an embodiment of the desktop system. The lighting source 1804 is depicted having a light housing 1810 and a lighting base 1812.

The lighting base 1812 is shown having lighting elements 1814. The lighting elements 1814 can be DC lighting elements including LEDs or OLEDs. The lighting elements 1814 are contemplated to be configurable to emit multiple different wavelengths of light including red, blue, and multiple wavelengths of light simultaneously like white light.

The lighting source 1804 is depicted as including 16 lighting elements 1814 arranged in four rows of four columns in the center of the lighting base 1812. The lighting base 1812 is contemplated to have a reflective surface.

Referring now to FIG. 19, therein is shown an isometric top view of a rotatable unit 1902 for an embodiment of the desktop system. The rotatable units 1902 is shown having a flat surface 1904 and an indicator light 1906.

The flat surface 1904 is shown flush with an outer ring 1908. The outer ring 1908 can slope down from the flat surface 1904 to the surface of a base housing of the desktop system.

The indicator light 1906 can visually depict the charging or the charging status of a device plugged into AC receptacles or USB receptacles. The indicator light 1906 can also show the power status of the desktop system, that is, whether the desktop system is powered or whether the desktop system is turned on.

The indicator light 1906 is contemplated to be an LED light. The indicator light 1906 can be dimmed or change color based on the power usage of the desktop system or an external mobile device, charge state of the external mobile device, or power state of the desktop system or the external mobile device. The indicator light 1906 can include an IC chip for controlling the brightness and color of the indicator light 1906.

Referring now to FIG. 20, therein is shown an isometric top view of a rotatable unit 2002 for an embodiment of the desktop system during rotation. The rotatable unit 2002 is shown in a transition stage.

The rotatable unit 2002 is shown having a side edge 2004 and a first side 2006 and a second side 2008. The rotatable unit 2002 can include a release and a locker that can be used to maintain the rotatable unit 2002 with the first side 2006 or the second side 2008 facing up. The release and locker of the rotatable unit 2002 can be a press release and locker system that is elastic and will transition from the first side 2006 to the second side 2008 when the first side 2006 of the rotatable unit 2002 is pressed by a user.

Alternatively, it is contemplated that the rotatable unit 2002 can rotate from the second side 2008 to the first side 2006 when the second side of the rotatable unit 2002 is pressed by a user. It is also contemplated that the rotatable unit 2002 can be manually moved to reposition the rotatable unit 2002 with a different tilt angle.

It is further contemplated that the rotatable unit 2002 can be swiveled around an outer ring 2010. It has been discovered that providing the rotatable unit 2002 with the ability to swivel and tilt provides greater flexibility and usability to a user.

Tilt and swivel of the rotatable unit 2002 has been discovered to enable the repositioning of a lighting source on either the first side 2006 or the second side 2008 to provide directional and precise lighting. Tilt and swivel of the rotatable unit 2002 has further been discovered to provide greater ergonomics when the first side 2006 or the second side 2008 includes AC receptacles, USB receptacles, or other receptacles.

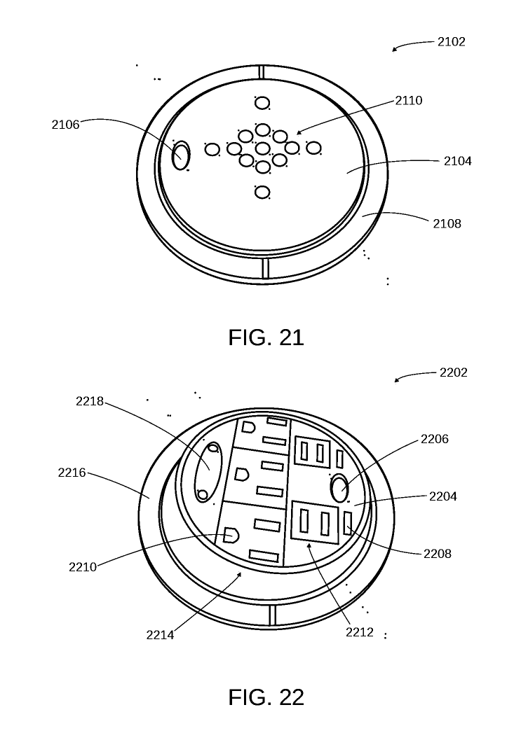

Referring now to FIG. 21, therein is shown an isometric top view of a rotatable unit 2102 for an embodiment of the desktop system. The rotatable unit 2102 is shown having a flat surface 2104 and an indicator light 2106.

The flat surface 2104 is shown flush with an outer ring 2108. The outer ring 2108 can slope down from the flat surface 2104 to the surface of a base housing of the desktop system.

The indicator light 2106 can visually depict the charging or the charging status of a device plugged into AC receptacles or USB receptacles. The indicator light 2106 can also show the power status of the desktop system, that is whether the desktop system is powered or whether the desktop system is turned on.

The indicator light 2106 is contemplated to be an LED light. The indicator light 2106 can be dimmed or change color based on the power usage of the desktop system or an external mobile device, charge state of the external mobile device, or power state of the desktop system or the external mobile device. The indicator light 2106 can include an IC chip for controlling the brightness and color of the indicator light 2106.

The flat surface 2104 can further include lighting source 2110. The lighting source 2110 is shown as an array of LEDs. It is contemplated that the lighting source 2110 of the rotatable unit 2102 can be turned on by a motion sensor, remote control, photo sensor, switch, or wireless signal.

The lighting source 2110 is contemplated to be a chip-type lighting source 2110 for surface mounting and to reduce the height of the lighting source 2110 enabling the rotatable unit 2102 thin. The lighting source 2110 can include a control chip to vary the lighting source 2110 luminosity and color.

Referring now to FIG. 22, therein is shown an isometric top view of a rotatable unit 2202 for an embodiment of the desktop system. The rotatable unit 2202 is shown having a flat surface 2204 and an indicator light 2206.

The flat surface 2204 is depicted having USB receptacles 2208 and AC receptacle 2210. The USB receptacles 2208 can be external receptacle portions of USB-units 2212 and are contemplated to be USB type-A or USB type-C receptacles. The AC receptacle 2210 can be external receptacle portions of AC-units 2214.

The AC-units 2214 and the USB-units 2212 can be combined within the rotatable units 2202 into modules. The modules of the AC-units 2214 and the USB-units 2212 can include multiple AC-units 2214 or multiple USB-units 2212 and can share components like conductors, passive electrical components, and circuit boards. The modules of the AC-units 2214 and the USB-units 2212 can also be housed with an internal housing that is contained within the rotatable units 2202.

The AC-units 2214 and the USB-units 2212 can also be combined within the rotatable units 2202 into sealed modules. The sealed modules of the AC-units 2214 and the USB-units 2212 can include multiple AC-units 2214 or multiple USB-units 2212 and can share components like conductors, passive electrical components, and circuit boards. The sealed modules of the AC-units 2214 and the USB-units 2212 can also be housed with a sealed internal housing that is contained within the rotatable units 2202.

As an illustrative example, the multiple USB-units 2212 can be combined into a single USB-module, or a single sealed USB-module, with an internal housing and sharing components. Alternatively, the USB-units 2212 can be different individual USB-modules, or individual sealed USB-modules, with individual internal housings within the rotatable units 2202.

As a further illustrative example each of the AC-units 2214 can be combined into a single AC-module, or a single sealed AC-module, with an internal housing and sharing components. Alternatively, the AC-units 2214 can be different individual AC-modules, or individual sealed AC-modules, with individual internal housings within the rotatable units 2202. As a further illustrative example the AC-units 2214 along with the USB-units 2212 can be combined into a single module, or single sealed module, sharing an internal housing and components.

The flat surface 2204 is shown above an outer ring 2216. The outer ring 2216 can slope down from rear the rotatable unit 2202 to the surface of a base housing of the desktop system.

The indicator light 2206 can visually depict the charging or the charging status of a device plugged into AC receptacles 2210 or USB receptacles 2208. The indicator light 2206 can also show the power status of the desktop system, that is whether the desktop system is powered or whether the desktop system is turned on.

The indicator light 2206 is contemplated to be an LED light. The indicator light 2206 can be dimmed or change color based on the power usage of the desktop system or an external mobile device, charge state of the external mobile device, or power state of the desktop system or the external mobile device. The indicator light 2206 can include an IC chip for controlling the brightness and color of the indicator light 2206.

The rotatable unit 2202 is further depicted having a marking plate 2218. The marking plate 2218 can include the power ratings of the AC receptacles 2210 and the USB receptacles 2208. As an illustrative example, the marking plate 2218 can identify a maximum wattage such as 1,650 Watt for all external electronic devices plugged into the rotatable units 2202.

It is contemplated that the rotatable unit 2202 can combine lighting sources, AC-units 2214, USB-units 2212, or receptacles for internet, phone, or storage devices. It is further contemplated that the rotatable unit 2202 can have two sides with any combination of indicator lights, marking plates 2218, AC-units 2214, USB-units 2212, other receptacles, or lighting sources.

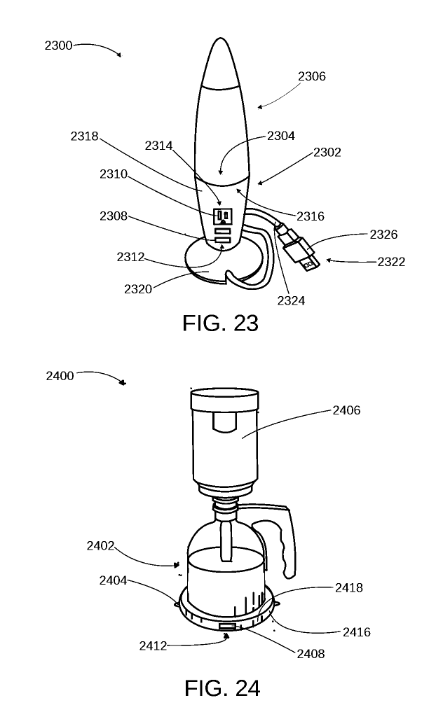

Referring now to FIG. 23, therein is shown an isometric top view of the desktop system 2300 in a seventh embodiment. The desktop system 2300 is depicted having a base unit 2302 containing a lighting source 2304. The base unit 2302 is shown coupled to a lava lamp tank 2306.

The base unit 2302 is shown having USB receptacles 2308 and an AC receptacle 2310. The USB receptacles 2308 can be external receptacle portions of USB-units 2312 and are contemplated to be USB type-A or USB type-C receptacles.

The USB receptacles 2308 can provide active Vbus and GND pins while providing inactive D+, and D− pins. In alternative configurations, the USB receptacles 2308 can provide the active Vbus and GND pins while providing no pins for D+ and D−. It is contemplated that when the USB receptacles 2308 is implemented in USB receptacles other than type-A, the ID pin can also be inactive or nonexistent.

It has been discovered that providing the active Vbus and GND pins, while not providing active D+, D−, or ID pins, allows the desktop system 2300 to be produced at a lower price point and less manufacturing complexity because no circuitry or internal connections are needed for the D+, D−, or ID pins.

It has further been discovered that providing only a USB receptacle rather than a USB plug, greatly increases the versatility and usability of the desktop system 2300 by allowing users to plug in a USB charging plug that is compatible with the type-A or type-C receptacle on one end and any other USB receptacle on the other. That is, a user can use the USB receptacles 2308 to charge an electronic device requiring a USB mini-A, a USB mini-B, a USB micro-A, a USB micro-B, or even a USB type-B connection by using the user's own USB charging cable.

Further it has been discovered that the USB receptacles 2308 increase the ergonomic functionality and versatility of the desktop system 2300 by enabling a user to plug in their charging cable and position their electronic device anywhere within reach of the desktop system 2300. The electronic device can be positioned out of the way and the user can easily reach the desktop system 2300 without needing to stand up, walk over to an outlet, bend over, and plug their electronic device in.

The AC receptacle 2310 is shown positioned vertically above the USB receptacles 2308. The AC receptacle 2310 can be an external receptacle portion of an AC-unit 2314. The USB receptacles 2308 and the AC receptacle 2310 can be exposed from a base housing 2316.

The AC-unit 2314 and the USB-units 2312 can be combined within the base housing 2316 into modules. The modules of the AC-unit 2314 and the USB-units 2312 can include the AC-unit 2314 or multiple USB-units 2312 and can share components like conductors, passive electrical components, and circuit boards. The modules of the AC-unit 2314 and the USB-units 2312 can also be housed with an internal housing that is contained within the base housing 2316.

The AC-unit 2314 and the USB-units 2312 can also be combined within the base housing 2316 into sealed modules. The sealed modules of the AC-unit 2314 and the USB-units 2312 can include the AC-unit 2314 or multiple USB-units 2312 and can share components like conductors, passive electrical components, and circuit boards. The sealed modules of the AC-unit 2314 and the USB-units 2312 can also be housed with a sealed internal housing that is contained within the base housing 2316.

The AC receptacle 2310 and the USB receptacles 2308 are shown exposed from multiple openings in a side 2318 of the base housing 2316 of the base unit 2302. The side 2318 can be a curved side or a side having an inward slope near a bottom and an outward slope as the height of side 2318 increases.

The base housing 2316 is contemplated to be a lava lamp base having the lighting source 2304 contained therein. The lighting source 2304 is contemplated to be a heater. Alternatively, the base housing 1316 is contemplated to include a heater in addition to the lighting source 2304.

It has been discovered that shaping the base unit 2302 to resemble a lava lamp enables greater integration of the desktop system 2300 onto the desk, countertop, or nightstand of a user because the desktop system 2300 does not occupy new desk top space but only occupies the same amount of space as any previously used lava lamp.

The base housing 2316 is contemplated to be made of plastics or metals depending on the level of quality demanded by users and supported by the market. The base unit 2302 further includes a base foot 2320 below the base housing 2316 and connected thereto.

The base unit 2302 is shown having a power input 2322. The power input 2322 is shown having a cable 2324 coupled to the base foot 2320 and a USB plug 2326 coupled to the end of the cable 2324 opposite of the base foot 2320. The USB plug 2326 is contemplated to be compatible with USB type-A or USB type-C receptacles.

The power from the power input 2322 can be a single power type and can be conducted straight from the power input 2322 through circuitry in the USB-units 2312 to the USB receptacles 2308 of the USB-units 2312. It has been discovered that conducting the power from the power input 2322 straight through the USB-units 2312 without modifying the power improves the desktop system 2300 by reducing manufacturing costs, complexity, and component failure points.

The single power type from the power input 2322 can also be converted in circuitry in the AC-unit 2314 from a DC Vbus power source to an AC power and provided as an output at the AC receptacle 2310 of the AC-unit 2314. It has been discovered that converting the power from the single power type of the power input 2322 improves the desktop system 2300 by reducing manufacturing costs, complexity, and component failure points because the circuitry doing the conversion can be designed for a single power type and is not required to convert multiple different types of input power.

It is contemplated that the AC receptacle 2310 and the USB receptacles 2308 can be configured to produce one ampere to ten amperes of current. As an example, the AC-unit 2314 or the USB-units 2312 can be configured to output 1.0 ampere, 2.1 ampere, 2.4 ampere and multiples of 2.4 amperes. It is further contemplated that the AC receptacle 2310 can be configured to have a power rating of 1850 watts.

The lighting source 2304 within the base housing 2316 can be LEDs or OLEDs. The lighting source 2304 is contemplated to be configurable to emit multiple different wavelengths of light including red, blue, and multiple wavelengths of light simultaneously like white light.

The desktop system 2300 can take power from the power input 2322 and conduct it through the circuitry of the USB-units 2312 to power the USB receptacles 2308, convert it within the AC-unit 2314 to power the AC receptacle 2310, or conduct it to the lighting source 2304 to power the lighting source 2304 directly.

It has been discovered that removing extra circuitry associated with the conversion of the power from the power input 2322 to be useable with the USB-units 2312 and the lighting source 2304 and directly connecting the USB receptacles 2308 and the lighting source 2304 to the power input 2322 greatly reduces costs and complexity of producing and designing the desktop system 2300 while simultaneously reducing the number of components that could potentially fail.

Further, the desktop system 2300 does not include any batteries for power storage for the power of the power input 2322. That is, when the power from the power input 2322 is removed the AC receptacle 2310, the USB receptacles 2308, and the lighting source 2304 are no longer powered. It has been discovered that providing the desktop system 2300 without batteries for power storage can provide a smaller footprint, simplified design, and a lower bill of materials along with a more robust design.

The desktop system 2300 can be implemented in many form factors, which offer functions, effects, and performances engaging people's eye, nose, mouth, and ears for a period of time while people are working, resting, sleeping, or standing. Illustratively, it is contemplated the desktop system 2300 in other form factors can include a light source for area illumination, indicator light to show charging status, image projecting light, time source light for indicating time. Further it is contemplated the desktop system 2300 in other form factors can generate, exhibit, or provide light beams, or offer area illumination; show or project a time display of a clock, photos, or other images; offer or play music or sound; create or produce air flow at a desired temperature, moisture, steam, or smell; offer liquids such as coffee or tea; or offer food.

Referring now to FIG. 24, therein is shown an isometric top view of the desktop system 2400 in an eighth embodiment. The desktop system 2400 is depicted having a base unit 2402 containing a lighting source 2404. The base unit 2402 is shown as a liquid container coupled to a coupled to a tank 2406.

The base unit 2402 is shown having a USB receptacle 2408. The USB receptacle 2408 can be external receptacle portions of a USB-unit 2412 and is contemplated to be a USB type-A or a USB type-C receptacle.

The USB receptacle 2408 can provide active Vbus and GND pins while providing inactive D+, and D− pins. In alternative configurations, the USB receptacle 2408 can provide the active Vbus and GND pins while providing no pins for D+ and D−. It is contemplated that when the USB receptacle 2408 is implemented in USB receptacles other than type-A, the ID pin can also be inactive or nonexistent.

It has been discovered that providing the active Vbus and GND pins, while not providing active D+, D−, or ID pins, allows the desktop system 2400 to be produced at a lower price point and less manufacturing complexity because no circuitry or internal connections are needed for the D+, D−, or ID pins.

It has further been discovered that providing only a USB receptacle rather than a USB plug, greatly increases the versatility and usability of the desktop system 2400 by allowing users to plug in a USB charging plug that is compatible with the type-A or type-C receptacle on one end and any other USB receptacle on the other. That is, a user can use the USB receptacle 2408 to charge an electronic device requiring a USB mini-A, a USB mini-B, a USB micro-A, a USB micro-B, or even a USB type-B connection by using the user's own USB charging cable.

Further it has been discovered that the USB receptacle 2408 increase the ergonomic functionality and versatility of the desktop system 2400 by enabling a user to plug in their charging cable and position their electronic device anywhere within reach of the desktop system 2400. The electronic device can be positioned out of the way and the user can easily reach the desktop system 2400 without needing to stand up, walk over to an outlet, bend over, and plug their electronic device in.

The USB-unit 2412 can be a module within the base housing 2416. The module of the USB-unit 2412 can include components like conductors, passive electrical components, and circuit boards. The module of the USB-unit 2412 can also be housed with an internal housing that is contained within the base housing 2416.

The USB-unit 2412 can also be a sealed module within the base housing 2416. The sealed module of the USB-unit 2412 can include components like conductors, passive electrical components, and circuit boards. The sealed module of the USB-unit 2412 can also be housed with a sealed internal housing that is contained within the base housing 2416.

The USB receptacle 2408 is shown exposed from a single opening in a side 2418 of the base housing 2416 of the base unit 2402. The side 2418 can be a vertical or substantially vertical side. The base housing 2416 is contemplated to be a coffee pot base having the lighting source 2404 contained therein. The base housing 2416 is contemplated to include a heater.

It has been discovered that shaping the base unit 2402 to coffee pot enables greater integration of the desktop system 2400 onto the desk, countertop, or nightstand of a user because the desktop system 2400 does not occupy new desk top space but only occupies the same amount of space as any previously used coffee pot.

The base housing 2416 is contemplated to be made of plastics or metals depending on the level of quality demanded by users and supported by the market. The base unit 2402 further includes a power input. The power from the power input can be a single power type and can be conducted straight from the power input through circuitry in the USB-unit 2412 to the USB receptacle 2408.

It has been discovered that conducting the power from the power input straight through the USB-unit 2412 without modifying the power improves the desktop system 2400 by reducing manufacturing costs, complexity, and component failure points.

The single power type from the power input can also be converted in circuitry in the USB-unit 2412 from an AC power source to a DC Vbus power source. It has been discovered that converting the power from the single power type of the power input improves the desktop system 2400 by reducing manufacturing costs, complexity, and component failure points because the circuitry doing the conversion can be designed for a single power type and is not required to convert multiple different types of input power.

It is contemplated that the USB receptacle 2408 can be configured to produce one ampere to ten amperes of current. As an example, the USB-unit 2412 can be configured to output 1.0 ampere, 2.1 ampere, 2.4 ampere and multiples of 2.4 amperes.

The lighting source 2404 within the base housing 2416 can be LEDs or OLEDs. The lighting source 2404 is contemplated to be configurable to emit multiple different wavelengths of light including red, blue, and multiple wavelengths of light simultaneously like white light.

The desktop system 2400 can take power from the power input and conduct it through the circuitry of the USB-unit 2412 to power the USB receptacle 2408 or conduct it to the lighting source 2404 to power the lighting source 2404 directly.

It has been discovered that removing extra circuitry associated with the conversion of the power from the power input to be useable with the USB-unit 2412 and the lighting source 2404 and directly connecting the USB receptacle 2408 and the lighting source 2404 to the power input greatly reduces costs and complexity of producing and designing the desktop system 2400 while simultaneously reducing the number of components that could potentially fail.

Further, the desktop system 2400 does not include any batteries for power storage for the power of the power input. That is, when the power from the power input is removed, the USB receptacle 2408 and the lighting source 2404 are no longer powered. It has been discovered that providing the desktop system 2400 without batteries for power storage can provide a smaller footprint, simplified design, and a lower bill of materials along with a more robust design.

The desktop system 2400 can be implemented in many form factors, which offer functions, effects, and performances engaging people's eye, nose, mouth, and ears for a period of time while people are working, resting, sleeping, or standing. Illustratively, it is contemplated the desktop system 2400 in other form factors can include a light source for area illumination, indicator light to show charging status, image projecting light, time source light for indicating time. Further it is contemplated the desktop system 2400 in other form factors can generate, exhibit, or provide light beams, or offer area illumination; show or project a time display of a clock, photos, or other images; offer or play music or sound; create or produce air flow at a desired temperature, moisture, steam, or smell; offer liquids such as coffee or tea; or offer food.

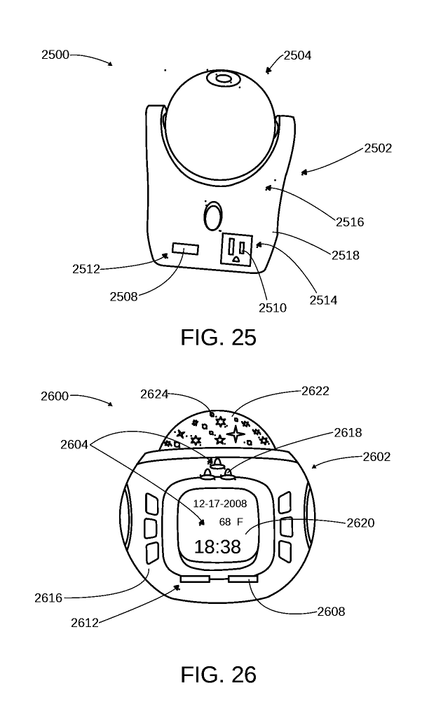

Referring now to FIG. 25, therein is shown an isometric top view of the desktop system 2500 in a ninth embodiment. The desktop system 2500 is depicted having a base unit 2502 coupled to a lighting source 2504.

The base unit 2502 is shown having a USB receptacle 2508 and an AC receptacle 2510. The USB receptacle 2508 can be an external receptacle portion of a USB-unit 2512 and is contemplated to be a USB type-A or USB type-C receptacle.

The USB receptacle 2508 can provide active Vbus and GND pins while providing inactive D+, and D− pins. In alternative configurations, the USB receptacle 2508 can provide the active Vbus and GND pins while providing no pins for D+ and D−. It is contemplated that when the USB receptacle 2508 is implemented in USB receptacles other than type-A, the ID pin can also be inactive or nonexistent.

It has been discovered that providing the active Vbus and GND pins, while not providing active D+, D−, or ID pins, allows the desktop system 2500 to be produced at a lower price point and less manufacturing complexity because no circuitry or internal connections are needed for the D+, D−, or ID pins.

It has further been discovered that providing only a USB receptacle rather than a USB plug, greatly increases the versatility and usability of the desktop system 2500 by allowing users to plug in a USB charging plug that is compatible with the type-A or type-C receptacle on one end and any other USB receptacle on the other. That is, a user can use the USB receptacle 2508 to charge an electronic device requiring a USB mini-A, a USB mini-B, a USB micro-A, a USB micro-B, or even a USB type-B connection by using the user's own USB charging cable.

Further it has been discovered that the USB receptacle 2508 increase the ergonomic functionality and versatility of the desktop system 2500 by enabling a user to plug in their charging cable and position their electronic device anywhere within reach of the desktop system 2500. The electronic device can be positioned out of the way and the user can easily reach the desktop system 2500 without needing to stand up, walk over to an outlet, bend over, and plug their electronic device in.

The AC receptacle 2510 is shown positioned horizontally beside the USB receptacle 2508. The AC receptacle 2510 can be an external receptacle portion of an AC-unit 2514. The USB receptacle 2508 and the AC receptacle 2510 can be exposed from a base housing 2516.

The AC-unit 2514 and the USB-unit 2512 can be combined within the base housing 2516 into a module. The module of the AC-unit 2514 and the USB-unit 2512 can share components like conductors, passive electrical components, and circuit boards. The module of the AC-unit 2514 and the USB-unit 2512 can also be housed with an internal housing that is contained within the base housing 2516.

The AC-unit 2514 and the USB-unit 2512 can also be combined within the base housing 2516 into a sealed module. The sealed module of the AC-unit 2514 and the USB-unit 2512 can share components like conductors, passive electrical components, and circuit boards. The sealed module of the AC-unit 2514 and the USB-unit 2512 can also be housed with a sealed internal housing that is contained within the base housing 2516.

The AC receptacle 2510 and the USB receptacle 2508 are shown exposed from multiple openings in a side 2518 of the base housing 2516 of the base unit 2502. The side 2518 can be a curved side or a side having an inward slope near a bottom and an outward slope as the height of side 2518 increases.

The lighting source 2504 is contemplated to be a moveable projection lamp such as an LED projection nightlight. The lighting source 2504 and the base housing 2516 are contemplated to be made of plastics.

The base unit 2502 can include or be coupled to a power input. The power from the power input can be a single power type and can be conducted straight from the power input through circuitry in the USB-unit 2512 to the USB receptacle 2508 of the USB-unit 2512. It has been discovered that conducting the power from the power input straight through the USB-unit 2512 without modifying the power improves the desktop system 2500 by reducing manufacturing costs, complexity, and component failure points.

The power from the power input can be a single power type and can be conducted straight from the power input through circuitry in the AC-unit 2514 to the AC receptacle 2510. It has been discovered that conducting the power from the power input straight through the AC-unit 2514 without modifying the power improves the desktop system 2500 by reducing manufacturing costs, complexity, and component failure points.

The single power type from the power input can also be converted in circuitry in the AC-unit 2514 from a DC Vbus power source to an AC power and provided as an output at the AC receptacle 2510 of the AC-unit 2514. It has been discovered that converting the power from the single power type of the power input improves the desktop system 2500 by reducing manufacturing costs, complexity, and component failure points because the circuitry doing the conversion can be designed for a single power type and is not required to convert multiple different types of input power.

The single power type from the power input can also be converted in circuitry in the USB-units 2512 from an AC source to a DC Vbus power source and provided as an output at the USB receptacles 1508. It has been discovered that converting the power from the single power type of the power input improves the desktop system 2500 by reducing manufacturing costs, complexity, and component failure points because the circuitry doing the conversion can be designed for a single power type and is not required to convert multiple different types of input power.

It is contemplated that the AC receptacle 2510 and the USB receptacle 2508 can be configured to produce one ampere to ten amperes of current. As an example, the AC-unit 2514 or the USB-units 2512 can be configured to output 1.0 ampere, 2.1 ampere, 2.4 ampere and multiples of 2.4 amperes. It is further contemplated that the AC receptacle 2510 can be configured to have a power rating of 1850 watts.

The lighting source 2504 can be LEDs or OLEDs. The lighting source 2504 is contemplated to be configurable to emit multiple different wavelengths of light including red, blue, and multiple wavelengths of light simultaneously like white light.

The desktop system 2500 can take power from the power input and conduct it through the circuitry of the USB-unit 2512 to power the USB receptacle 2508, convert it within the AC-unit 2514 to power the AC receptacle 2510, or conduct it to the lighting source 2504 to power the lighting source 2504 directly. It is contemplated that other embodiments could include power from the power input and convert it in the circuitry of the USB-unit 2512 to power the USB receptacle 2508, conduct it through the AC-unit 2514 to power the AC receptacle 2510, or conduct it to the lighting source 2504 to directly power the lighting source 2504.

It has been discovered that removing extra circuitry associated with the conversion of the power from the power input to be useable with the USB-unit 2512 and the lighting source 2504 and directly connecting the USB receptacle 2508 and the lighting source 2504 to the power input greatly reduces costs and complexity of producing and designing the desktop system 2500 while simultaneously reducing the number of components that could potentially fail.

Further, the desktop system 2500 does not include any batteries for power storage for the power of the power input. That is, when the power from the power input is removed the AC receptacle 2510, the USB receptacle 2508, and the lighting source 2504 are no longer powered. It has been discovered that providing the desktop system 2500 without batteries for power storage can provide a smaller footprint, simplified design, and a lower bill of materials along with a more robust design.

The desktop system 2500 can be implemented in many form factors, which offer functions, effects, and performances engaging people's eye, nose, mouth, and ears for a period of time while people are working, resting, sleeping, or standing. Illustratively, it is contemplated the desktop system 2500 in other form factors can include a light source for area illumination, indicator light to show charging status, image projecting light, time source light for indicating time. Further it is contemplated the desktop system 2500 in other form factors can generate, exhibit, or provide light beams, or offer area illumination; show or project a time display of a clock, photos, or other images; offer or play music or sound; create or produce air flow at a desired temperature, moisture, steam, or smell; offer liquids such as coffee or tea; or offer food.

Referring now to FIG. 26, therein is shown an isometric top view of the desktop system 2600 in a tenth embodiment. The desktop system 2600 is depicted having a base unit 2602 including lighting sources 2604.

The base unit 2602 is further shown having USB receptacles 2608. The USB receptacles 2608 can be an external receptacle portion of USB-units 2612 and are contemplated to be a USB type-A or USB type-C receptacles.

The USB receptacles 2608 can provide active Vbus and GND pins while providing inactive D+, and D− pins. In alternative configurations, the USB receptacles 2608 can provide the active Vbus and GND pins while providing no pins for D+ and D−. It is contemplated that when the USB receptacles 2608 is implemented in USB receptacles other than type-A, the ID pin can also be inactive or nonexistent.

It has been discovered that providing the active Vbus and GND pins, while not providing active D+, D−, or ID pins, allows the desktop system 2600 to be produced at a lower price point and less manufacturing complexity because no circuitry or internal connections are needed for the D+, D−, or ID pins.

It has further been discovered that providing only a USB receptacle rather than a USB plug, greatly increases the versatility and usability of the desktop system 2600 by allowing users to plug in a USB charging plug that is compatible with the type-A or type-C receptacle on one end and any other USB receptacle on the other. That is, a user can use the USB receptacles 2608 to charge an electronic device requiring a USB mini-A, a USB mini-B, a USB micro-A, a USB micro-B, or even a USB type-B connection by using the user's own USB charging cable.

Further it has been discovered that the USB receptacles 2608 increase the ergonomic functionality and versatility of the desktop system 2600 by enabling a user to plug in their charging cable and position their electronic device anywhere within reach of the desktop system 2600. The electronic device can be positioned out of the way and the user can easily reach the desktop system 2600 without needing to stand up, walk over to an outlet, bend over, and plug their electronic device in.

The USB receptacles 2608 are shown positioned horizontally offset. The USB receptacles 2608 are shown exposed from a base housing 2616. The USB-units 2612 can be combined within the base housing 2616 into a module. The module of the USB-units 2612 can share components like conductors, passive electrical components, and circuit boards. The module of the USB-units 2612 can also be housed with an internal housing that is contained within the base housing 2616.

The USB-units 2612 can also be combined within the base housing 2616 into a sealed module. The sealed module of the USB-units 2612 can share components like conductors, passive electrical components, and circuit boards. The sealed module of the USB-units 2612 can also be housed with a sealed internal housing that is contained within the base housing 2616.

The lighting sources 2604 are contemplated to include individual LEDs 2618 and LEDs or OLEDs configured to be a screen or display 2620. The individual LEDs 2618 are shown directed toward a projection unit 2622 having pinhole cutouts 2624 for projecting shapes. The base housing 2616 and the projection unit 2622 are contemplated to be made of plastics.

The lighting sources 2604 can be LEDs or OLEDs. The lighting sources 2604 is contemplated to be configurable to emit multiple different wavelengths of light including red, blue, and multiple wavelengths of light simultaneously like white light.

The base unit 2602 can include or be coupled to a power input. The power from the power input can be a single power type and can be conducted straight from the power input through circuitry in the USB-units 2612 to the USB receptacles 2608 of the USB-units 2612. It has been discovered that conducting the power from the power input straight through the USB-units 2612 without modifying the power improves the desktop system 2600 by reducing manufacturing costs, complexity, and component failure points.

The single power type from the power input can also be converted in circuitry in the USB-units 2612 from an AC source to a DC Vbus power source and provided as an output at the USB receptacles 1508. It has been discovered that converting the power from the single power type of the power input improves the desktop system 2600 by reducing manufacturing costs, complexity, and component failure points because the circuitry doing the conversion can be designed for a single power type and is not required to convert multiple different types of input power.

The desktop system 2600 can take power from the power input and conduct it through the circuitry of the USB-units 2612 to power the USB receptacles 2608 or conduct it to the lighting sources 2604 to power the lighting sources 2604 directly. It is contemplated that other embodiments could include power from the power input and convert it in the circuitry of the USB-units 2612 to power the USB receptacles 2608 or convert the power input in the circuitry of the USB-units 2612 and then conduct it to the lighting sources 2604 to directly power the lighting sources 2604.

It has been discovered that removing extra circuitry associated with the conversion of the power from the power input to be useable with the USB-units 2612 and the lighting sources 2604 and directly connecting the USB receptacles 2608 and the lighting sources 2604 to the power input greatly reduces costs and complexity of producing and designing the desktop system 2600 while simultaneously reducing the number of components that could potentially fail.

Further, the desktop system 2600 does not include any batteries for power storage for the power of the power input. That is, when the power from the power input is removed the USB receptacles 2608 and the lighting sources 2604 are no longer powered. It has been discovered that providing the desktop system 2600 without batteries for power storage can provide a smaller footprint, simplified design, and a lower bill of materials along with a more robust design.

The desktop system 2600 can be implemented in many form factors, which offer functions, effects, and performances engaging people's eye, nose, mouth, and ears for a period of time while people are working, resting, sleeping, or standing. Illustratively, it is contemplated the desktop system 2600 in other form factors can include a light source for area illumination, indicator light to show charging status, image projecting light, time source light for indicating time. Further it is contemplated the desktop system 2600 in other form factors can generate, exhibit, or provide light beams, or offer area illumination; show or project a time display of a clock, photos, or other images; offer or play music or sound; create or produce air flow at a desired temperature, moisture, steam, or smell; offer liquids such as coffee or tea; or offer food.

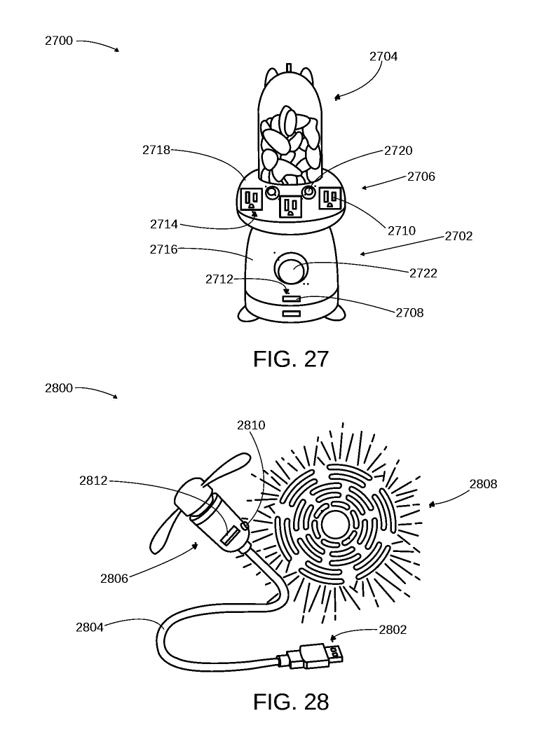

Referring now to FIG. 27, therein is shown an isometric top view of the desktop system 2700 in an eleventh embodiment. The base unit 2702 is shown coupled to a canister 2704 with a support 2706.

The base unit 2702 is shown having USB receptacles 2708 while the support 2706 is shown having AC receptacles 2710. The USB receptacles 2708 can be external receptacle portions of USB-units 2712 and are contemplated to be USB type-A or USB type-C receptacles.

The USB receptacles 2708 can provide active Vbus and GND pins while providing inactive D+, and D− pins. In alternative configurations, the USB receptacles 2708 can provide the active Vbus and GND pins while providing no pins for D+ and D−. It is contemplated that when the USB receptacles 2708 is implemented in USB receptacles other than type-A, the ID pin can also be inactive or nonexistent.

It has been discovered that providing the active Vbus and GND pins while not providing active D+, D−, or ID pins allows the desktop system 2700 to be produced at a lower price point and less manufacturing complexity because no circuitry or internal connections are needed for the D+, D−, or ID pins.

It has further been discovered that providing only a USB receptacle rather than a USB plug, greatly increases the versatility and usability of the desktop system by allowing users to plug in a USB charging plug that is compatible with the type-A or type-C receptacle on one end and any other USB receptacle on the other. That is, a user can use the USB receptacles 2708 to charge an electronic device requiring a USB mini-A, a USB mini-B, a USB micro-A, a USB micro-B, or even a USB type-B connection by using the user's own USB charging cable.

Further it has been discovered that the USB receptacles 2708 increase the ergonomic functionality and versatility of the desktop system by enabling a user to plug in their charging cable and position their electronic device anywhere within reach of the desktop system. The electronic device can be positioned out of the way and the user can easily reach the desktop system without needing to stand up, walk over to an outlet, bend over, and plug their electronic device in.

The USB receptacles 2708 are shown configured with two of the USB receptacles 2708 vertically offset on the base unit 2702. The AC receptacles 2710 are depicted horizontally offset from each other and arranged on the support 2706. The AC receptacles 2710 can be external receptacle portions of AC-units 2714.

The USB-units 2712 can be combined within a base housing 2716 into modules. The modules of the USB-units 2712 can include multiple USB-units 2712 and can share components like conductors, passive electrical components, and circuit boards. The modules of the USB-units 2712 can also be housed with an internal housing that is contained within the base housing 2716.

The AC-units 2714 can be combined within a support housing 2718 into modules. The modules of the AC-units 2714 can include multiple AC-units 2714 and can share components like conductors, passive electrical components, and circuit boards. The modules of the AC-units 2714 can also be housed with an internal housing that is contained within the support housing 2718.

The USB-units 2712 can be combined within a base housing 2716 into sealed modules. The sealed modules of the USB-units 2712 can include multiple USB-units 2712 and can share components like conductors, passive electrical components, and circuit boards. The sealed modules of the USB-units 2712 can also be housed with an internal housing that is contained within the base housing 2716.

The AC-units 2714 can be combined within a support housing 2718 into sealed modules. The sealed modules of the AC-units 2714 can include multiple AC-units 2714 and can share components like conductors, passive electrical components, and circuit boards. The sealed modules of the AC-units 2714 can also be housed with an internal housing that is contained within the support housing 2718.

As an illustrative example, the USB-units 2712 can be combined into a single USB-module or single sealed USB-module with an internal housing and sharing components. As a further illustrative example, each of the USB-units 2712 can be separated into individual modules, or individual sealed modules, self-contained within their own internal housings.

As an illustrative example, the AC-units 2714 can be combined into a single AC-module or single sealed AC-module with an internal housing and sharing components. As a further illustrative example, each of the AC-units 2714 can be separated into individual modules, or individual sealed modules, self-contained within their own internal housings.

The support housing 2718 is shown having an indicator lights 2720 while the base housing 2716 is shown having controls 2722. The indicator light 2720 can visually depict the charging or the charging status of a device plugged into the AC receptacles 2710 or the USB receptacles 2708. The indicator light 2720 can also show the power status of the desktop system, the operation of the canister 2704, or the state of the controls 2722.

Referring now to FIG. 28, therein is shown an isometric side view of an implement 2800 for use with the desktop system. The implement 2800 is shown having a plug 2802 for plugging into the USB receptacles of the desktop system.

The implement 2800 can further include a support 2804 coupling the plug 2802 to a fan unit 2806. The fan unit 2806 is contemplated to include LEDs for creating geometric projections 2808 as the fan unit 2806 spins. The fan unit 2806 can include a power button 2810 for turning the fan unit 2806 or the LEDs on.

The fan unit 2806 is shown having a USB receptacle 2812. The USB receptacle 2812 can be external receptacle portions of USB-units and are contemplated to be USB type-A or USB type-C receptacles.

The USB receptacle 2812 can provide active Vbus and GND pins while providing inactive D+, and D− pins. In alternative configurations, the USB receptacle 2812 can provide the active Vbus and GND pins while providing no pins for D+ and D−. It is contemplated that when the USB receptacle 2812 is implemented in USB receptacles other than type-A, the ID pin can also be inactive or nonexistent.

It has been discovered that providing the active Vbus and GND pins, while not providing active D+, D−, or ID pins, allows the implement 2800 to be produced at a lower price point and less manufacturing complexity because no circuitry or internal connections are needed for the D+, D−, or ID pins.

It has further been discovered that providing only a USB receptacle rather than a USB plug, greatly increases the versatility and usability of the implement 2800 by allowing users to plug in a USB charging plug that is compatible with the type-A or type-C receptacle on one end and any other USB receptacle on the other. That is, a user can use the USB receptacle 2812 to charge an electronic device requiring a USB mini-A, a USB mini-B, a USB micro-A, a USB micro-B, or even a USB type-B connection by using the user's own USB charging cable.

Further it has been discovered that the USB receptacle 2808 increase the ergonomic functionality and versatility of the implement 2800 by enabling a user to plug in their charging cable and position their electronic device anywhere within reach of the implement 2800. The electronic device can be positioned out of the way and the user can easily reach the implement 2800 without needing to stand up, walk over to an outlet, bend over, and plug their electronic device in.

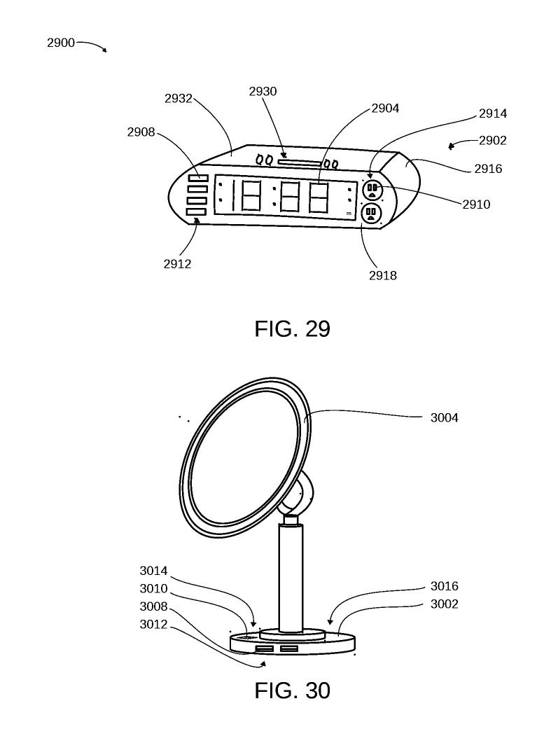

Referring now to FIG. 29, therein is shown an isometric side view of the desktop system 2900 in a twelfth embodiment. The desktop system 2900 is depicted having a base unit 2902 including a lighting source 2904.

The base unit 2902 is shown having USB receptacles 2908 and AC receptacles 2910. The USB receptacles 2908 can be external receptacle portions of USB-units 2912 and are contemplated to be USB type-A or USB type-C receptacles.

The USB receptacles 2908 can provide active Vbus and GND pins while providing inactive D+, and D− pins. In alternative configurations, the USB receptacles 2908 can provide the active Vbus and GND pins while providing no pins for D+ and D−. It is contemplated that when the USB receptacles 2908 is implemented in USB receptacles other than type-A, the ID pin can also be inactive or nonexistent.

It has been discovered that providing the active Vbus and GND pins while not providing active D+, D−, or ID pins allows the desktop system 2900 to be produced at a lower price point and less manufacturing complexity because no circuitry or internal connections are needed for the D+, D−, or ID pins.

It has further been discovered that providing only a USB receptacle rather than a USB plug, greatly increases the versatility and usability of the desktop system 2900 by allowing users to plug in a USB charging plug that is compatible with the type-A or type-C receptacle on one end and any other USB receptacle on the other. That is, a user can use the USB receptacles 2908 to charge an electronic device requiring a USB mini-A, a USB mini-B, a USB micro-A, a USB micro-B, or even a USB type-B connection by using the user's own USB charging cable.

Further it has been discovered that the USB receptacles 2908 increase the ergonomic functionality and versatility of the desktop system 2900 by enabling a user to plug in their charging cable and position their electronic device anywhere within reach of the desktop system 2900. The electronic device can be positioned out of the way and the user can easily reach the desktop system 2900 without needing to stand up, walk over to an outlet, bend over, and plug their electronic device in.

The USB receptacles 2908 are shown vertically aligned on one side of the base unit 2902. The AC receptacles 2910 are shown vertically aligned on the other side of the base unit 2902 form the USB receptacles 2908. The AC receptacles 2910 can be external receptacle portions of AC-units 2914.

The AC-units 2914 and the USB-units 2912 can be combined within a base housing 2916 into modules. The modules of the AC-units 2914 and the USB-units 2912 can include multiple AC-units 2914 or multiple USB-units 2912 and can share components like conductors, passive electrical components, and circuit boards. The modules of the AC-units 2914 and the USB-units 2912 can also be housed with an internal housing that is contained within the base housing 2916.

The AC-units 2914 and the USB-units 2912 can also be combined within the base housing 2916 into sealed modules. The sealed modules of the AC-units 2914 and the USB-units 2912 can include multiple AC-units 2914 or multiple USB-units 2912 and can share components like conductors, passive electrical components, and circuit boards. The sealed modules of the AC-units 2914 and the USB-units 2912 can also be housed with a sealed internal housing that is contained within the base housing 2916.

As an illustrative example, the two USB-units 2912 can be a single USB-module, or a sealed USB-module, with an internal housing and sharing components. As a further illustrative example, each of the AC-units 2914 and the USB-units 2912 can be individual modules, or individual sealed modules, self-contained within their own internal housings. As a further illustrative example the AC-units 2914 along with the USB-units 2912 can be combined into a single module, or single sealed module, sharing an internal housing and components.

The AC receptacles 2910 and the USB receptacles 2908 are shown exposed from multiple openings in a front side 2918 of the base housing 2916. The front side 2918 can be a vertical side or a substantially vertical side of the base housing 2916.

The base housing 2916 is contemplated to be a digital led clock having a universal shape that can be formed to resemble multiple types of existing clock bases. It has been discovered that shaping the base unit 2902 to resemble currently used bases enables greater integration of the desktop system 2900 onto the desk of a user because the desktop system 2900 does not occupy new desk top space but only occupies the same amount of space as any previously used desktop clock.

The base housing 2916 is contemplated to be made of plastics or metals depending on the level of quality demanded by users and supported by the market. The base unit 2902 is contemplated to be coupled to a power input. The power input can include a cable coupled to the base housing 2916 and an AC plug coupled to the end of the cable opposite of the base housing 2916.

The AC plug is contemplated to be compatible with a 120 volt 60 hertz AC receptacle or a 230 volt 290 hertz AC receptacle. The power input can include an adapter coupled between the AC plug and the cable or alternatively, the AC plug can be directly coupled to the cable.

The power from the power input can be a single power type and can be conducted straight from the power input through circuitry in the USB-units 2912 to the USB receptacles 2908 of the USB-units 2912. It has been discovered that conducting the power from the power input straight through the USB-units 2912 without modifying the power improves the desktop system 2900 by reducing manufacturing costs, complexity, and component failure points.

It is contemplated that each of the USB-units 2912 can also convert the single power type from the power input into multiple different ampere ratings. For example, it is contemplated that the USB-units 2912 can convert the single power type to supply a 500 milliamperes, 1,000 milliamperes, or 2,100 milliamperes DC current to the USB receptacles 2908.

It is contemplated that the USB-units 2912 can change the ampere rating based on the external mobile device plugged into the corresponding USB receptacle 2908. It is further contemplated that the USB-units 2912 can be dedicated to a specific and fixed ampere rating.

It has been discovered that providing multiple ampere ratings enables the USB-units 2912 to charge different mobile devices effectively. It has been further discovered that the USB-units 2912 set to supply a specific fixed ampere rating to the mobile devices reduces the complexity of the conversion circuitry required by the USB-units 2912 and thus reduces manufacturing costs and complexity.

The single power type of the power input can also be converted in circuitry in the AC-units 2914 from a DC Vbus power source to an AC power and provided as an output at the AC receptacles 2910 of the AC-units 2914. It has been discovered that converting the power from the single power type of the power input improves the desktop system 2900 by reducing manufacturing costs, complexity, and component failure points because the circuitry doing the conversion can be designed for a single power type and is not required to convert multiple different types of input power.

It is contemplated that in alternate embodiments, the power from the power input can be a single power type and can be conducted straight from the AC plug of the power input to circuitry in the USB-units 2912, which converts the power from the power input to DC. The converted power from the USB-units 2912 is output on the USB receptacles 2908. It has been discovered that conducting the power from the power input straight to the USB-units 2912 without modifying the power improves the desktop system 2900 by reducing manufacturing costs, complexity, and component failure points.

It is contemplated that in alternate embodiments that each of the USB-units 2912 can also convert the single power type from the AC plug into multiple different ampere ratings. For example it is contemplated that the USB-units 2912 can convert the single power type from the AC plug and convert it to supply a 500 milliamperes, 1,000 milliamperes, or 2,100 milliamperes DC current to the USB receptacles 2908.

In some contemplated embodiments, the power from the power AC plug can be a single power type and can be conducted straight from the AC plug of the power input through circuitry in the AC-units 2914 to the AC receptacles 2910. It has been discovered that conducting the power from the power input straight through the AC-units 2914 without modifying the power improves the desktop system 2900 by reducing manufacturing costs, complexity, and component failure points.

The base unit 2902 is depicted having a controls 2930 exposed from a top side 2932 of the base housing 2916. The controls 2930 can be used to turn off the USB-units 2912 and the AC-units 2914.

The lighting sources 2904 can be LEDs in a digital clock for displaying the time. The controls 2930 can further be used to control the clock display of the lighting sources 2904.

The desktop system 2900 can take power from the power input and conduct it through the circuitry of the USB-units 2912 to power the USB receptacles 2908, convert it within the AC-units 2914 to power the AC receptacles 2910, or conduct it directly from the power input to clock circuitry for displaying the current time and powering the lighting sources 2904.

It has been discovered that removing extra circuitry associated with the conversion of the power from the power input to be useable with the USB-units 2912 and directly connecting the USB receptacles 2908 to the power input greatly reduces costs and complexity of producing and designing the desktop system 2900 while simultaneously reducing the number of components that could potentially fail.

Further, the desktop system 2900 does not include any batteries for power storage for the power of the power input. That is, when the power from the power input is removed the AC receptacles 2910, the USB receptacles 2908, and the lighting sources 2904 are no longer powered. It has been discovered that providing the desktop system 2900 without batteries for power storage can provide a smaller footprint, simplified design, and a lower bill of materials along with a more robust design. It has also been discovered that it is very difficult to supply the high current levels required by mobile devices and the lighting source 2904 with batteries for power storage unit.

It is contemplated that the desktop system 2900 could be implemented with the adjustment circuit 308 of FIG. 3 separate from the illumination controller circuit 304 of FIG. 3 for controlling the display of the lighting source 2904, and that both the adjustment circuit 308 and the illumination controller circuit 304 can be contained within the base housing 2916. It has been discovered that implementing the adjustment circuit 308 separate from the illumination controller circuit 304 within the base housing 2916 provides higher DC current for very quickly charging devices coupled to the USB receptacles 2908. That is, by separating the power conversion in the adjustment circuit 308 and the control of the light source 2904 with the illumination controller circuit 304 enables the adjustment circuit 308 to output from 1 amp up to 5 amps to external devices charging on the USB receptacles 2908.

Referring now to FIG. 30, therein is shown an isometric side view of the desktop system 3000 in a thirteenth embodiment. The desktop system 3000 is depicted as a desk mirror having a base unit 3002 and a lighting source 3004.

The base unit 3002 is shown having USB receptacles 3008 and AC receptacles 3010. The USB receptacles 3008 can be external receptacle portions of USB-units 3012 and are contemplated to be USB type-A or USB type-C receptacles.

The USB receptacles 3008 can provide active Vbus and GND pins while providing inactive D+, and D− pins. In alternative configurations, the USB receptacles 3008 can provide the active Vbus and GND pins while providing no pins for D+ and D−. It is contemplated that when the USB receptacles 3008 is implemented in USB receptacles other than type-A, the ID pin can also be inactive or nonexistent.

It has been discovered that providing the active Vbus and GND pins while not providing active D+, D−, or ID pins allows the desktop system 3000 to be produced at a lower price point and less manufacturing complexity because no circuitry or internal connections are needed for the D+, D−, or ID pins.

It has further been discovered that providing only a USB receptacle rather than a USB plug, greatly increases the versatility and usability of the desktop system 3000 by allowing users to plug in a USB charging plug that is compatible with the type-A or type-C receptacle on one end and any other USB receptacle on the other. That is, a user can use the USB receptacles 3008 to charge an electronic device requiring a USB mini-A, a USB mini-B, a USB micro-A, a USB micro-B, or even a USB type-B connection by using the user's own USB charging cable.

Further it has been discovered that the USB receptacles 3008 increase the ergonomic functionality and versatility of the desktop system 3000 by enabling a user to plug in their charging cable and position their electronic device anywhere within reach of the desktop system 3000. The electronic device can be positioned out of the way and the user can easily reach the desktop system 3000 without needing to stand up, walk over to an outlet, bend over, and plug their electronic device in.

The USB receptacles 3008 are shown vertically aligned on a side of the base unit 3002. The AC receptacles 3010 are shown aligned on the top side of the base unit 3002. The AC receptacles 3010 can be external receptacle portions of AC-units 3014.

The AC-units 3014 and the USB-units 3012 can be combined within a base housing 3016 into modules. The modules of the AC-units 3014 and the USB-units 3012 can include multiple AC-units 3014 or multiple USB-units 3012 and can share components like conductors, passive electrical components, and circuit boards. The modules of the AC-units 3014 and the USB-units 3012 can also be housed with an internal housing that is contained within the base housing 3016.

The AC-units 3014 and the USB-units 3012 can also be combined within the base housing 3016 into sealed modules. The sealed modules of the AC-units 3014 and the USB-units 3012 can include multiple AC-units 3014 or multiple USB-units 3012 and can share components like conductors, passive electrical components, and circuit boards. The sealed modules of the AC-units 3014 and the USB-units 3012 can also be housed with a sealed internal housing that is contained within the base housing 3016.

As an illustrative example, the two USB-units 3012 can be a single USB-module, or a sealed USB-module, with an internal housing and sharing components. As a further illustrative example, each of the AC-units 3014 and the USB-units 3012 can be individual modules, or individual sealed modules, self-contained within their own internal housings. As a further illustrative example the AC-units 3014 along with the USB-units 3012 can be combined into a single module, or single sealed module, sharing an internal housing and components.

The AC receptacles 3010 and the USB receptacles 3008 are shown exposed from multiple openings the base housing 3016. The base housing 3016 is contemplated to be the base of a stand for a desktop mirror. It has been discovered that shaping the base unit 3002 to resemble currently used bases enables greater integration of the desktop system 3000 onto the desk of a user because the desktop system 3000 does not occupy new desk top space but only occupies the same amount of space as any previously used desktop mirror.

The base housing 3016 is contemplated to be made of plastics or metals depending on the level of quality demanded by users and supported by the market. The base unit 3002 is contemplated to be coupled to a power input. The power input can include a cable coupled to the base housing 3016 and an AC plug coupled to the end of the cable opposite of the base housing 3016.

The AC plug is contemplated to be compatible with a 120 volt 60 hertz AC receptacle or a 230 volt 300 hertz AC receptacle. The power input can include an adapter coupled between the AC plug and the cable or alternatively, the AC plug can be directly coupled to the cable.

The power from the power input can be a single power type and can be conducted straight from the power input through circuitry in the USB-units 3012 to the USB receptacles 3008 of the USB-units 3012. It has been discovered that conducting the power from the power input straight through the USB-units 3012 without modifying the power improves the desktop system 3000 by reducing manufacturing costs, complexity, and component failure points.

It is contemplated that each of the USB-units 3012 can also convert the single power type from the power input into multiple different ampere ratings. For example, it is contemplated that the USB-units 3012 can convert the single power type to supply a 500 milliamperes, 1,000 milliamperes, or 2,100 milliamperes DC current to the USB receptacles 3008.

It is contemplated that the USB-units 3012 can change the ampere rating based on the external mobile device plugged into the corresponding USB receptacle 3008. It is further contemplated that the USB-units 3012 can be dedicated to a specific and fixed ampere rating.

It has been discovered that providing multiple ampere ratings enables the USB-units 3012 to charge different mobile devices effectively. It has been further discovered that the USB-units 3012 set to supply a specific fixed ampere rating to the mobile devices reduces the complexity of the conversion circuitry required by the USB-units 3012 and thus reduces manufacturing costs and complexity.

The single power type of the power input can also be converted in circuitry in the AC-units 3014 from a DC Vbus power source to an AC power and provided as an output at the AC receptacles 3010 of the AC-units 3014. It has been discovered that converting the power from the single power type of the power input improves the desktop system 3000 by reducing manufacturing costs, complexity, and component failure points because the circuitry doing the conversion can be designed for a single power type and is not required to convert multiple different types of input power.

It is contemplated that in alternate embodiments, the power from the power input can be a single power type and can be conducted straight from the AC plug of the power input to circuitry in the USB-units 3012, which converts the power from the power input to DC. The converted power from the USB-units 3012 is output on the USB receptacles 3008. It has been discovered that conducting the power from the power input straight to the USB-units 3012 without modifying the power improves the desktop system 3000 by reducing manufacturing costs, complexity, and component failure points.

It is contemplated that in alternate embodiments that each of the USB-units 3012 can also convert the single power type from the AC plug into multiple different ampere ratings. For example it is contemplated that the USB-units 3012 can convert the single power type from the AC plug and convert it to supply a 500 milliamperes, 1,000 milliamperes, or 2,100 milliamperes DC current to the USB receptacles 3008.

In some contemplated embodiments, the power from the power AC plug can be a single power type and can be conducted straight from the AC plug of the power input through circuitry in the AC-units 3014 to the AC receptacles 3010. It has been discovered that conducting the power from the power input straight through the AC-units 3014 without modifying the power improves the desktop system 3000 by reducing manufacturing costs, complexity, and component failure points.

The base unit 3002 is depicted having a controls 3030 exposed from a top side 3032 of the base housing 3016. The controls 3030 can be used to turn off the USB-units 3012 and the AC-units 3014.

The lighting sources 3004 can be LEDs around a desktop mirror for illuminating a user. The desktop system 3000 can take power from the power input and conduct it through the circuitry of the USB-units 3012 to power the USB receptacles 3008, convert it within the AC-units 3014 to power the AC receptacles 3010, or conduct it directly from the power input to the lighting sources 3004.

It has been discovered that removing extra circuitry associated with the conversion of the power from the power input to be useable with the USB-units 3012 and directly connecting the USB receptacles 3008 to the power input greatly reduces costs and complexity of producing and designing the desktop system 3000 while simultaneously reducing the number of components that could potentially fail.

Further, the desktop system 3000 does not include any batteries for power storage for the power of the power input. That is, when the power from the power input is removed the AC receptacles 3010, the USB receptacles 3008, and the lighting sources 3004 are no longer powered. It has been discovered that providing the desktop system 3000 without batteries for power storage can provide a smaller footprint, simplified design, and a lower bill of materials along with a more robust design. It has also been discovered that it is very difficult to supply the high current levels required by mobile devices and the lighting source 3004 with batteries for power storage unit.

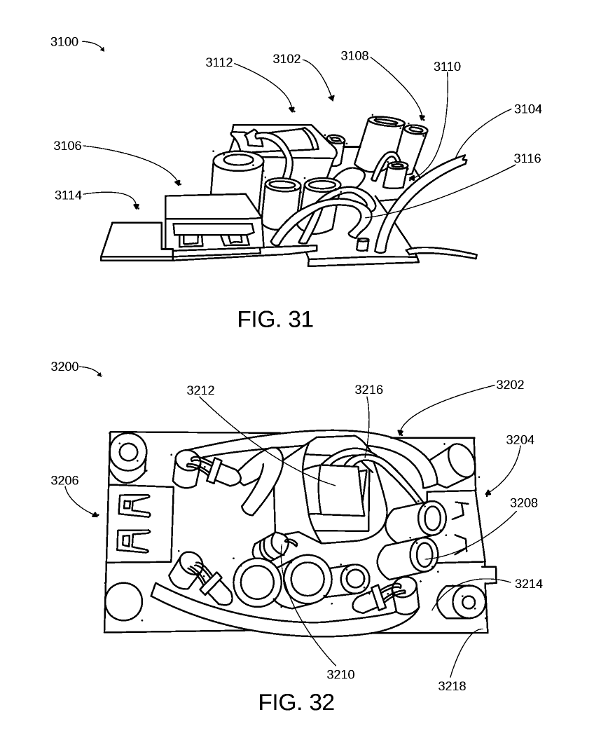

Referring now to FIG. 31, therein is shown an isometric view of a USB-unit 3100 for an embodiment of the desktop system. The USB-unit 3100 is shown as including circuitry 3102 that has a single input power type 3104.

The single input power type 3104 is converted, conducted, or both by the circuitry 3102 and is provided as an output to a USB receptacle 3106 with a power profile of a USB Vbus. It has been discovered that implementing the circuitry 3102 with only the single input power type 3104 greatly reduces the production costs, production complexity, without sacrificing functionality of the USB-unit 3100.

The circuitry 3102 can include components such as capacitors 3108, resistors 3110, and inductors 3112. The circuitry 3102 can further include circuit boards 3114 and conductors 3116. The USB receptacle 3106 is contemplated to be a Type-A or a Type-C receptacle.

Referring now to FIG. 32, therein is shown an isometric top view of a USB-module module 3200 for an embodiment of the desktop system. The USB-module 3200 is shown as including circuitry 3202 that has a single input power type 3204.

The single input power type 3204 is converted, conducted, or both by the circuitry 3202 and is provided as an output to a USB receptacle 3206 with a power profile of a USB Vbus. It has been discovered that implementing the circuitry 3202 with only the single input power type 3204 greatly reduces the production costs, production complexity, without sacrificing functionality of the USB-module 3200.

The circuitry 3202 includes components including capacitors 3208, resistors 3210, and inductors 3212. The circuitry 3202 further includes circuit boards 3214 and conductors 3216. The USB receptacle 3206 is contemplated to be a Type-A or a Type-C receptacle.

The USB receptacle 3206 and the circuitry 3202 is depicted enclosed within a housing 3218. It is contemplated that the housing 3218 can be standardized in size and fit within compartments of the desktop system which is capable of enclosing standardized housing. It is contemplated that the housing 3218 can contain one or many of the USB receptacles 3206.

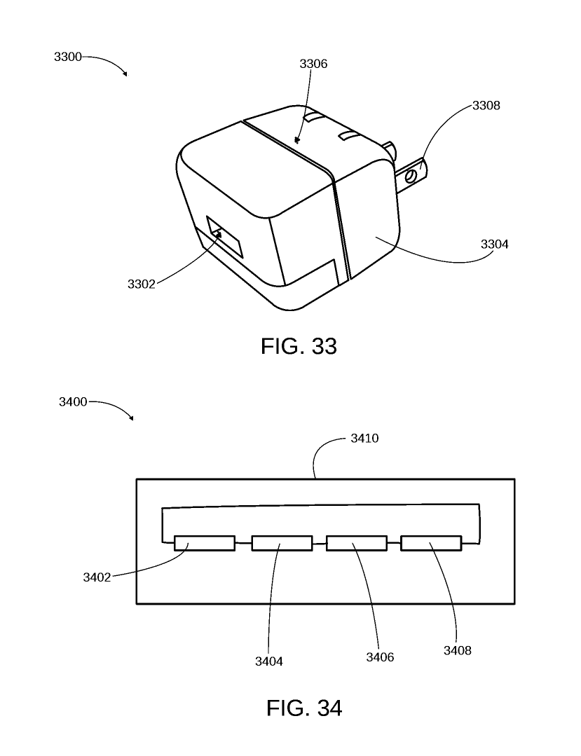

Referring now to FIG. 33, therein is shown an isometric view of a sealed USB-module 3300 for an embodiment of the desktop system. The sealed module 3300 is depicted having a USB receptacle 3302 in a sealed housing 3304 having compliance marks 3306 and powered by a power input 3308. Illustratively, the sealed module 3300 can include the USB-unit 3000 of FIG. 30 contained in the sealed housing 3304 with the compliance marks 3306.

The compliance marks 3306 are contemplated to be from the Underwriters Laboratory (UL), the Federal Communications Commission (FCC), the Product Safety Engineering, Inc. (PSE), the Voluntary Control Council for Interference by Information Technology Equipment (VCCI), the Low Voltage Directive (LVD), Energy Star, the Restriction of Hazardous Substances Directive (Rohs), or the Limited Power Source Safety Standard (LPS).

Referring now to FIG. 34, therein is shown a side view of a Type-A USB receptacle 3400 for an embodiment of the desktop system. The USB receptacle 3400 is shown having pins 1-4 including a first pin 3002, which can be a Vbus pin for providing power at 5 volts DC.

The USB receptacle 3400 further includes a second pin 3004 and a third pin 3006. The second pin 3004 can be a D− pin while the third pin 3006 can be a D+ pin. The USB receptacle 3400 can further include a fourth pin 3008. The fourth pin 3008 can be a GND pin. The USB receptacle 3400 can also include a shield 3410.

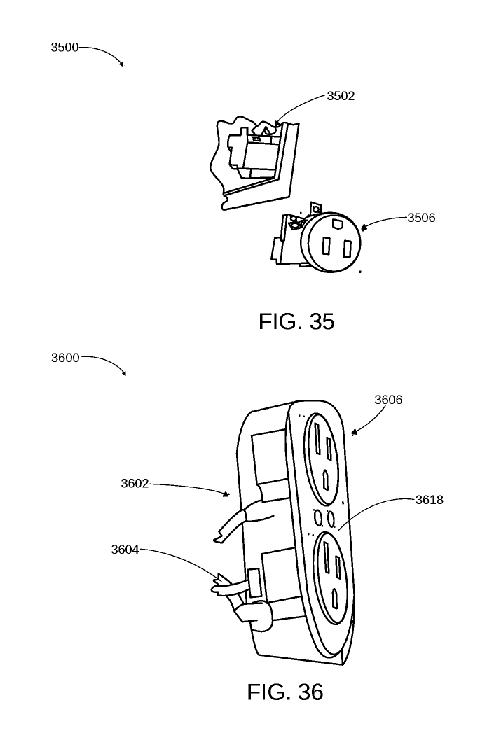

Referring now to FIG. 35, therein is shown an isometric view of an AC-unit for an embodiment of the desktop system. The AC-unit 3500 is shown as including circuitry 3502 that has a single input power type.

The single input power type can be converted, conducted, or both by the circuitry 3502 and is provided as an output to an AC receptacle 3506 with a power profile of an AC outlet. It has been discovered that implementing the circuitry 3502 with only the single input power type greatly reduces the production costs, production complexity, without sacrificing functionality of the AC-unit 3500. The circuitry 3502 can include components such as capacitors, resistors, and inductors. The circuitry 3502 can further include circuit boards and conductors.

Referring now to FIG. 36, therein is shown an isometric top view of an AC-module 3600 for an embodiment of the desktop system. The AC-module 3600 is shown as including circuitry 3602 that has a single input power type 3604.

The single input power type 3604 is converted, conducted, or both by the circuitry 3602 and is provided as an output to a AC receptacle 3606 with a power profile of an AC outlet. It has been discovered that implementing the circuitry 3602 with only the single input power type 3604 greatly reduces the production costs, production complexity, without sacrificing functionality of the AC-module 3600.

The circuitry 3602 can include components such as capacitors, resistors, and inductors. The circuitry 3602 can further include circuit boards and conductors. The AC receptacle 3606 is contemplated to be a standardized AC socket.

The AC receptacle 3606 and the circuitry 3602 is depicted enclosed within a housing 3618. It is contemplated that the housing 3618 can be standardized in size and fit within compartments of the desktop system which is capable of enclosing standardized housing. It is contemplated that the housing 3618 can contain one or many of the AC receptacles 3606.

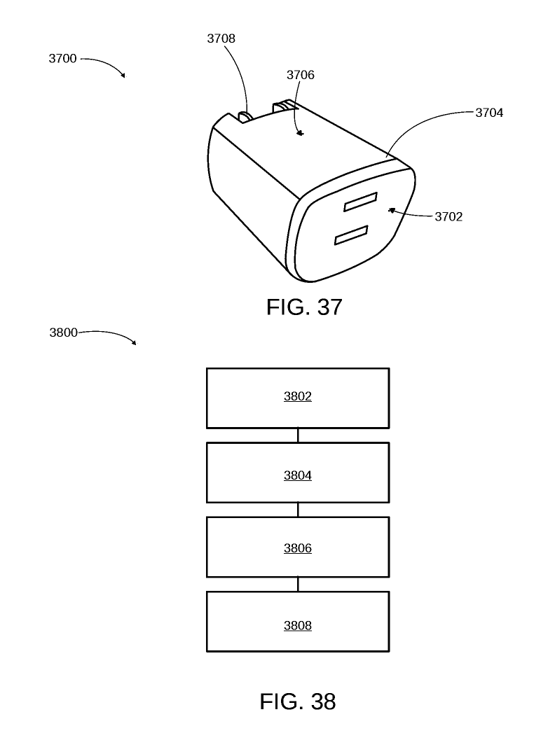

Referring now to FIG. 37, therein is shown an isometric view of a sealed AC-module 3700 for an embodiment of the desktop system. The sealed AC-module 3700 is depicted having a AC receptacle 3702 in a sealed housing 3704 having compliance marks 3706 and powered by a power input 3708. Illustratively, the sealed module 3700 can include the AC-unit 3500 of FIG. 35 contained in the sealed housing 3704 with the compliance marks 3706.

The compliance marks 3706 are contemplated to be from the Underwriters Laboratory (UL), the Federal Communications Commission (FCC), the Product Safety Engineering, Inc. (PSE), the Voluntary Control Council for Interference by Information Technology Equipment (VCCI), the Low Voltage Directive (LVD), Energy Star, the Restriction of Hazardous Substances Directive (Rohs), or the Limited Power Source Safety Standard (LPS).

Referring now to FIG. 38, therein is shown a flow chart for a method of manufacture 3800 of the desktop system of FIG. 1. The method of manufacture 3800 includes: mounting a USB-unit within the desktop system, the USB-unit including a USB receptacle exposed from the desktop system, the USB-unit including active Vbus and GND pins while having inactive D+ and D− pins in a block 3802; mounting an AC-unit within the desktop system, the AC-unit including an AC receptacle exposed from the desktop system in a block 3804; connecting a single power type directly to the USB-unit and to the AC-unit, the single power type conducted through the USB-unit and output on the USB receptacle based on the single power type being converted within the AC-unit to an alternating current power type and the single power type being a Vbus power type, or the single power type conducted through the AC-unit and output on the AC receptacle based on the single power type being converted in the USB-unit to a Vbus power type and the single power type being an alternating current power type in a block 3806; and mounting a light emitting diode within the desktop system and exposed therefrom in a block 3808.

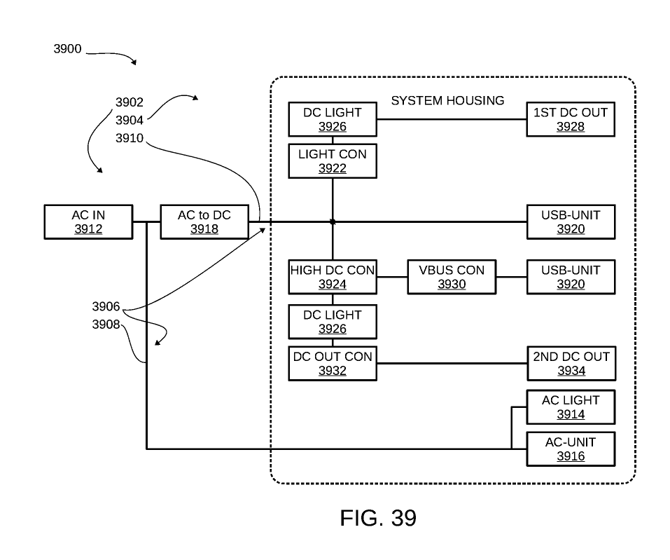

FIG. 39, therein is shown, a first block diagram 3900 for an embodiment of the desktop system. It is contemplated that the first block diagram 3900 can be implemented in the embodiments of the desktop system of the present disclosure.

The first block diagram 3900 is depicted having a power input 3902 external to and coupled to a system housing 3904. The system housing 3904 can include the base unit, lighting source and support described with regard to the embodiments of the desktop system.

The power input 3902 is depicted having a cable 3906 coupled to the system housing 3904. The cable 3906 is shown having two functional electrical conduits including an AC conduit 3908 and a DC conduit 3910.

The AC conduit 3908 can extend from an AC plug 3912 coupled to the end of the cable 3906 opposite of the system housing 3904. The AC plug 3912 is contemplated to be compatible with a 120 volt 60 hertz AC receptacle or a 230 volt 50 hertz AC receptacle.

The AC conduit 3908 can provide alternating current directly from the AC plug 3912 to AC components including AC lights 3914 and AC receptacles within AC-units 3916. The AC receptacles can be external receptacle portions of the AC-units 3916 as described with regard to the embodiments of the desktop system.

Multiple AC-units 3916 can be combined within the system housing 3904 into modules. The modules having the multiple AC-units 3916 can share components like conductors, passive electrical components, and circuit boards. The modules of the AC-units 3916 can be housed with an internal housing that is contained within the system housing 3904.

Multiple AC-units 3916 can also be combined within the system housing 3904 into sealed modules. The sealed modules having the multiple AC-units 3916 can share components like conductors, passive electrical components, and circuit boards. The sealed modules of the AC-units 3916 can be housed with a sealed internal housing that is contained within the system housing 3904.

The AC receptacles of the AC-units 3916 can be exposed from multiple openings in the system housing 3904. The AC lights 3914 can be a compact fluorescent lamp, incandescent bulb, fluorescent tube, LED bulb, electroluminescent wire, or a combination thereof.

The power input 3902 can also include an adapter 3918 coupled between the AC plug 3912 and the cable 3906 and external to the system housing 3904. The adapter 3918 can include a transformer, rectifier, converter and inverter to convert the AC power to DC power.

It is contemplated that the adapter 3918 can convert the input AC to a 5 volt DC output. The power from the power input 3902 can be a single power type, which can be conducted straight from the adapter 3918 of the power input 3902 through conductive circuitry in USB-units 3920 to USB receptacles. The USB-units 3920 can have the USB receptacles exposed from the system housing 3904.

It has been discovered that conducting the DC power from the adapter 3918 of the power input 3902 straight through the USB-units 3920 without modifying the power improves the desktop system by reducing manufacturing costs, complexity, and component failure points.

The system housing 3904 is depicted having multiple USB-units 3920. The USB receptacles of the USB-units 3920 can provide active Vbus and GND pins while providing inactive D+, and D-pins. In alternative configurations, the USB receptacles of the USB-units 3920 can provide the active Vbus and GND pins while providing no pins for D+ and D−. It is contemplated that when the USB receptacles of the USB-units 3920 are implemented in USB receptacles other than type-A, the ID pin can also be inactive or nonexistent.

It has been discovered that providing the active Vbus and GND pins while not providing active D+, D−, or ID pins allows the desktop system to be produced at a lower price point and less manufacturing complexity because no circuitry or internal connections are needed for the D+, D−, or ID pins.

It has further been discovered that providing only a USB receptacle from the USB-units 3920 rather than a USB plug, greatly increases the versatility and usability of the desktop system by allowing users to plug in a USB charging plug that is compatible with the type-A or type-C receptacle on one end and any other USB receptacle on the other. That is, a user can use the USB receptacles 408 to charge an electronic device requiring a USB mini-A, a USB mini-B, a USB micro-A, a USB micro-B, or even a USB type-B connection by using the user's own USB charging cable.

Further it has been discovered that the USB receptacles of the USB-units 3920 increase the ergonomic functionality and versatility of the desktop system by enabling a user to plug in their charging cable and position their electronic device anywhere within reach of the desktop system. The electronic device can be positioned out of the way and the user can easily reach the desktop system without needing to stand up, walk over to an outlet, bend over, and plug their electronic device in.

Multiple USB-units 3920 can be combined within the system housing 3904 into modules. The modules having the multiple USB-units 3920 can share components like conductors, passive electrical components, and circuit boards. The modules of the USB-units 3920 can be housed with an internal housing that is contained within the system housing 3904.

Multiple USB-units 3920 can also be combined within the system housing 3904 into sealed modules. The sealed modules having the multiple USB-units 3920 can share components like conductors, passive electrical components, and circuit boards. The sealed modules of the USB-units 3920 can be housed with a sealed internal housing that is contained within the system housing 3904.

The 5 volt DC output of the adapter 3918 can be input into a DC light converter 3922 as well as a high voltage DC converter 3924. The DC light converter 3922 can provide one or more DC output voltages to power DC lights 3926.

The system housing 3904 is depicted having multiple DC lights 3926. The DC lights 3926 can be LED's. The DC lights 3926 coupled to the DC light converter 3922 can be multiple LED's of different voltages.

Further coupled to the DC light converter 3922 in series with the DC lights 3926, or optionally in parallel with the DC lights 3926, is a first DC output 3928. The first DC output 3928 can be the DC voltage supplied by the DC light converter 3922.

The high voltage DC converter 3924 can up-convert the 5 volt DC power from the adapter 3918. It is contemplated that the high voltage DC converter 3924 can provide a six volt, nine volt, twelve volt, a twenty-four volt output. It is further contemplated that the high voltage DC converter 3924 can provide multiple or a combination of these output voltages.

The output of the high voltage DC converter 3924 can be fed into a Vbus Converter 3930. The Vbus Converter 3930 can provide the Vbus power type output. However it is contemplated that the Vbus Converter 3930 can provide a different amperage capability than the 5 volt DC output of the adapter 3918. Specifically the Vbus Converter 3930 can provide a 1 ampere, 2.1 ampere, 3.1 ampere, 2.4 ampere, 3.4 ampere, 4.2 ampere, 4.4 ampere, or up to a 10 ampere supply for the USB-unit 3920 connected to the Vbus Converter 3930.

Further coupled to the high voltage DC converter 3924 are the DC lights 3926. The DC lights 3926 coupled to the high voltage DC converter 3924 can be LED's. The DC lights 3926 coupled to the high voltage DC converter 3924 can be multiple LED's of different voltages.

Coupled to the high voltage DC converter 3924 in series with the DC lights 3926 or in parallel with the DC lights 3926 is a DC output converter 3932. The DC output converter 3932 can provide specific or multiple DC output voltages to a second DC output 3934 coupled thereto.

It is contemplated that the DC light converter 3922, the high voltage DC converter 3924, and the DC output converter 3932 could be a single converter or could be multiple converters within the system housing 3904. Further it is contemplated that the DC light converter 3922, the high voltage DC converter 3924, and the DC output converter 3932 could share a single housing within the system housing 3904 and could share electrical components with each other within the system housing 3904.

It is contemplated that the first DC output 3928, the second DC output 3934, and the USB-units 3920 could be contained within modules or sealed modules within the system housing 3904. Alternatively, it is contemplated that the first DC output 3928 and the second DC output 3934 could be contained in modules or sealed modules separate from the USB-units 3920.

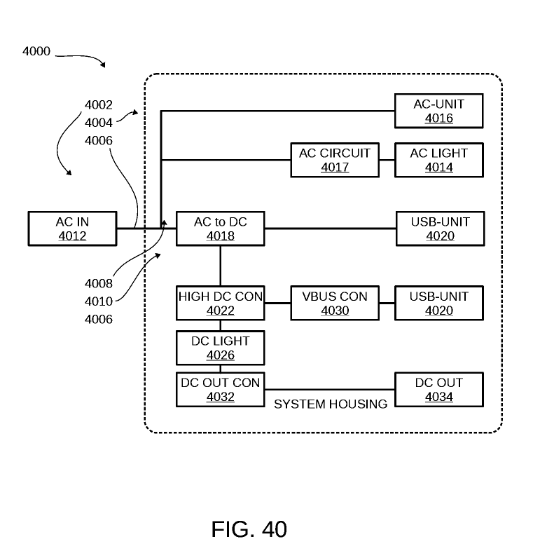

FIG. 40, therein is shown, a second block diagram 4000 for an embodiment of the desktop system. It is contemplated that the second block diagram 4000 can be implemented in the embodiments of the desktop system of the present disclosure.

The second block diagram 4000 is depicted having a power input 4002 external to and coupled to a system housing 4004. The system housing 4004 can include the base unit, lighting source and support described with regard to the embodiments of the desktop system.

The power input 4002 is depicted having a cable 4006 coupled to the system housing 4004. The cable 4006 is shown as an AC conduit. Within the system housing 3904, the cable can branch into an AC conduit 4008 and a DC conduit 4010.

The cable 4006 can extend from an AC plug 4012 coupled to the end of the cable 4006 opposite of the system housing 4004. The AC plug 4012 is contemplated to be compatible with a 120 volt 60 hertz AC receptacle or a 230 volt 50 hertz AC receptacle.

The cable 4006 can provide alternating current directly from the AC plug 4012 to AC components including AC lights 4014 and AC receptacles within AC-units 4016. The AC receptacles can be external receptacle portions of the AC-units 4016 as described with regard to the embodiments of the desktop system.

Multiple AC-units 4016 can be combined within the system housing 4004 into modules. The modules having the multiple AC-units 4016 can share components like conductors, passive electrical components, and circuit boards. The modules of the AC-units 4016 can be housed with an internal housing that is contained within the system housing 4004.

Multiple AC-units 4016 can also be combined within the system housing 4004 into sealed modules. The sealed modules having the multiple AC-units 4016 can share components like conductors, passive electrical components, and circuit boards. The sealed modules of the AC-units 4016 can be housed with a sealed internal housing that is contained within the system housing 4004.

The AC receptacles of the AC-units 4016 can be exposed from multiple openings in the system housing 4004. The AC lights 4014 can be a compact fluorescent lamp, incandescent bulb, fluorescent tube, LED bulb, electroluminescent wire, or a combination thereof. The AC lights 4014 can be coupled to an optional AC circuit 4017. The AC circuit 4017 is contemplated to be a circuit for manipulating the AC power such as a ballast.

The cable 4006 from the power input 4002 can also be coupled to an adapter 4018 within the system housing 4004. The adapter 4018 can include a transformer, rectifier, converter and inverter to convert the AC power to DC power.

It is contemplated that the adapter 4018 can convert the input AC to a 5 volt DC output. The power from the power input 4002 can be a single power type, which can be conducted straight from the adapter 4018 of the power input 4002 through conductive circuitry in USB-units 4020 to USB receptacles. The USB-units 4020 can have the USB receptacles exposed from the system housing 4004.

It has been discovered that conducting the DC power from the adapter 4018 of the power input 4002 straight through the USB-units 4020 without modifying the power improves the desktop system by reducing manufacturing costs, complexity, and component failure points.

The system housing 4004 is depicted having multiple USB-units 4020. The USB receptacles of the USB-units 4020 can provide active Vbus and GND pins while providing inactive D+, and D-pins. In alternative configurations, the USB receptacles of the USB-units 4020 can provide the active Vbus and GND pins while providing no pins for D+ and D−. It is contemplated that when the USB receptacles of the USB-units 4020 are implemented in USB receptacles other than type-A, the ID pin can also be inactive or nonexistent.

It has been discovered that providing the active Vbus and GND pins while not providing active D+, D−, or ID pins allows the desktop system to be produced at a lower price point and less manufacturing complexity because no circuitry or internal connections are needed for the D+, D−, or ID pins.

It has further been discovered that providing only a USB receptacle from the USB-units 4020 rather than a USB plug, greatly increases the versatility and usability of the desktop system by allowing users to plug in a USB charging plug that is compatible with the type-A or type-C receptacle on one end and any other USB receptacle on the other. That is, a user can use the USB receptacles 408 to charge an electronic device requiring a USB mini-A, a USB mini-B, a USB micro-A, a USB micro-B, or even a USB type-B connection by using the user's own USB charging cable.

Further it has been discovered that the USB receptacles of the USB-units 4020 increase the ergonomic functionality and versatility of the desktop system by enabling a user to plug in their charging cable and position their electronic device anywhere within reach of the desktop system. The electronic device can be positioned out of the way and the user can easily reach the desktop system without needing to stand up, walk over to an outlet, bend over, and plug their electronic device in.

Multiple USB-units 4020 can be combined within the system housing 4004 into modules. The modules having the multiple USB-units 4020 can share components like conductors, passive electrical components, and circuit boards. The modules of the USB-units 4020 can be housed with an internal housing that is contained within the system housing 4004.

Multiple USB-units 4020 can also be combined within the system housing 4004 into sealed modules. The sealed modules having the multiple USB-units 4020 can share components like conductors, passive electrical components, and circuit boards. The sealed modules of the USB-units 4020 can be housed with a sealed internal housing that is contained within the system housing 4004.

The 5 volt DC output of the adapter 4018 can also be input into a high voltage DC converter 4022. The high voltage DC converter 4022 can provide one or more DC output voltages to power DC lights 4026.

The system housing 4004 is can have multiple DC lights 4026. The DC lights 4026 can be LED's. The DC lights 4026 coupled to the high voltage DC converter 4022 can be multiple LED's of different voltages.

The output of the high voltage DC converter 4022 can also be fed into a Vbus Converter 4030. The Vbus Converter 4030 can provide the Vbus power type output. However it is contemplated that the Vbus Converter 4030 can provide a different amperage capability than the 5 volt DC output of the adapter 4018. Specifically the Vbus Converter 4030 can provide a 1 ampere, 2.1 ampere, 3.1 ampere, 2.4 ampere, 3.4 ampere, 4.2 ampere, 4.4 ampere, or up to a 10 ampere supply for the USB-unit 4020 connected to the Vbus Converter 4030.

Yet further Coupled to the high voltage DC converter 4022 in series with the DC lights 4026 or in parallel with the DC lights 4026 is a DC output converter 4032. The DC output converter 4032 can provide specific or multiple DC output voltages to a DC output 4034 coupled thereto.

It is contemplated that the high voltage DC converter 4022, and the DC output converter 4032 could be a single converter or could be multiple converters within the system housing 4004. Further it is contemplated that the high voltage DC converter 4022, and the DC output converter 4032 could share a single housing within the system housing 4004 and could share electrical components with each other within the system housing 4004.

It is contemplated that the DC output 4034, and the USB-units 4020 could be contained within modules or sealed modules within the system housing 4004. Alternatively, it is contemplated that the DC output 4034 could be contained in modules or sealed modules separate from the USB-units 4020.

Thus, it has been discovered that the desktop system furnishes important and heretofore unknown and unavailable solutions, capabilities, and functional aspects. The resulting configurations are straightforward, cost-effective, uncomplicated, highly versatile, accurate, sensitive, and effective, and can be implemented by adapting known components for ready, efficient, and economical manufacturing, application, and utilization.

The desktop system is contemplated to include embodiments having AC-units, USB-units, AC-modules, USB-modules, sealed AC-modules, and sealed USB-modules installed or arranged on or within a base unit, support, housing, or pole of the desktop system. Embodiments of the desktop system are contemplated to be arranged in locations where people will stay for period of time, such as a desk, table, bed, chair, land, grass, or wherever else people work, rest, sit, stand, sleep or a take nap. In other contemplated embodiments the desktop system may utilize electric signals for triggering sight, sound, smell, taste, or feel in a user's eyes, ear, nose, mouth, or body, respectively.

The electric signals are contemplated to be used to emit illumination with various levels of brightness, visual effects, images, time displays, lighting sources, visual projections, or digital photo displays. The electric signals are further contemplated be used to emit sound with various levels of volume, pitch, melody, or beat.

The electric signals are further contemplated be used to emit a scent such as an air freshener, or a perfume dispenser. The electric signals are further contemplated be used to emit or dispense a liquid such as water, coffee, tea, body moisturizer or even to emit or dispense food. The electric signals are further contemplated be used to emit air flow including wind, moisturized air, steam, heated air from an electric heater, steam, cold air, or air conditioned air.

It is contemplated that the desktop system can take many forms including cosmetic mirrors, handheld DC powered lighting, digital clocks, desk lamps, desk top clocks, desk top radios, desk top fans, desk top lighting, reading lights, wall reading lights, head lighting, book lights, electric picture displays, night lights, projection lights, electric candle sets, and other conventionally available items that can be placed to let people easily reach, touch, operate, or manage the desktop system and integrate existing functions into the desktop system. The desktop system is contemplated in some embodiments to be an LED light, an LED desk lamp, LED table lighting, an LED lava light, an LED projection light, an LED time piece, an LED electric fan, an LED air freshener, an LED indicator coffee machine, an LED indicator sound device, or an LED visual device.

In some embodiments the desktop system is contemplated to include accessories or components, such as circuits, integrated circuits, motion sensors, optical sensors, acoustic sensors, passive infrared sensors, or other sensors, timers, time delay mechanism, timers, resilient structures, conductive structures, transformers, inverters, adaptors, wires, prongs, UL listed adapters, infrared emitters or sensors, and master power controllers.

The desktop system is contemplated to include AC receptacles and USB receptacles configured to offer electric power at a voltage and amperage sufficient to achieve a desired charging time for external devices. External devices are contemplated to include MP3 or MP4 players, smart phones, laptop computers, tablet computers, video game consoles, digital visual equipment, communication equipment, and other consumer electric products.

It is contemplated that the USB-unit, USB-module, sealed USB-module, USB receptacle, AC-unit, AC-module, sealed AC-module, or AC receptacle may be turned on or turned off for a predetermined time by a switch, a sensor, a timer, a photo sensor, a motion sensor, a time delay mechanism, or a master power control mechanism. It is contemplated that embodiments of the desktop system can include removable covers over the USB receptacles and the AC receptacles to allow kids or others to safely touch the desktop system and prevent dust, or water from getting into the receptacles.

In some embodiments of the desktop system it is contemplated that the USB-unit or USB-module can be removable from the desktop system and carried for use away from the desktop system. For this purpose, the USB-unit or USB-module is contemplated to be capable of disassembly or detachment from the desktop system and is further capable of re-assembly or reattachment into the desktop system with a quick connector, adaptor, assembly mechanism, or fixing mechanism.

It is contemplated that when the USB-unit or the USB-module is detachable from the desktop system, each of the USB-units or USB-modules can have its own safety certifications so that the individual USB-units or USB-modules can be tested by safety authorities and sold separately. In some contemplated embodiments the USB-unit can get power from a power source and uses its circuitry to convert or transform the power to a desired waveform, voltage, and current sufficient to charge other electric or digital devices.

It is contemplated that some embodiments can include the USB-modules or AC-modules with a universal design. It is contemplated that the AC-units and USB-units can be compact in size to enable any combination of the units to be combined and form a module that fits into all kinds of electric devices, including LED light devices, wall outlets, wall outlet adaptors, power strips, surge protectors, communication devices, computer devices, consumer electric devices, smart phones, panel computer devices.

It is contemplated that the modules of the desktop system can utilize any combination of USB-units or AC-units and can share components. The USB-units and AC-units are contemplated to include components such as conductive wire, conductive plate, conductors, contacts, prong-cables, USB-cables, prongs, resilient conductors, printed circuits, flexible circuits, electric parts and accessories, affixing structures, positioning structures, and installation structures.

It is contemplated that the USB receptacles of the desktop system can have different current outputs including 500 milliamperes, 1 ampere, 1.1 amperes, and 2.2 amperes to enable the USB receptacles to charge different electric devices such as an iPhone™, which needs to have 1 ampere, and an iPad™, which requires 2.1 amperes.

If users need to charge one iPhone™ and one iPad™ at the same time, at least 3.1 amperes will be needed. On the other hand if users need to charge one iPhone™ or one iPad™ at different times, the USB-modules can include one receptacle with circuitry and components rated at 1 ampere and at 1.1 amperes, which would provide one USB-receptacle that could output 1 ampere or 2.1 amperes, which will be cheaper. If users need to charge only one iPhone™, the desktop system can only include one USB-unit with a one ampere output and would provide the most economical product.

It has been discovered that because the modules of the desktop system can be standardized, the modules can be mounted within standardized compartments of other devices. Also, since the modules can be formed as sealed modules, the modules can be sealed separately with their own safety certifications and then be mounted within many different desktop systems, which reduces the resources expended on research and development, tooling, safety certification time and costs because there is no need to file for each different desktop system but simply for the interchangeable modules.

It has been discovered that making the modules or the sealed modules of the desktop system as small as possible so that they fit into many desktop systems with can enable the modules to have universal applicability.

On the other hand, it has been discovered that the modules of the desktop system with the smallest, slimmest, or most compact size can be prohibitively expensive. As an illustrative example, the APPLE™ iPhone™'s or iPad™'s USB-unit, which is very small in size, needs to use a very high cost compact transformer or inverter in order to achieve a short charge time. Some embodiments of the desktop system resolved the issue of high miniaturization costs by placing the modules in a housing with a larger space, thereby obtaining the same power output at a substantially lower cost.

While the desktop system has been described in conjunction with a specific best mode, it is to be understood that many alternatives, modifications, and variations will be apparent to those skilled in the art in light of the preceding description. Accordingly, it is intended to embrace all such alternatives, modifications, and variations, which fall within the scope of the included claims. All matters set forth herein or shown in the accompanying drawings are to be interpreted in an illustrative and non-limiting sense.

What is claimed is:

1. A desktop system comprising:
a USB-unit mounted within the desktop system, the USB-unit including a USB receptacle exposed from the desktop system, the USB-unit including active Vbus and GND pins while having inactive D+ and D− pins;
a single power type directly connected to the USB-unit, the single power type conducted through the USB-unit and output on the USB receptacle with the same power profile as the single power type provides based on the single power type being a Vbus power type, or the single power type conducted through the USB-unit and output on the USB receptacle in a modified form based on the single power type being an alternating current power type; and
a light source mounted within the desktop system and exposed therefrom.

2. The desktop system of claim 1 wherein the light source is an image projecting light emitting diode, a time displaying light emitting diode, an area illumination light emitting diode, a display light emitting diode, a power usage light emitting diode, or a charging status indicator light emitting diode.

3. The desktop system of claim 1 wherein power from the single power type is not stored in a battery within the desktop system.

4. The desktop system of claim 1 wherein the USB-unit, an AC-unit, or a combination thereof is combined into a rotatable housing, the rotatable housing including a first flat side and a second side having the USB-unit, the AC-unit, or a combination thereof exposed therefrom.

5. The desktop system of claim 1 further comprising a second USB-unit, and wherein the USB-unit and the second USB-unit output different currents.

6. A desktop system comprising:
a base housing;
a USB-unit mounted within the base housing, the USB-unit including a USB receptacle exposed from the desktop system, the USB-unit including active Vbus and GND pins while having inactive D+ and D− pins;
a single power type directly connected to the USB-unit, the single power type conducted through the USB-unit and output on the USB receptacle with the same power profile as the single power type provides based on the single power type being a Vbus power type, or the single power type conducted through the USB-unit and output on the USB receptacle in a modified form based on the single power type being an alternating current power type; and
a light source mounted within the desktop system and exposed therefrom.

7. The desktop system of claim 6 wherein the USB-unit, an AC-unit, or a combination thereof are contained within a module, the module having a housing that fits with the base housing of the desktop system.

8. The desktop system of claim 6 wherein the power input is an AC plug with an adapter to output a DC power type, an AC plug with an AC output power type, or a USB plug with a DC output power type.

9. The desktop system of claim 6 wherein the USB-unit, an AC-unit, or a combination thereof are contained within a sealed module, the sealed module having a housing that fits with the base housing of the desktop system.

10. The desktop system of claim 6 further comprising:
a power switch coupled to the USB-unit and an AC-unit for turning the USB-unit and the AC-unit on and off;
a timing switch coupled to the USB-unit and the AC-unit for turning the USB-unit and the AC-unit on and off at predetermined time intervals;
a photo sensor switch coupled to the USB-unit and the AC-unit for turning the USB-unit and the AC-unit on and off based on light level changes;
a motion sensor switch coupled to the USB-unit and the AC-unit for turning the USB-unit and the AC-unit on and off based on motion changes; or
a combination thereof.

11. A method of manufacturing a desktop system comprising:
mounting a USB-unit within the desktop system, the USB-unit including a USB receptacle exposed from the desktop system, the USB-unit including active Vbus and GND pins while having inactive D+ and D− pins;
connecting a single power type directly connected to the USB-unit, the single power type conducted through the USB-unit and output on the USB receptacle with the same power profile as the single power type provides based on the single power type being a Vbus power type, or the single power type conducted through the USB-unit and output on the USB receptacle in a modified form based on the single power type being an alternating current power type; and
mounting a light source within the desktop system and exposed therefrom.

12. The method of claim 11 wherein mounting the light emitting source includes mounting an image projecting light emitting diode, a time displaying light emitting diode, an area illumination light emitting diode, a display light emitting diode, a power usage light emitting diode, or a charging status indicator light emitting diode.

13. The method of claim 11 wherein connecting the single power type includes connecting the single power type providing a power that is not stored in a battery within the desktop system.

14. The method of claim 11 wherein mounting the USB-unit includes mounting the USB-unit into a rotatable housing, the rotatable housing including a first flat side and a second side having the USB-unit, an AC-unit, or a combination thereof exposed therefrom.

15. The method of claim 11 further comprising:
mounting a second USB-unit; and
wherein mounting the USB-unit and the second USB-unit include mounting the USB-unit and the second USB-unit that output different currents.

16. The method of claim 11 further comprising:
providing a base housing;
mounting an AC-unit within the base housing; and
wherein:
mounting the USB-unit includes mounting the USB-unit within the base housing; and
coupling the single power type includes connecting a power input to the base housing, the power input being a single power type directly connected to the USB-unit and to the AC-unit.

17. The method of claim 16 wherein mounting the USB-unit, the AC-unit, or a combination thereof includes mounting the USB-unit, the AC-unit, or a combination thereof contained within a module, the module having a housing that fits with the base housing of the desktop system.

18. The method of claim 16 wherein connecting the power input includes connecting an AC plug with an adapter to output a DC power type, an AC plug with an AC output power type, or a USB plug with a DC output power type.

19. The desktop system of claim 16 wherein mounting the USB-unit, the AC-unit, or a combination thereof includes mounting the USB-unit, the AC-unit, or a combination thereof contained within a sealed module, the sealed module having a housing that fits with the base housing of the desktop system.

20. The method of claim 16 further comprising:
coupling a power switch to the USB-unit and the AC-unit for turning the USB-unit and the AC-unit on and off;
coupling a timing switch to the USB-unit and the AC-unit for turning the USB-unit and the AC-unit on and off at predetermined time intervals;
coupling a photo sensor switch to the USB-unit and the AC-unit for turning the USB-unit and the AC-unit on and off based on light level changes;
coupling a motion sensor switch to the USB-unit and the AC-unit for turning the USB-unit and the AC-unit on and off based on motion changes; or
coupling a combination thereof.
